(19) United States
(12) Patent Application Publication
(10) Pub. No.: US 2008/0229198 A1
(43) Pub. Date: Sep. 18, 2008

(54) Electronically providing user assistance

(75) Inventors: Edward K.Y. Jung, Bellevue, WA (US); Royce A. Levien, Lexington, MA (US); Robert W. Lord, Seattle, WA (US); Mark A. Malamud, Seattle, WA (US); John D. Rinaldo, Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporaiton of the State of Delaware

(21) Appl. No.: 12/012,216

(22) Filed: Jan. 30, 2008

Related U.S. Application Data
(63) Continuation-in-part of application No. 10/955,966, filed on Sep. 30, 2004.

(51) Int. Cl. G06F 3/048

(52) U.S. Cl. 715/708

(57) ABSTRACT

Provided embodiments include a device, apparatus, system, computer program product, and method. A provided method includes receiving a signal indicative of a user-selected portion of a manual pertaining to an apparatus that includes an electronic device. The method also includes searching a file for an assistance pertaining to the apparatus and corresponding to the user-selected portion of the manual. The method further includes generating a signal indicative of the assistance pertaining to the apparatus and corresponding to the user-selected portion of the manual, wherein the manual is physically distinct from the apparatus. In an alternative embodiment, the method includes facilitating an electronic display of the assistance using a user interface of the electronic device. The facilitating may include facilitating a projection of a display of the assistance from the electronic device. In another alternative embodiment, the method may include displaying at least two user-selectable portions of the manual.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 10/955,966, entitled PROVIDING ASSISTANCE, naming EDWARD K. Y. JUNG; ROYCE A. LEVIEN; MARK A. MALAMUD; JOHN D. RINALDO, JR. as inventors, filed 30, Sep. 2004, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 10/974,476, entitled ENHANCED USER ASSISTANCE, naming EDWARD K. Y. JUNG; ROYCE A. LEVIEN; MARK A. MALAMUD; JOHN D. RINALDO, JR. as inventors, filed 26, Oct. 2004, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 10/974,555, entitled ENHANCED USER ASSISTANCE, naming EDWARD K. Y. JUNG; ROYCE A. LEVIEN; MARK A. MALAMUD; JOHN D. RINALDO, JR. as inventors, filed 26, Oct. 2004, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 10/974,561, entitled ENHANCED CONTEXTUAL USER ASSISTANCE, naming EDWARD K. Y. JUNG; ROYCE A. LEVIEN; MARK A. MALAMUD; JOHN D. RINALDO, JR. as inventors, filed 27, Oct. 2004, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 10/978,243, entitled ENHANCED USER ASSISTANCE, naming EDWARD K. Y. JUNG; ROYCE A. LEVIEN; MARK A. MALAMUD; JOHN D. RINALDO, JR. as inventors, filed 29, Oct. 2004, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/000,687, entitled ENHANCED USER ASSISTANCE, naming EDWARD K. Y. JUNG; ROYCE A. LEVIEN; MARK A. MALAMUD; JOHN D. RINALDO, JR. as inventors, filed 1, Dec. 2004, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/037,828, entitled OBTAINING USER ASSISTANCE, naming EDWARD K. Y. JUNG; ROYCE A. LEVIEN; MARK A. MALAMUD; JOHN D. RINALDO, JR. as inventors, filed 18, Jan. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/037,825, entitled OBTAINING USER ASSISTANCE, naming EDWARD K. Y. JUNG; ROYCE A. LEVIEN; MARK A. MALAMUD; JOHN D. RINALDO, JR. as inventors, filed 18, Jan. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/037,827, entitled OBTAINING USER ASSISTANCE, naming EDWARD K. Y. JUNG; ROYCE A. LEVIEN; MARK A. MALAMUD; JOHN D. RINALDO, JR. as inventors, filed 18, Jan. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/041,861, entitled USER ASSISTANCE, naming EDWARD K. Y. JUNG; ROYCE A. LEVIEN; MARK A. MALAMUD; JOHN D. RINALDO, JR. as inventors, filed 21, Jan. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/069,893, entitled USER ASSISTANCE FOR A CONDITION, naming EDWARD K. Y. JUNG; ROYCE A. LEVIEN; MARK A. MALAMUD; JOHN D. RINALDO, JR. as inventors, filed 28, Feb. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/061,387, entitled SUPPLY-CHAIN SIDE ASSISTANCE, naming EDWARD K. Y. JUNG; ROYCE A. LEVIEN; MARK A. MALAMUD; JOHN D. RINALDO, JR. as inventors, filed 18, Feb. 2005, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/000,736, entitled ENHANCED USER ASSISTANCE, naming EDWARD K. Y. JUNG; ROYCE A. LEVIEN; MARK A. MALAMUD; JOHN D. RINALDO, JR. as inventors, filed 01, Dec. 2004, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/524,025, entitled SUPPLY-CHAIN SIDE ASSISTANCE, naming EDWARD K. Y. JUNG; ROYCE A. LEVIEN; MARK A. MALAMUD; JOHN D. RINALDO, JR. as inventors, filed 19, Sep. 2006, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 11/528,480, entitled OBTAINING USER ASSISTANCE, naming EDWARD K. Y. JUNG; ROYCE A. LEVIEN; MARK A. MALAMUD; JOHN D. RINALDO, JR. as inventors, filed 26, Sep. 2006, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

An embodiment provides a method. The method includes receiving a signal indicative of a user-selected portion of a manual pertaining to an apparatus that includes an electronic device. The method also includes searching a file for an assistance pertaining to the apparatus and corresponding to the user-selected portion of the manual. The method further includes generating a signal indicative of the assistance pertaining to the apparatus and corresponding to the user-selected portion of the manual, wherein the manual is physically distinct from the apparatus. In an alternative embodiment, the method includes facilitating an electronic display of the assistance using a user interface of the electronic device. The facilitating may include facilitating a projection of a display of the assistance from the electronic device. In another alternative embodiment, the method may include displaying at least two user-selectable portions of the manual. In a further embodiment, the method may include establishing a communications link between the manual and the electronic device. In addition to the foregoing, other method embodiments are described in the claims, drawings, and text that form a part of the present application.

Another embodiment provides a system. The system includes an apparatus and a user assistance manager. The apparatus includes a core device operable to perform a core function of the apparatus. The apparatus also includes an electronic display circuit operable to present human-perceivable content using a user interface of the apparatus. The user assistance manager includes a receiver circuit, a query circuit, and a signal generator. The receiver circuit includes a receiver circuit operable to receive a signal originated by a manual having content pertaining to the apparatus, and indicative of a user-selected content portion of the manual. The query circuit includes a query circuit operable to search a file stored on a computer readable medium for a user assistance pertaining to the apparatus and corresponding to the user-selected content portion of the manual. The signal generator includes a signal generator operable to generate a signal indicative of the user assistance pertaining to the apparatus and corresponding to the user-selected content portion of the manual. In an alternative embodiment, the user assistance manager includes a broadcast circuit operable to facilitate using the electronic display circuit a presentation of the assistance pertaining to the apparatus and corresponding to the user-selected content portion of the manual. In addition to the foregoing, other system embodiments are described in the claims, drawings, and text that form a part of the present application.

A further embodiment provides a user manual device. The user manual device includes a display surface operable to present to a human-user at least two portions of content pertaining to an apparatus and selectable by the human-user. The user manual device also includes a user assistance manager. The user assistance manager includes a sensor circuit operable to detect a human-user selection of a presented content portion of at least two portions of presented content. The user assistance manual also includes an analytic circuit operable to search a file stored on a computer readable medium for a human-user assistance related to the user-selected content portion. The user assistance circuit further includes a signal generator circuit operable to generate the signal indicative of the human-user assistance related to the human user-selected content portion. The user assistance manager may include a computer readable medium operable to save a file that includes at least two instances of user assistance pertaining to the apparatus. In addition to the foregoing, other user manual device embodiments are described in the claims, drawings, and text that form a part of the present application.

An embodiment provides a computer program product. The computer program product includes a computer-readable storage medium bearing program instructions. The program instructions are operable to perform a process in a computing device. The process includes receiving a signal indicative of a user-selected portion of a manual pertaining to an apparatus, wherein the manual is physically distinct from the apparatus. The process also includes searching a file for an assistance pertaining to the apparatus and corresponding to the user-selected portion of the manual. The process further includes generating a signal indicative of the assistance pertaining to the apparatus and corresponding to the user-selected portion of the manual. The process may include facilitating an electronic display of the assistance using a user interface of an electronic device associated with the apparatus. In addition to the foregoing, other computer program product embodiments are described in the claims, drawings, and text that form a part of the present application.

Another embodiment provides a machine. The machine includes means for receiving a signal indicative of a user-selected portion of a manual pertaining to an apparatus that includes an electronic device. The machine also includes means for searching a file for an assistance pertaining to the apparatus and corresponding to the user-selected portion of the manual. The machine further includes means for generating a signal indicative of the assistance pertaining to the apparatus and corresponding to the user-selected portion of the manual, wherein the manual is physically distinct from the apparatus. The machine may include means for facilitating an electronic display of the assistance using a user interface of the electronic device. The means for facilitating an electronic display of the assistance using a user interface of the electronic device may further include means for facilitating a projection of a display of the assistance from the electronic device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an exemplary embodiment of a thin computing device in which embodiments may be implemented;

FIG. 2 illustrates an exemplary embodiment of a general-purpose computing system in which embodiments may be implemented;

FIG. 3 is a flow diagram illustrating an exemplary operational flow that provides assistance;

FIG. 4 is a flow diagram illustrating additional detail related to an alternative embodiment of the exemplary operational flow of FIG. 3;

FIG. 5 is a flow diagram illustrating an exemplary operational flow supplementing the exemplary query operational flow that provides assistance described in conjunction with FIG. 3;

FIG. 6 illustrates an exemplary system in which embodiments may be implemented;

FIG. 7 is a flow diagram illustrating an exemplary operational flow that receives an assistance presentation;

FIG. 8 is a flow diagram illustrating another exemplary operational flow that receives an assistance presentation;

FIG. 9 is a flow diagram illustrating an exemplary operational flow that provides contextual assistance;

FIG. 10 is a flow diagram illustrating another exemplary operational flow that provides contextual assistance;

FIG. 11 is a flow diagram illustrating an exemplary operational flow that provides assistance;

FIG. 12 is a flow diagram illustrating a further exemplary operational flow that provides assistance;

FIG. 13 illustrates an exemplary system in which embodiments of the exemplary operational flow illustrated in FIGS. 11 and 14 that provide assistance may be implemented;

FIG. 14 illustrates user interfaces of the exemplary embodiment of the computing device of the exemplary system illustrated in FIG. 13;

FIG. 15 illustrates a partial view of an exemplary apparatus that may serve as an illustrative environment of and/or for subject matter technologies that provide user assistance for an item;

FIG. 16 illustrates an exemplary embodiments of states of a user interface U/I that may serve as an illustrative environment of and/or for subject matter technologies that provide user assistance for an item;

FIG. 17 illustrates an alternative embodiment of the apparatus of FIG. 15 that includes a first user interface and a second user interface both associatable with an aspect of the item;

FIG. 18 illustrates an alternative embodiment of the apparatus of FIG. 15;

FIG. 19 illustrates an exemplary operational flow that provides user assistance for an item;

FIG. 20 illustrates an alternative embodiment of the exemplary operational flow of FIG. 19 that provides user assistance for an item;

FIG. 21 illustrates an alternative embodiment of the exemplary operational flow of FIG. 19 that provides user assistance for an item;

FIG. 22 illustrates an alternative embodiment of the exemplary operational flow of FIG. 19 that provides user assistance for an item;

FIG. 23 illustrates a partial view of an exemplary computer-readable medium product that may serve as an illustrative environment of and/or for subject matter technologies that provide user assistance for an item;

FIG. 24 illustrates a partial view of an exemplary apparatus that may serve as an illustrative environment of and/or for subject matter technologies that provide user assistance for an item;

FIG. 25 illustrates a partial view of an exemplary apparatus that may serve as an illustrative environment of and/or for subject matter technologies that provide user assistance for an item;

FIG. 26 illustrates a partial view of an alternative embodiment of the exemplary apparatus of FIG. 24;

FIG. 27 illustrates an exemplary operational flow that provides a user assistance with an item;

FIG. 28 illustrates an exemplary operational flow that provides a user assistance with an item;

FIG. 29 illustrates a partial view of an exemplary apparatus that may serve as an illustrative environment of and/or for subject matter technologies that provide user assistance for an item;

FIG. 30 illustrates a partial view of an exemplary apparatus that may serve as an illustrative environment of and/or for subject matter technologies that provide user assistance for an item;

FIG. 31A illustrates an exemplary embodiment where the user interface includes a plurality of states;

FIG. 31B illustrates an exemplary embodiment where the user interface includes a plurality of modes;

FIG. 32 illustrates a partial view of an alternative embodiment of the exemplary apparatus of FIG. 30;

FIG. 33 illustrates a partial view of an alternative embodiment of the exemplary apparatus of FIG. 30;

FIG. 34 illustrates a partial view of an exemplary apparatus that may serve as an illustrative environment of and/or for subject matter technologies that provide user assistance for an item;

FIG. 35 illustrates an exemplary operational flow that provides a user assistance with an item;

FIG. 36 illustrates an alternative embodiment of the exemplary operational flow of FIG. 35;

FIG. 37 illustrates an alternative embodiment of the exemplary operational flow of FIG. 35;

FIG. 38 illustrates an alternative embodiment of the exemplary operational flow of FIG. 35;

FIG. 39 illustrates an alternative embodiment of the exemplary operational flow of FIG. 35;

FIG. 40 illustrates a partial view of product that includes an exemplary computer-readable medium product that may serve as an illustrative environment of and/or for subject matter technologies that provide user assistance for an item;

FIG. 41 illustrates an exemplary operational flow that provides a user assistance with an item, such as the item;

FIG. 42 illustrates a partial view of an exemplary apparatus that may serve as an illustrative environment of and/or for subject matter technologies that provide user assistance for an item, such as the item;

FIG. 43 illustrates an example environment in which embodiments may be implemented;

FIG. 44 illustrates an example of an operational flow;

FIG. 45 illustrates an alternative embodiment of the operational flow of FIG. 44;

FIG. 46 illustrates another alternative embodiment of the operational flow of FIG. 44;

FIG. 47 illustrates a further alternative embodiment of the operational flow of FIG. 44;

FIG. 48 illustrates an alternative embodiment of the operational flow of FIG. 44;

FIG. 49 illustrates an example system;

FIG. 50 illustrates an example system;

FIG. 51 illustrates an example computer program product; and

FIG. 52 illustrates an example machine.

### DETAILED DESCRIPTION

In the following detailed description, reference is made to the accompanying drawings, which form a part hereof. In the drawings, similar symbols typically identify similar components, unless context dictates otherwise. The illustrated embodiments described in the detailed description, drawings, and claims are not meant to be limiting. Other embodiments may be utilized, and other changes may be made, without departing from the spirit or scope of the subject matter presented here.

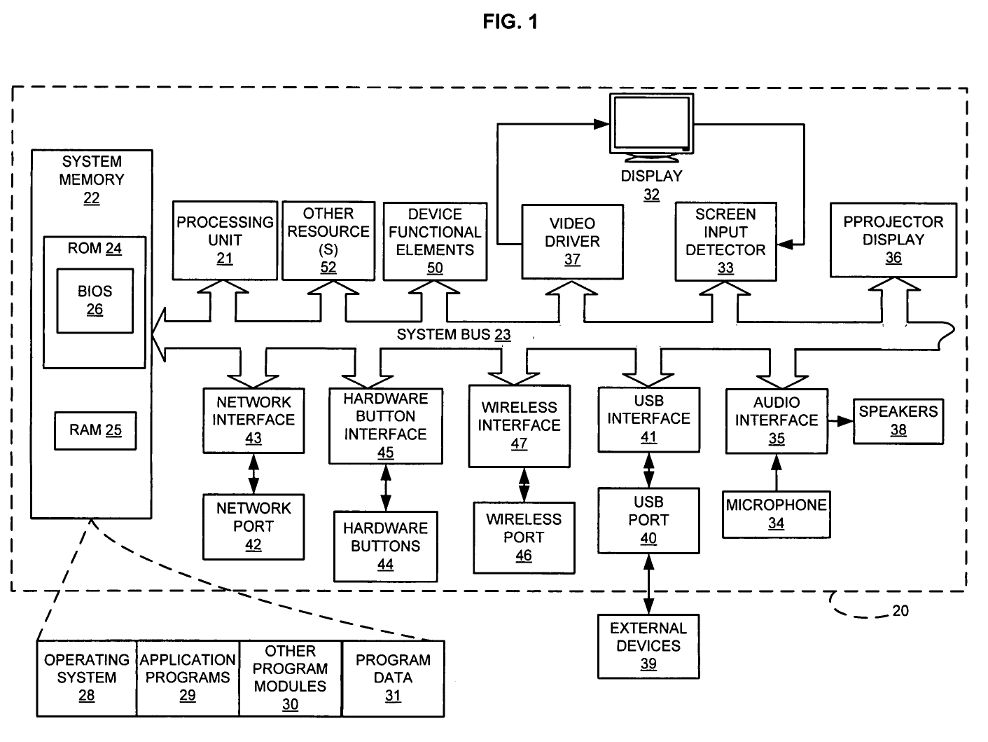

FIG. 1 and the following discussion are intended to provide a brief, general description of an environment in which embodiments may be implemented. FIG. 1 illustrates an exemplary system that includes a thin computing device 20, which may be included in an electronic device that also includes a device functional element 50. For example, the electronic device may include any item having electrical and/or electronic components playing a role in a functionality of the item, such as a limited resource computing device, a wireless communication device, a mobile wireless communication device, an electronic pen, a handheld electronic writing device, a digital camera, a scanner, an ultrasound device, an x-ray machine, a non-invasive imaging device, a cell phone, a PDA, a Blackberry® device, a printer, a refrigerator, a car, or an airplane.

The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 and/or RAM 25, including an operating system 28, one or more application programs 29, other program modules 30 and program data 31.

A user may enter commands and information into the computing device 20 through input devices, such as a number of switches and buttons, illustrated as hardware buttons 44, connected to the system via a suitable interface 45. Input devices may further include a touch-sensitive display with suitable input detection circuitry, illustrated as a display 32 and screen input detector 33. The output circuitry of the touch-sensitive display 32 is connected to the system bus 23 via a video driver 37. Other input devices may include a microphone 34 connected through a suitable audio interface 35, and a physical hardware keyboard (not shown). Output devices may include at least one the display 32, or a projector display 36.

In addition to the display 32, the computing device 20 may include other peripheral output devices, such as at least one speaker 38. Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are exemplary and other components and means of establishing communications links may be used.

The computing device 20 may be primarily designed to include a user interface. The user interface may include a character, a key-based, and/or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and is coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, and a camera capturing and saving an image.

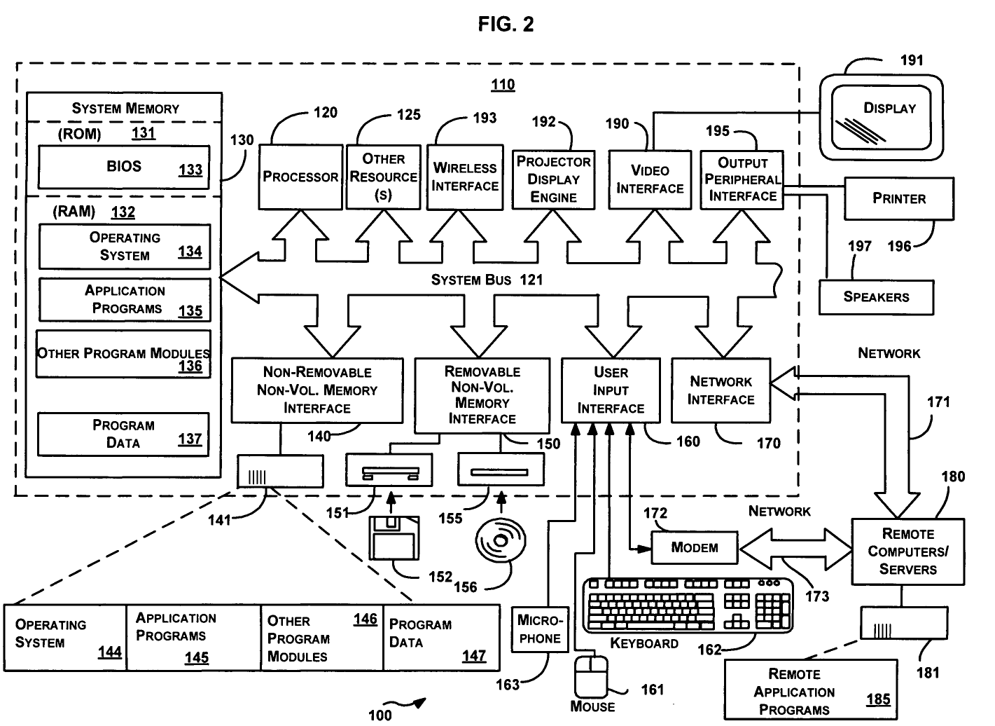

FIG. 2 illustrates an exemplary embodiment of a general-purpose computing system in which embodiments may be implemented, shown as a computing system environment 100. Components of the computing system environment 100 may include, but are not limited to, a computing device 110 having a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media may include computer storage media and communications media.

Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, and/or atomic quantum memory. Combinations of any of the above may also be included within the scope of computer-readable media.

Communications media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as a wired network and a direct-wired connection, and wireless media such as acoustic, RF, optical, and infrared media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, and/or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by processing unit 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS” are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, and/or is coupled to an optical disk drive 155 that reads from and writes to a removable, non-volatile optical disk 156, such as a CD ROM. Other removable/nonremovable, volatile/non-volatile computer storage media that can be used in the exemplary operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies.

A user may enter commands and information into the computing device 110 through input devices such as a microphone 163, keyboard 162, and pointing device 161, commonly referred to as a mouse, trackball, or touch pad. Other input devices (not shown) may include at least one of a touch sensitive display, joystick, game pad, satellite dish, and scanner. These and other input devices are often connected to the processing unit 120 through a user input interface 160 that is coupled to the system bus, but may be connected by other interface and bus structures, such as a parallel port, game port, or a universal serial bus (USB).

A display 191, such as a monitor or other type of display device or surface may be connected to the system bus 121 via an interface, such as a video interface 190. A projector display engine 192 that includes a projecting element may be coupled to the system bus. In addition to the display, the computing device 110 may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The network logical connections depicted in FIG. 2 include a local area network (LAN) and a wide area network (WAN), and may also include other networks such as a personal area network (PAN) (not shown). Such networking environments are commonplace in offices, enterprise-wide computer networks, intranets, and the Internet.

When used in a networking environment, the computing system environment 100 is connected to the network 171 through a network interface, such as the network interface 170, the modem 172, and/or the wireless interface 193. The network may include a LAN network environment, and/or a WAN network environment, such as the Internet. In a networked environment, program modules depicted relative to the computing device 110, or portions thereof, may be stored in a remote memory storage device. By way of example, and not limitation, FIG. 2 illustrates remote application programs 185 as residing on computer storage medium 181. It will be appreciated that the network connections shown are exemplary and other means of establishing communications link between the computers may be used.

FIGS. 1 and 2 illustrate an example of an environment in which embodiments may be implemented. The computing device 20 of FIG. 1 and/or computer 100 of FIG. 2 are examples of an environment and are not intended to suggest any limitation as to the scope of use or functionality of an embodiment. Neither should the environment be interpreted as having any dependency or requirement relating to any one or combination of components illustrated in an exemplary operating environment.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, server computers, hand-held or laptop devices, personal digital assistants, multiprocessor systems, microprocessor-based systems, set top boxes, programmable consumer electronics, network PCs, minicomputers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in distributed computing environments where tasks are performed by remote processing devices that are linked through a communications network. In a distributed computing environment, program modules may be located in both local and remote computer storage media including memory storage devices.

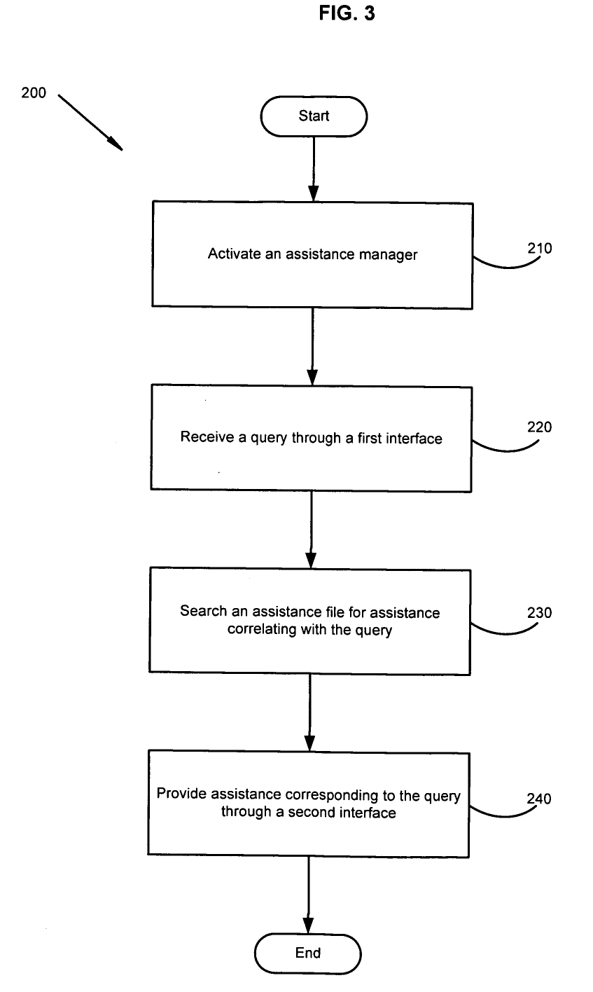

FIG. 3 is a flow diagram illustrating an exemplary operational flow 200 that provides assistance. After a start operation, the operation moves to operation 210. At activation operation 210, an assistance manager is activated. The assistance manager typically includes instructions, such as computer-readable instructions, for example, a program, process, and/or application operating on an electronic device that implements the exemplary operational flow 200 that provides assistance.

At query operation 220, a query related to an electronic device is received through a first interface associated with the electronic device. The query may include a selection of an aspect of the electronic device as a subject of the query. The query may include any aspect of the electronic device for which a user might desire assistance, such as, a feature of the device, an element of the device, and a process associated with the device. The query related to the electronic device may include an assistance request related to the electronic device. The assistance request may include a request related to the electronic device in any manner, including the selected aspect of the electronic device. For example, the assistance request may include any request related to the electronic device, such as “show me,” “demonstrate,” and “guide me.” The first interface may include a first user interface.

The electronic device may be incorporated into any type of appliance and/or item. In certain embodiments, the electronic device may include a computing device, such as a personal computer and a server. In other embodiments, the electronic device may include a limited resource computing device, an appliance, a pervasive computing device, and a digital appliance. Examples may include a PDA, a cell phone, a Blackberry appliance, an on-board computing device, such as in a car, boat, and/or aircraft, an X-Box, a home gateway, a set-top box, a point-of-sale terminal, a digital camera, a TiVo, and an automated teller machine. By way of further example, the electronic device may include a computing device and the query may relate to an aspect of the computing device. The electronic device may include an electrical appliance and the query may relate to an aspect of the electrical appliance. The electronic device may include a limited resource computing device and the query may relate to an aspect of the limited resource computing device. The electronic device may include a pervasive computing device and the query may relate to an aspect of the pervasive computing device. The electronic device may include a digital appliance and the query may relate to an aspect of the digital appliance.

At search operation 230, an assistance file is searched for an assistance response correlating to the query. Searching the assistance file may include searching an assistance file stored in a storage media associated with the electronic device, such as the system memory 22 of FIG. 1, or coupled with the electronic device. Alternatively, the assistance file may be stored and/or searched remotely and coupled with a functionality of the operation 230, such as by a network, such as a LAN, a WAN, or the Internet.

At assistance operation 240, an assistance response is provided correlating to the query through a second interface of the electronic device. In an embodiment, the assistance response provided may include visually providing an assistance with a physical element of the device, such as blinking a light associated with the physical element. For example, the physical element may be a physical button and the light may be a light emitting device incorporated into the button. In this example, the assistance may include blinking the LED associated with the button. In an alternative embodiment, the second interface may include an LED and a third interface may include a speaker. The provided assistance may include providing an audible assistance presentation from the speaker and blinking the LED appropriately during the presentation. The audible assistance presentation may include a spoken presentation that includes a word or words. The providing an assistance further may include tactilely providing an assistance presentation.

The provided assistance may include guidance through a process associated with the aspect of the device, a description of the aspect of the device, a showing how the aspect of the device operates, and/or an interactive tutorial. The assistance may be provided in any manner, such as a visual presentation, an audio presentation, a spoken presentation, a tactile presentation, and/or a combination of two or more of these manners of presentation.

In an embodiment, the second interface may be a second user interface. The second user interface may include a visual display, a graphical display, and a graphical user interface. The second user interface may include an audio display, such as an acoustic speaker. Further, the second user interface may include a tactile interface, such as a vibrating component. The operational flow then proceeds to an end operation.

The first interface and the second interface may be at least substantially similar, and the second user interface may include the first user interface. In an embodiment, the first interface and the second interface may comprise a same physical or virtual element of the electronic device. The first interface and the second interface may share a same physical or virtual element, but be separately activated when the physical or virtual element is in different activate modes or states. For example, an interface having a physical structure and in a first state may function as the first interface, and in a second state may function as the second interface. In this example, a single physical button interface may have a plurality of interface states. Continuing with these examples, a physical button associated with an electronic device may have normal operating function related to the electronic device. Upon activation of an assistance manager and entry into an assistance mode, the same physical button transitions to a first state and functions as the first interface that receives a query, such as at the query operation 220. Upon occurrence of an event, such as receipt of the query at the query operation 220, or finding an assistance correlating to the query at the search operation 230, the same physical button transitions to a second state. In the second state, the physical button functions as the second interface that provides assistance correlating to the query, such as at the provide operation 240.

In another example, an interface, such as a physical button, may function as a first interface when operated in a first mode and function as a second interface when operated in a second mode. In this example, a single physical button may function as a first interface when pressed quickly once and as a second interface when pressed slowly once. Continuing with this example, the single physical button may function as a first interface when pressed once and as a second interface when pressed twice in quick succession.

In an embodiment, the operational flow 200 that provides assistance may be considered to be an electronic-device assistance manager. The assistance manager may be implemented in any combination of hardware, software, and/or firmware configured to effect the operational flow 200 that provides assistance, depending upon the design choices of the system designer. A further embodiment includes a computer-readable media containing computer instructions which, when run on a computing device, cause the computing device to perform the operational flow 200 that provides assistance. The computer-readable media may include a computer storage media, which may be carried by a computer-readable carrier, such as a floppy disk. Alternatively, the computer-readable media may include a communications media.

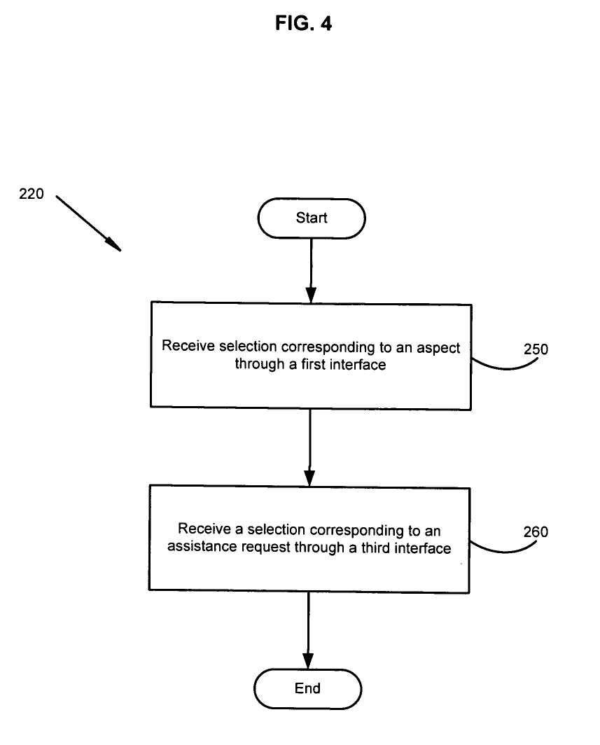

FIG. 4 is a flow diagram illustrating additional detail related to an alternative embodiment of the exemplary query operation 220 of FIG. 3. At aspect selection operation 250, a selection corresponding to the electronic device is received through the first interface. As described in conjunction with query operation 220 of FIG. 3, the selection designates a subject matter of the query, and may include a selection of an aspect of the electronic device. The selection may include an aspect related to the electronic device, such as, a component associated with the device, a feature associated with the electronic device, a function associated with the electronic device, a program associated with the electronic device, and a process associated with the electronic device. In an embodiment, the first interface may include a first user interface.

In an embodiment, the selection may be received by detecting a touch to a first user interface associated with the electronic device, such as a button or a component. The touch may be received in any manner. For example, such as from a user body part physically contacting the first user interface, a user body part being proximate to the first user interface, and a user body part having an orientation to the first user interface. Similarly, for example, a touch may be received by a stylus physically contacting the first user interface, being proximate to the first user interface, and having an orientation to the first user interface.

The first user interface may be associated with an aspect of the electronic device, such as a physical association. Using a button for example, a first user interface may be included within a physical structure of a button, or the first user interface may be adjacent or proximate to the button. The association of a button or component and the first user interface may include a logical association. By a way of further example, an association may include a touch sensitive portion of a visual display surface. When the visual display surface displays an image or icon visually associated with an aspect of an electronic device, a touch to the displayed image or icon, or a portion of the visual display surface proximate to the displayed image or icon, may be detected and received as a selection through an interface logically associated with the electronic device, or an interface logically associated with an aspect of the electronic device.

In another embodiment, the selection may be received by detecting a sound or word. For example, the first user interface may include a microphone and processing capability to detect a sound or spoken word corresponding to a selection related to the electronic device, or to an aspect of the electronic device. For example, detecting a signal corresponding to the spoken words “lens cover” selects a lens cover of a digital camera, and is received as a selection related to the electronic device, or to the lens cover of the electronic device.

At assistance selection operation 260, a selection corresponding to an assistance request is received. In an embodiment, the selection is received through a third interface of the electronic device, and the third interface may include a third user interface. The receiving a selection corresponding to an assistance request associated with the selection may include detecting a touch to the third user interface. The third user interface may include a button. The third user interface may include at least one predetermined query. The selection corresponding to an assistance request may include a request for a description of functionality, a request for a description of process, a request for instruction, a request for information, and/or a request for guidance. The request for guidance may include a request for a guidance related to replicating a previous operation of the device. The receiving a selection corresponding to an assistance request may include receiving a selection corresponding to an assistance request selected from a plurality of selections.

At least two of first, second, and third user interfaces may be at least substantially similar. In an embodiment, and similar to the embodiment of the exemplary operational flow 200 that provides an assistance described in conjunction with FIG. 3, at least two of the first interface, the second interface, and the third interface may comprise a same physical or virtual device. At least two of the interfaces may share a same physical or virtual device, but be separately activated when the physical or virtual device is in a different mode or state.

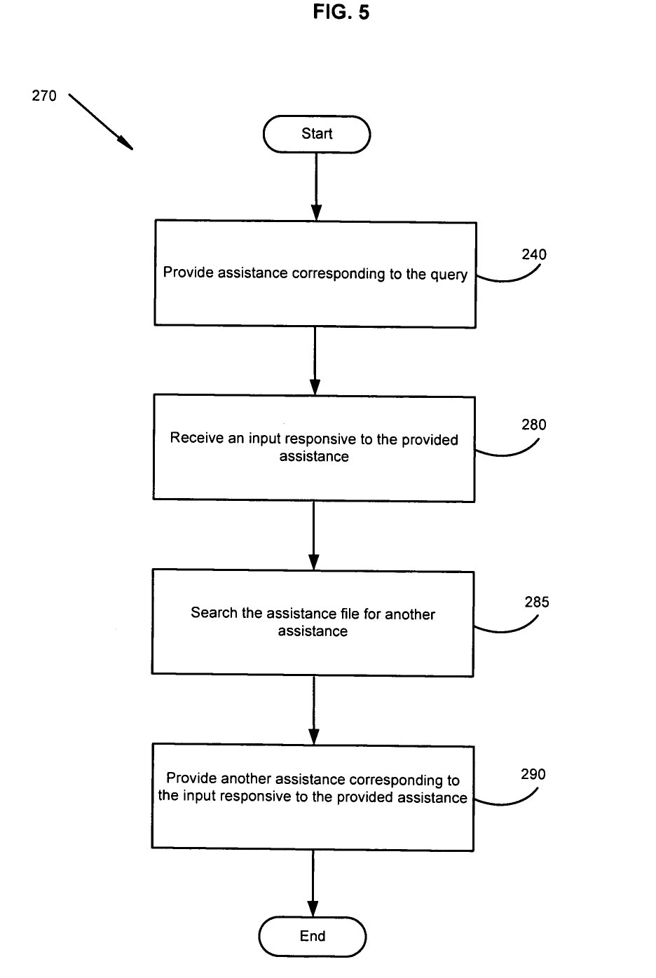

FIG. 5 is a flow diagram illustrating an exemplary operational flow 270 that provides an additional assistance, supplementing the exemplary operational flow 200 described in conjunction with FIG. 3. The exemplary operational flow 270 provides an additional assistance. After a start operation, and after the provide assistance operation 240 of FIG. 3, the exemplary operation 270 moves to a receive input operation 280. At the receive input operation 280, an input relating to the provide assistance operation 240 is received. The input may be received through any interface, including one or more of the user interfaces described in conjunction with the exemplary operational flow 200 and FIG. 3. In addition, the input may be received through an addition interface of the electronic device. The input relating to the provide assistance operation 240 may include a request for an additional assistance correlating to the assistance provided by the provide assistance operation 240. Alternatively, the input responsive to the provide assistance operation 240 may include a request that further correlates to the aspect of the device.

At a search operation 285, the assistance file is searched for another assistance response correlating to the input relating to the provide assistance operation 240. The assistance file may be searched in a manner substantially similar to the searching an assistance file at the search operation 230. At provide assistance operation 290, the another assistance is provided. The another assistance may be any type of assistance, including one or more of the types of assistance described above, and may include an interactive question and answer format, and a tutorial format. The exemplary operation 270 then moves to an end operation.

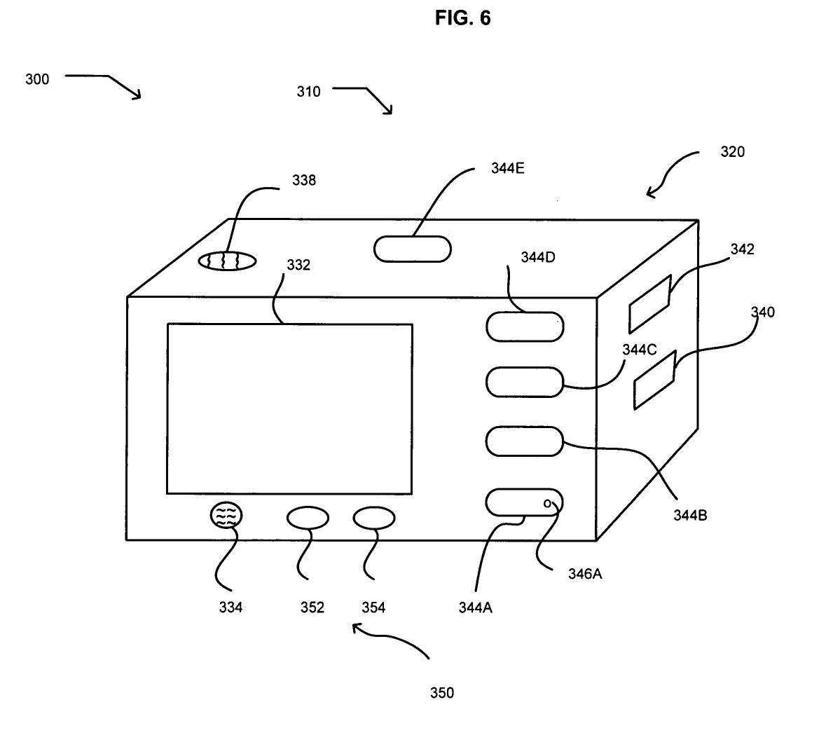

FIG. 6 illustrates an exemplary system 300 in which embodiments may be implemented. The system 300 includes a digital camera 310 having image capture and image storage functionality. The digital camera 310 includes a computing device (not shown), such as the thin computing device 20 described in conjunction with FIG. 1. The digital camera 310 also includes a plurality of interfaces 320. The plurality of interfaces 320 includes a display 332. In alternative embodiments, the display 332 may provide a textual, a visual display, and a graphical display. In a further embodiment, the display 332 may include touch screen functionality operable to accept a user input. The plurality of user interfaces 320 of the camera 310 also includes a microphone 334, a speaker 338, and a plurality of tangible buttons 344A-344E. One or more of the tangible buttons may include a light emitter, such as a light emitting device 346A. Further, one or more of the tangible buttons 344A-344E may include a vibrator operable to provide a tactile display. The display 332 and the tangible buttons 344A-344E may have any functionality appropriate to the digital camera. For example, button 344E may be assigned to operate a camera element, such as a shutter function. Button 344A may be assigned an “enter” function, and buttons 344B and 344C may be respectively assigned a scroll up and scroll down function relative to a menu displayed on the display 332. Button 344D may be assigned to operate another camera element, such as a lens zoom function. The digital camera 310 also includes context sensors 350, which may be selected, for example, to produce relevant information about an environment extrinsic to the digital camera. The context sensors 350 are illustrated as an external temperature sensor 352 and a light intensity sensor 354. The digital camera 310 further includes a USB port 340, and a network port 342.

The digital camera 310 also includes a system memory (not shown), such as the system memory 22 of the thin computing device 20 of FIG. 1. The system memory includes stored operating systems and programs necessary to operate the digital camera 310, and also includes an assistance manager operable to implement the operational flow 200 that provides assistance of FIG. 3. The system memory also includes an assistance file, which may be included in the assistance manager. The assistance file includes a body of assistance information intended to help a user in response to a plurality of user-selected requests related to the digital camera 310. The assistance manager and/or the assistance file may be provided by an original equipment manufacturer of the camera 310, or it may be provided by a third party.

The assistance manager includes operability to receive a query related to the digital camera 310 through an interface of the plurality of interfaces 320. For example, in an embodiment, detecting a user touch to the button 344D may be received as an instruction to activate the assistance manager, such as the assistance manager at operation number 210 of FIG. 3. Activation of the assistance manager transitions the user interfaces 320 to a first state. A detected subsequent user touch to another user interface of the plurality of user interfaces 320 may be received by the assistance manager a query related to the digital camera 310.

Alternatively, a detected subsequent user touch to another user interface of the plurality of user interfaces 320 may be received by the assistance manager as a selection corresponding to an aspect of the digital camera 310. The user touch may be detected by a user interface physically incorporated in the aspect of the digital camera 310 or proximate thereto.

In an alternative embodiment, the query may be received by detecting a signal responsive to a sound or voice received by the microphone 334. For example, a detection and recognition of a signal responsive to a spoken “help” command to the microphone 334 may be received as an instruction to activate the assistance manager. Further, a detection and recognition of a signal responsive to spoken words “shutter button” may be received by the assistance manager has a selection corresponding to an aspect of the digital camera 310.

The assistance manager includes operability to provide assistance, such as information, advice, guidance, and instructions, through at least one the plurality of interfaces 320 of the digital camera 310, such as the display 332, the tangible buttons 344A-344E, and the speaker 338. In an embodiment, the provided assistance may include any type of presentation, such as a visual presentation, an audio presentation, a spoken presentation, a tactile presentation, and a combination of two or more of the foregoing presentation modes. In another embodiment, the assistance file includes operability to provide interactive assistance with additional user inputs being received through the camera user interfaces 320.

An alternative embodiment implements the query operation 220 in two parts as described in conjunction with FIG. 4. Activation of the assistance manager transitions the user interfaces 320 to a first state. A detected subsequent user touch to another user interface of the plurality of user interfaces 320 may be received by the assistance manager as a received aspect selection operation 250, as described in conjunction with FIG. 4. On receiving the selection 250, the assistance manager transitions the user interfaces to a second state. A detected subsequent user touch to a user interface of the plurality of user interfaces 320 may be received as selection corresponding to an assistance request through the second user interface of the electronic device. For example, once the assistance manager transitions the user interfaces 320 to the second state, information may be displayed on the display 332 indicating assistance selections associated with the buttons 344A-344C. The buttons may be appropriately referenced by information displayed on the display 332, such as “show me,” “demonstrate,” and “guide me” respectively. A selection corresponding to an assistance request is received by the assistance manager as received selection corresponding to an assistance selection operation 260 as described in conjunction with FIG. 4.

In the above alternative environment, detection of a signal responsive to a sound or voice received by the microphone 334, the assistance selection operation 260 may be received by detection and recognition of a signal responsive to spoken commands received by the microphone, such as “show me,” “demonstrate,” and “guide me.”

In operation of an embodiment, a user interested in receiving assistance related to the digital camera activates the assistance manager by a long touch to at least one interface of the plurality of interfaces 320. In this illustrative operation of an embodiment, the button 344D in a long-touch mode is designated as an assistance manager activation button. The assistance manager is activated in response to the button 344D receiving a long touch. The assistance manager transitions the buttons 344A-344E to a first state. The user inputs the selection corresponding to an aspect of the digital camera 310 by touching an interface associated with the aspect. For example, a user touch may be received at button 344E, the shutter button, by an interface normally associated with the shutter button. Because the assistance manager has been activated and the buttons are in a first state, the touch to the button 344E is received as an-input selection corresponding to an aspect of the digital camera, the shutter button. The assistance manager then transitions the buttons 344A-344E to a second state and displays a plurality of assistance requests which are visually associated with the buttons 344A-344C. The buttons 344A-344C may be appropriately reference by information displayed on the display 332, such as “show me,” “demonstrate,” and “guide me” respectively. The association may be by lead lines indicating a visual association between a respective word and their respective button. A user touch to one of the buttons 344A-344C is received by the assistance manager as a selection corresponding to an assistance request. For example, if the button 344A is visually associated with “demonstrate,” a user touch detected at an interface associated with button 344A is received as a selection corresponding to an assistance request for a demonstration of the shutter button.

In an alternative embodiment, voice commands may be used to implement part or all of the operational flow 200 that provides assistance. Selections and inputs may be received from signals responsive to sounds and words detected by the microphone 334 and recognized. For example, the activation of the assistance manager program, the selection corresponding to an aspect of the digital camera 310, and the assistance request, may occur in response to a received sound, spoken word, and/or a spoken phrase. For example, a user may say “assistance manager” to activate the assistance manager, say “shutter button” as a selection corresponding to an aspect of the digital camera, and say “demonstration” as a selection corresponding to an assistance request.

The assistance manager searches the assistance file stored in the system memory of the thin computing device included in the digital camera 310 for an assistance correlating with the user-selected query for a demonstration of the shutter button. An assistance is provided correlating to the query through at least one interface of the plurality of interfaces 320.

The digital camera 310 provides assistance correlating to the user query through the user interfaces 320 of the digital camera. For example, the assistance may include providing in the display 332 a demonstrative visual presentation of the functions and capability of the shutter button 344E. The assistance may further include flashing the light emitter (not shown) associated with the shutter button 344E as appropriate to indicate when the shutter button should be pressed. The assistance may also provide a voice track through the speaker 338, the voice track may be coordinated with the visual presentation in the display 332 and flashing the light emitter associated with the shutter button 344E.

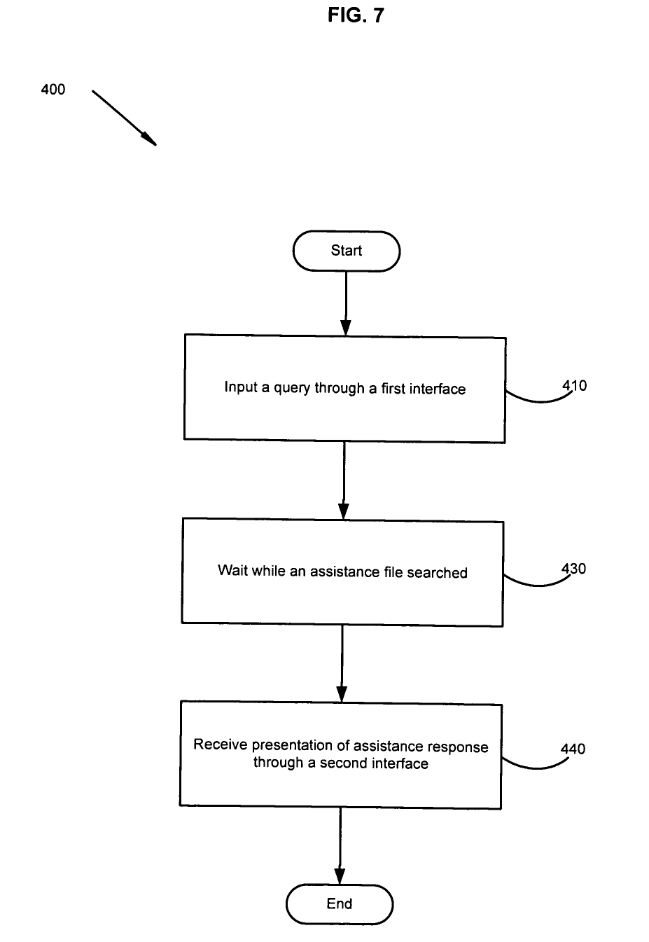

FIG. 7 is a flow diagram illustrating an exemplary operational flow 400 that receives an assistance presentation. After a start operation, the operation moves to an input operation 410. At the input operation 410, a query related to an aspect of an electronic device is inputted through a first interface of the electronic device. The query may typically be inputted by a human user. At wait operation 430, an inputter waits while an assistance file is searched for an assistance response correlating to the input operation 410. At receive assistance operation 440, a presentation of the assistance response correlating to the query is received through a third interface of the electronic device.

At least one of the first and second interfaces may be user interfaces, and the first and second interfaces may be at least substantially similar. In an embodiment, and similar to the embodiment of the exemplary operational flow 200 that provides an assistance described in conjunction with FIG. 3, the first interface and the second interface may comprise a same physical or virtual device. The first and second interfaces may share a same physical or a same virtual device, but be separately activatable when the physical or virtual device is in a different activating mode or state.

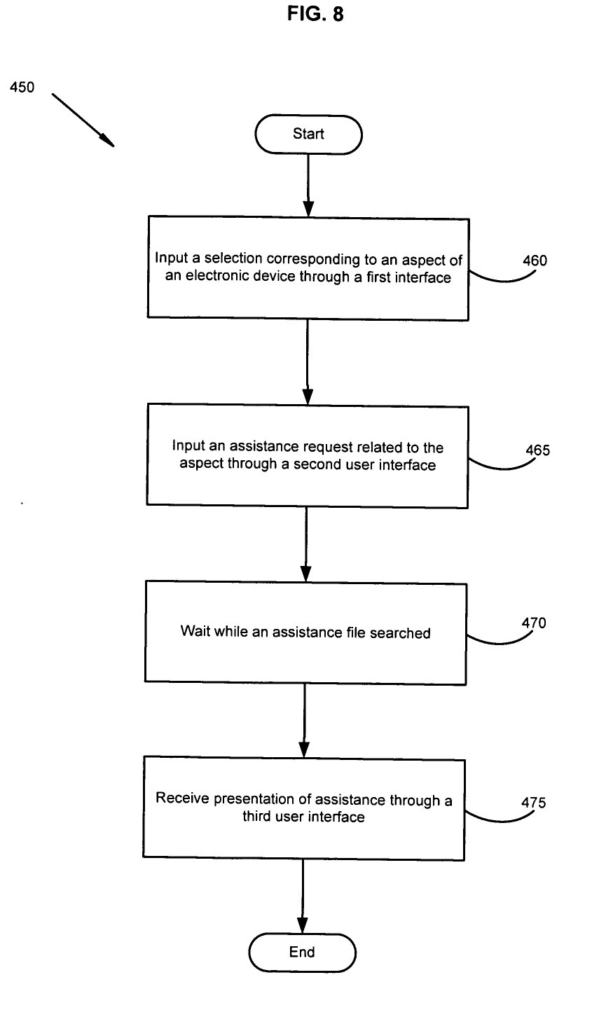

FIG. 8 is a flow diagram illustrating an exemplary operational flow 450 that receives an assistance presentation. After a start operation, the operation moves to a selection operation 460. At selection operation 460, a selection corresponding an aspect of an electronic device is inputted through a first user interface associated with the electronic device. At request operation 465, an assistance request related to the aspect is inputted through a second user interface associated with the electronic device. The selection and request may typically be inputted by a human user. At wait operation 470, the inputter waits while an assistance file is searched for the assistance presentation correlating to the assistance request. At receive assistance operation 475, an assistance presentation correlating to the assistance request is received through a third user interface associated with the electronic device. The exemplary operational flow 450 then proceeds to an end operation.

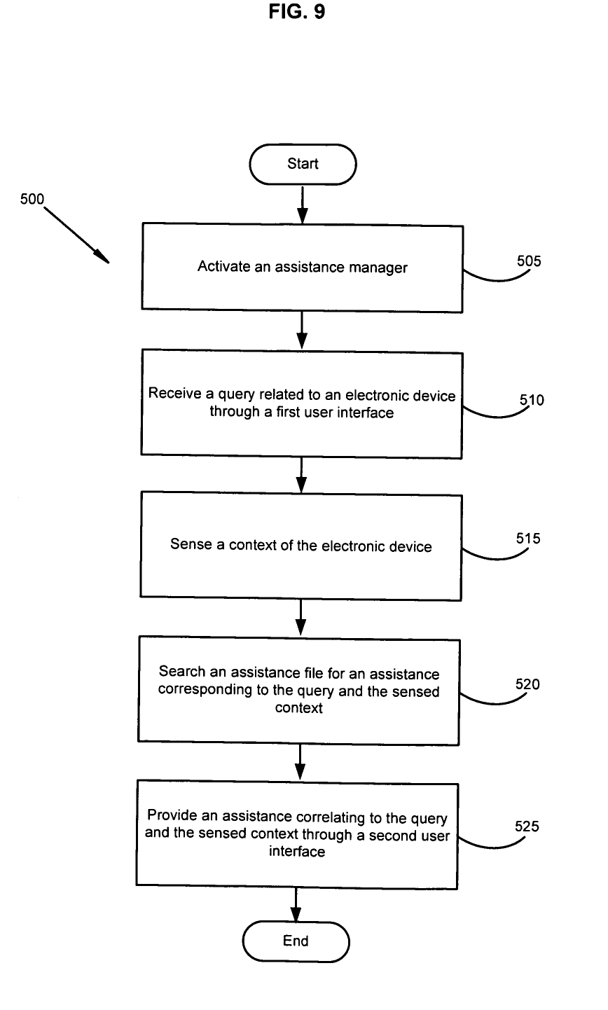

FIG. 9 is a flow diagram illustrating an exemplary operational flow 500 that provides contextual assistance. After a start operation, the operation moves to a help activation operation 505. At help activation operation 505, an assistance manager is activated. The assistance manager may include a circuit, a module, and/or instructions, such as computer-readable instructions, for example, a program, process, and/or application operating on an electronic device, that implement the exemplary operation 500 that provides assistance.

At query receive operation 510, a query related to an electronic device is received through a first user interface associated with the electronic device. In an embodiment, the first user interface may include a first user interface associated with an aspect of the electronic device. The association may include any form of association with the aspect of the electronic device, such as, for example, a physical association and a virtual association.

In a further embodiment, the first user interface may include a button. The button may include anything that accepts a user input expression. For example, the button may include a tangible button, and a virtual button. By way of further example, the receiving a selection of an aspect of the electronic device through a first user interface associated with the electronic device may include detecting a touch through a first user interface associated with the electronic device.

The query may be received in any manner through the first user interface. For example, the query may be received by detecting a touch to the first user interface, by detecting a sound through the first user interface, and/or by detecting a spoken word. The electronic device may include any type of electronic device. For example, an electronic device may include a computing device, a pervasive computing device, a limited resource computing device, and/or an electrical appliance. The query may include a query related to an aspect of the electronic device.

At context operation 515, a context of the electronic device is sensed. The sensed context may include any contextual parameter related to the electronic device. For example, the sensed context may include sensing a context extrinsic to the electronic device, an environment extrinsic to the electronic device, and/or a context intrinsic to the electronic device.

The intrinsic context may include any intrinsic context or state of the electronic device. For example, sensing a context intrinsic to the electronic device may include sensing a configuration context, a software context intrinsic to the electronic device, and/or a hardware context.

The query receive operation 510 may include receiving a query related to an electronic device and a sensed context of the electronic device. For example, a query may include a request for assistance correlating to taking a portrait where a sensed context at context operation 515 includes a sensed mountain background context.

At search operation 520, an assistance file is searched for an assistance correlating with the query and the sensed context. The assistance file may have any association with the electronic device. For example, the assistance file may be saved in a storage physically incorporated in the electronic device, a storage local to the electronic device, and saved in a storage accessible to the electronic device over a network.

At broadcast operation 525, an assistance correlating to the query and the sensed context is provided through a second user interface associated with the electronic device. The provided assistance may be any assistance correlating to both the query and the sensed context. For example, the provided assistance may include a guided response assistance, an interactive tutorial assistance, an assistance correlating with a physical element of the electronic device, a guidance correlating with a process associated with the electronic device, showing how an aspect of the device operates, and/or a description of an aspect of the electronic device. The provided assistance may be presented in any manner through the second user interface. For example, the provided assistance may include visually providing an assistance, such as blinking a light emitter associated with a physical element of the electronic device, or displaying text, graphics or pictures on a visual display associated with the electronic device. Further, the provided assistance may include audibly providing an assistance, such as a spoken assistance, and/or tactilely providing an assistance, such as by vibrating a physical element of the electronic device.

In an embodiment, the first user interface may include an element of the electronic device in a first state and the second user interface may include the element of the electronic device in a second state. In an alternative embodiment, the first user interface may include an element of the electronic device in a first mode and the second user interface may include the element of the electronic device in a second mode. The second user interface may include the first user interface.

The operational flow 500 then proceeds to an end operation.

In an embodiment, the exemplary operational flow 500 that provides contextual assistance may be considered to be an electronic device assistance manager. The assistance manager may be implemented in any combination of hardware, software, and/or firmware configured to effect the operational flow 500 that provides assistance, depending upon the design choices of the system designer. A further embodiment includes a computer-readable media containing computer instructions which, when run on a computing device, cause the computing device to perform the operational flow 500 that provides assistance. The computer-readable media may include a computer storage media, which may be carried by a computer-readable carrier, such as a floppy disk. Alternatively, the computer-readable media may include a communications media.

The exemplary operational flow 500 that provides contextual assistance may be implemented in any device or item where enhanced contextual user assistance may be advantageously employed. For example, the exemplary operational flow 500 may be implemented in the system 300 described in conjunction with FIG. 6. The digital camera 310 of the system 300 includes context sensors 350, which are illustrated as the temperature sensor 352 and the light intensity sensor 354. In this example, the assistance manager includes operability to implement the exemplary operational flow 500. Continuing with the operational example described in conjunction with FIG. 6, a user interested in receiving assistance activates the assistance manager at help activation operation 505 by a long touch to the button 344D.

At query receive operation 510, the assistance manager operates in a manner similar to that described in conjunction with FIG. 6 for query operation 220 where a touch to the shutter button 344E is detected as a query. At context operation 515, the assistance manager operates to sense a context of the electronic device. In this example, the context is sensed through the external temperature sensor 352 and the light intensity sensor 354. If for example, the context of the digital camera 310 is a snowy environment on a sunny day, the external temperature sensor 352 would sense temperatures at or below freezing, and the light intensity sensor 354 would sense strong sunlight. By way of further example, if the context of the digital camera 310 is a tropical beach, the external temperature sensor 352 would sense a warm temperature and the light sensor 354 would sense bright sunlight. In another example, if the context of the digital camera 310 was indoors under incandescent lighting, the external temperature sensor 352 would sense a room temperature and the light sensor 354 would sense a light frequency pattern corresponding to incandescent lighting.

At the search operation 520, the assistance manager searches an assistance file for an assistance correlating to both the query related to the user selected shutter button 344E and the sensed context. Using the above example where the digital camera is in a snowy environment on a sunny day, the assistance manager program may search an assistance file for a user assistance correlating to selecting shutter speeds used in a bright sunlight and cold temperature environment.

At the broadcast operation 525, the assistance manager provides a user assistance correlating to the query and the sensed context through a second user interface of the digital camera 310. Using the above example of the snow scene, the provided assistance may include recommending a fast shutter speed. The provided assistance may include a recommendation to protect the camera lens from fogging in the cold environment. The second user interface may include any user interface associated with the electronic device, and may include a combination of two or more user interfaces. For example, in an embodiment, the second user interface includes a visual display. The visual display may include a visual display surface, such an liquid crystal display, and/or may include a light emitter, such as small light emitting diode incorporated in a physical button.

In a further embodiment, the query receive operation 510 may include receiving a query related to an electronic device and a sensed context of the electronic device. A context sensor may include a program operable to recognize certain extrinsic environments from images acquired through a lens of the digital camera 310. The assistance manage may receive an user query requesting assistance in taking a portrait in a context of “this background,” and receive an image of “this background” resulting from the user capturing an image of “this background” through the lens of the digital camera 310. At the context operation 515, a recognition aspect of the assistance manager determines the context of “this background” from the user captured image. For example, if the recognition aspect of the assistance manager determines includes a mountain background, 515 includes a sensed mountain background context. Continuing with this embodiment, at the search operation 520, the assistance manager searches an assistance file for an assistance correlating to both the query related to the user selected shutter button 344E and the sensed extrinsic context acquired in response to a user action in capturing “this background” through the digital camera 310.

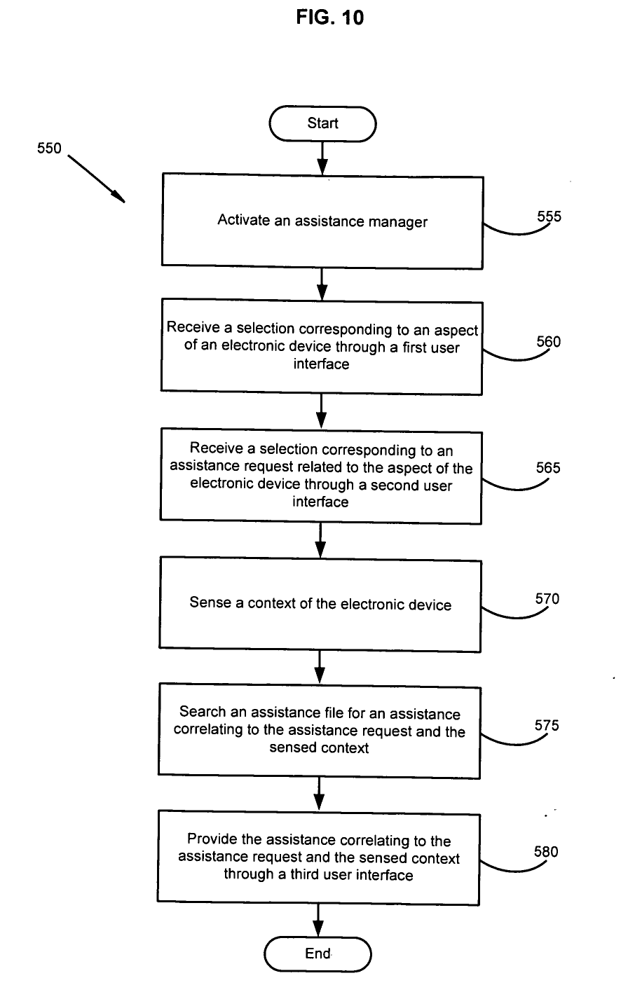

FIG. 10 is a flow diagram illustrating an exemplary operational flow 550 that provides contextual assistance. After a start operation, the operation moves to a help activation operation 555, where an assistance manager is activated. The assistance manager may include a circuit, a module, and/or instructions, such as computer-readable instructions, for example, a program, process, and/or application operating on an electronic device, that implement the exemplary operation 550 that provides assistance. At designation operation 560, a selection corresponding to an aspect of an electronic device is received through a first user interface of the electronic device. In an embodiment, the first user interface of the electronic device associated with the aspect. The selection corresponding to an aspect of an electronic device may be received through the first user interface in any manner. For example, the selection may be received by detecting a touch to the first user interface, and/or by detecting a sound through the first user interface, which may include detecting a spoken word.

At request operation 565, a selection corresponding to an assistance request related to the aspect of the electronic device is received through a second user interface of the electronic device. The first user interface and/or the second user interfaces may generally include any configuration, including configurations previously described. Several exemplary configurations are described in conjunction with the exemplary operational flows 200 and 270 of FIGS. 3 and 4 that provide assistance. The receiving a selection corresponding to an assistance request through a second user interface may generally be received in any manner, including any manner previously described that receives a selection through a user interface. In an alternative embodiment, the selection may include a selection corresponding to a predetermined assistance request related to the aspect of the electronic device. For example, predetermined assistance requests may include any request related to the electronic device, such as a group of “show me,” “demonstrate,” and “guide me.” In this alternative embodiment, at request operation 565, a user selects at least one from among a group of predetermined assistance requests.

At context operation 570, a context of the electronic device is sensed. The context operation 570 may be substantially similar to the context operation 515 of the exemplary process 500 that provides an assistance described in conjunction with FIG. 9. At search operation 575, an assistance file is searched for an assistance correlating to the selection corresponding to an assistance request and the sensed context. The search operation 575 may be substantially similar to the search operation 520 of the exemplary process 500 that provides an assistance described in conjunction with FIG. 9.

At broadcast operation 580, the assistance correlating to the assistance request related to the aspect of the electronic device and the environmental context is provided through a third user interface of the electronic device. The broadcast operation 580 may be substantially similar to the help operation 525 of the exemplary process 500 that provides an assistance described in conjunction with FIG. 9. The three user interfaces may be related in any suitable, selected manner. For example, in an embodiment the first user interface includes an element of the electronic device in a first state, and the second user interface includes the element of the electronic device in a second state. In another embodiment, the first user interface includes an element of the electronic device in a first state, the second user interface includes the element of the electronic device in a second state, and the third user interface includes the element of the electronic device in a third state. In a further embodiment, one of the first user interface, the second user interface, and the third user interface includes an element of the electronic device in a first state, and another of the first user interface, the second user interface, and the third user interface include the element of the electronic device in a second state. In an embodiment, the first user interface includes an element of the electronic device in a first mode and the second user interface includes the element of the electronic device in a second mode. In another embodiment, the first user interface includes an element of the electronic device in a first mode, the second user interface includes the element of the electronic device in a second mode, and the third user interface includes the element of the electronic device in a third mode. In a further embodiment, one of the first user interface, the second user interface, and the third user interface include an element of the electronic device in a first mode, and another of the first user interface, the second user interface, and the third user interface include the element of the electronic device in a second mode.

In an alternative embodiment, the exemplary operational flow 550 that provides assistance further includes the exemplary operational flow 270, which provides additional assistance as described in conjunction with FIG. 3.

In an embodiment, the exemplary operational flow 550 that provides contextual assistance may be considered to be an electronic device assistance manager. The assistance manager may be implemented in any combination of hardware, software, and/or firmware configured to effect the operational flow 550 that provides assistance, depending upon the design choices of the system designer. A further embodiment includes a computer-readable media containing computer instructions which, when run on a computing device, cause the computing device to perform the operational flow 550 that provides assistance. The computer-readable media may include a computer storage media, which may be carried by a computer-readable carrier, such as a floppy disk. Alternatively, the computer-readable media may include a communications media.

The exemplary operational flow 550 that provides contextual assistance may be implemented in any device or item where enhanced contextual user assistance may be advantageously employed. For example, the exemplary operational flow 550 may be implemented in the system 300 described in conjunction with FIGS. 6 and 9.

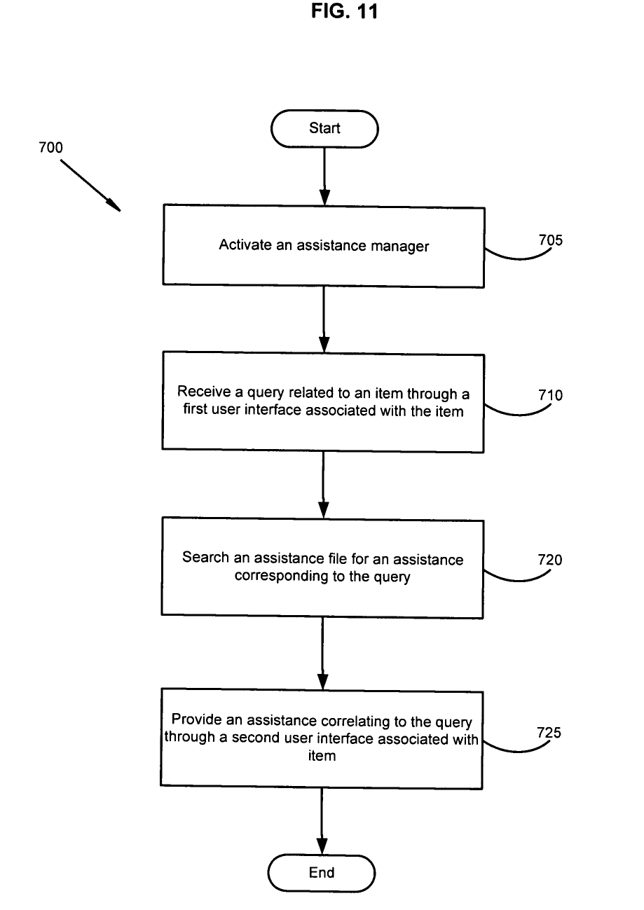

FIG. 11 is a flow diagram illustrating an exemplary operational flow 700 that provides assistance. After a start operation, the operation moves to a help activation operation 705. At help activation operation 705, an assistance manager is activated.

At query operation 710, a query related to an item is received through a first user interface associated with the item. In an embodiment, the item includes a computing device. The first user interface may be further associated with the computing device. In an embodiment, the first user interface may include a first user interface associated with an aspect of the item. The association may include any form of association with the aspect of the item, such as, for example, a physical association and a virtual association.

The query may include a query related to an aspect of the item. The query may be received in any manner through the first user interface. For example, the query may be received by detecting a touch to the first user interface, by detecting a sound through the first user interface, and/or by detecting a spoken word.

In a further embodiment, the first user interface may include a button. The button may include anything that accepts a user input expression. For example, the button may include a tangible button, and a virtual button. By way of further example, the receiving a selection of an aspect of the item through a first user interface associated with the item may include detecting a touch through a first user interface associated with the item.

The item may include any type of item. For example, an embodiment may include a vehicle, such as an automobile, a boat, a ship, and/or an aircraft. By way of further example, other embodiments may include an appliance, such as a refrigerator, a stove, a microwave oven, and/or an HVAC system. By way of additional example, embodiments may include manufacturing equipment and/or processing equipment.

At search operation 720, an assistance file is searched for an assistance correlating with the query. The assistance file may have any association with the item. For example, in an embodiment, the assistance file may be stored in a digital storage physically incorporated in a computing device associated with the item.

At broadcast operation 725, an assistance correlating to the query is provided through a second user interface associated with the item. In an embodiment, the item includes a computing device, and the assistance correlating to the query may be provided through a second user interface associated with a computing device. The provided assistance may include any material and/or information that may be helpful to a user. For example, the provided assistance may include a guided response assistance, an interactive tutorial assistance, an assistance correlating with a physical element of the item, a guidance correlating with a process associated with the item, showing how an aspect of the device operates, and/or a description of an aspect of the item. The provided assistance may be presented in any manner through the second user interface. For example, the provided assistance may include visually providing an assistance, such as blinking a light emitter associated with a physical element of the item, or displaying text, graphics or pictures on a visual display associated with the item. Further, the provided assistance may include audibly providing an assistance, such as a spoken assistance, and/or tactilely providing an assistance, such as by vibrating a physical element of the item.

In an embodiment, the first user interface may include an element of the item in a first state and the second user interface may include the element of the item in a second state. In an alternative embodiment, the first user interface may include an element of the item in a first mode and the second user interface may include the element of the item in a second mode. The second user interface may include the first user interface.

The operational flow 700 then proceeds to an end operation.

In an embodiment, the exemplary operational flow 700 that provides assistance may be considered an assistance manager. The assistance manager may include a circuit, a module, and/or instructions, such as computer-readable instructions. For example, instructions may include a program, process, and/or application operating on a computing device that implement the exemplary operational flow 700 that provides assistance. The assistance manager may be implemented in any combination of hardware, software, and/or firmware configured to effect the operational flow 700 that provides assistance, depending upon the design choices of the system designer. A further embodiment includes a computer-readable media containing computer instructions which, when run on a computing device, cause the computing device to perform the operational flow 700 that provides assistance. The computer-readable media may include a computer storage media, which may be carried by a computer-readable carrier, such as a floppy disk. Alternatively, the computer-readable media may include a communications media.

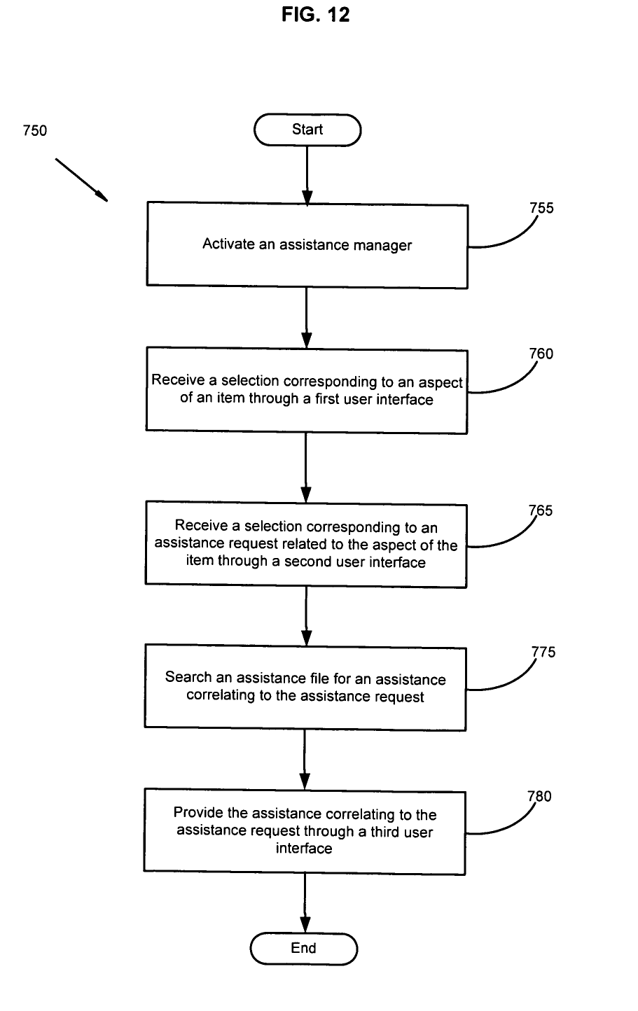

FIG. 12 is a flow diagram illustrating an exemplary operational flow 750 that provides assistance. After a start operation, the operation moves to a help activation operation 755, where an assistance manager is activated.

At a designation operation 760, a selection corresponding to an aspect of an item is received through a first user interface of the computing device. In an embodiment, the first user interface of the item may be associated with the aspect. In another embodiment, the item includes computing device and the aspect is associated with computing device. The selection corresponding to an aspect of an item may be received through the first user interface in any manner. For example, the selection may be received by detecting a touch to the first user interface, and/or by detecting a sound through the first user interface, which may include detecting a spoken word.

At request operation 765, a selection corresponding to an assistance request related to the aspect of the item is received through a second user interface of the item. The first user interface and/or the second user interface may generally include any configuration, including configurations previously described. Several exemplary configurations are described in conjunction with the exemplary operational flows 200 and 220 of FIGS. 3 and 4 that provide assistance. The receiving a selection corresponding to an assistance request through a second user interface may generally be received in any manner, including any manner previously described that receives a selection through a user interface. In an alternative embodiment, the selection may include a selection corresponding to a predetermined assistance request related to the aspect of the item. For example, predetermined assistance requests may include any request related to the item, such as a group of “show me,” “demonstrate,” and “guide me.” In this alternative embodiment, at request operation 765, a user selects at least one from among a group of predetermined assistance requests.

At search operation 775, an assistance file is searched for an assistance correlating to the selection corresponding to the assistance request received at request operation 765. The search operation 775 may be substantially similar to the search operation 720 of the exemplary operational flow 700 that provides an assistance described in conjunction with FIG. 11.

At broadcast operation 780, the assistance correlating to the assistance request related to the aspect of the item is provided through a third user interface of the item. The broadcast operation 780 may be substantially similar to the broadcast operation 725 of the exemplary operational flow 700 that provides an assistance described in conjunction with FIG. 11. The three user interfaces may be related in any suitable, selected manner. For example, in an embodiment the first user interface includes an element of the item in a first state, and the second user interface includes the element of the item in a second state. In another embodiment, the first user interface includes an element of the item in a first state, the second user interface includes the element of the item in a second state, and the third user interface includes the element of the item in a third state. In a further embodiment, one of the first user interface, the second user interface, and the third user interface includes an element of the item in a first state, and another of the first user interface, the second user interface, and the third user interface include the element of the item in a second state. In an embodiment, the first user interface includes an element of the item in a first mode and the second user interface includes the element of the item in a second mode. In another embodiment, the first user interface includes an element of the item in a first mode, the second user interface includes the element of the item in a second mode, and the third user interface includes the element of the item in a third mode. In a further embodiment, one of the first user interface, the second user interface, and the third user interface include an element of the item in a first mode, and another of the first user interface, the second user interface, and the third user interface include the element of the item in a second mode.

In an alternative embodiment, the exemplary operational flow 750 that provides assistance may further include the exemplary operation 270, which provides additional assistance as described in conjunction with FIG. 5.

In an embodiment, the exemplary operational flow 750 that provides assistance may be considered an assistance manager. The assistance manager may include a circuit, a module, and/or instructions, such as computer-readable instructions. For example, instructions may include computer-readable instructions, such as, a program, process, and/or application operating on a computing device of an item that implements the exemplary operational flow 750 that provides assistance. The assistance manager may be implemented in any combination of hardware, software, and/or firmware configured to effect the operational flow 750 that provides assistance, depending upon the design choices of the system designer. A further embodiment includes a computer-readable media containing computer instructions which, when run on a computing device, cause the computing device to perform the operational flow 750 that provides assistance. The computer-readable media may include a computer storage media, which may be carried by a computer-readable carrier, such as a floppy disk. Alternatively, the computer-readable media may include a communications media. The exemplary operational flow 750 that provides assistance may be implemented in any item where enhanced user assistance may be advantageously employed.

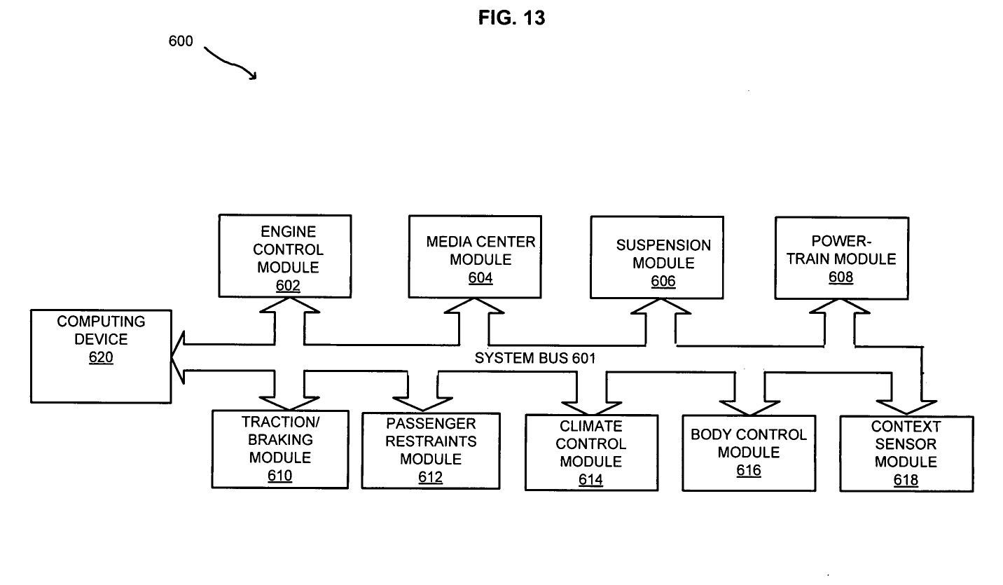

FIG. 13 illustrates an exemplary system 600 representative of an item in which embodiments, such as the exemplary operational flow 700 and the exemplary operational flow 750, may be implemented. The exemplary system 600 of FIG. 13 illustrates a vehicular environment, such as an automobile, and/or a truck. The exemplary system 600 includes an engine control module 602, a media center module 604, a suspension module 606, a power train module 608, the traction/braking module 610, a passenger restraint module 612, a climate control module 614, a body control module 616, and a context sensor module 618. These modules are representative of any module or modules that may be used in a vehicular environment. One or more of these modules may have one or more user interfaces available to a driver, a passenger, and/or a service person. The exemplary system 600 also includes a computing device 620. The modules 602-618 and the computing device 620 are coupled by a system bus 601.

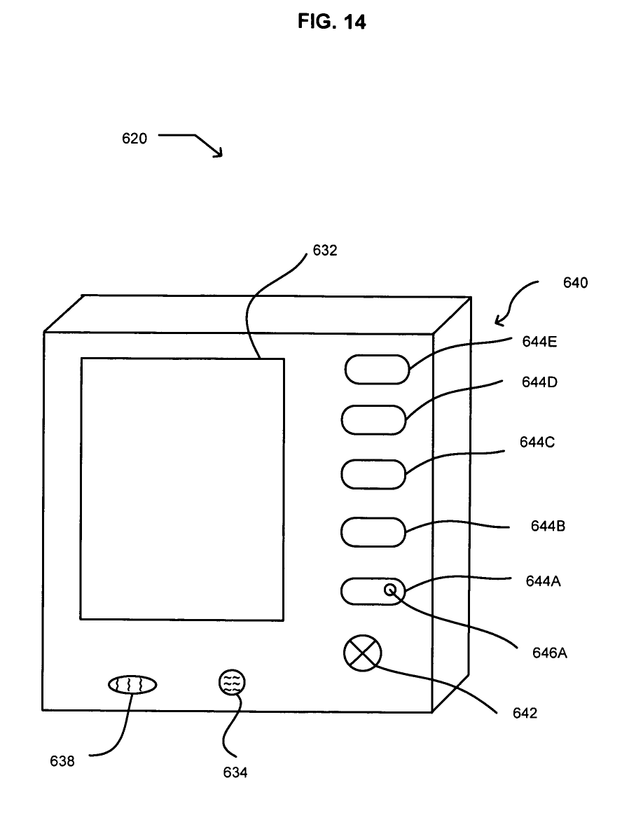

FIG. 14 illustrates user interfaces 640 of an exemplary embodiment of the computing device 620 of the exemplary system 600. The computing device 620 may be any type of computing device. For example, the computing device 620 may include the thin computing device 20 described in conjunction with FIG. 1, and/or the computing device 100 described in conjunction with FIG. 2. In an alternative embodiment, the computing device 620 may be implemented as a part of another module, for example, such as the media center module 604.

The computing device 620 includes the plurality of user interfaces 640. The plurality of user interfaces 640 may include any number and type of interfaces. As illustrated in FIG. 14, an embodiment of the plurality of interfaces 640 includes a display 632. The display 632 may provide a textual, a visual display, and/or a graphical display. In a further embodiment, the display 632 may include touch screen functionality operable to accept a user input. Also as illustrated in FIG. 14, an embodiment of the plurality of user interfaces 640 also includes a microphone 634, a speaker 638, and a plurality of tangible buttons 644A-644E. One or more of the tangible buttons may include a light emitter, such as a light emitting device 646A. Further, one or more of the tangible buttons 644A-644E may include a vibrator operable to provide a tactile and/or audible display. The display 632 and the tangible buttons 644A-644E may have any functionality appropriate to the system 600. The user interface 640 also includes a cursor control 642 providing user navigation on the display 632. The computing device 620 may also include context sensors (not shown), which may be selected, for example, to produce relevant information about an environment extrinsic and/or intrinsic to the system 600. The computing device 620 may further include a USB port and a network port (not shown).

The computing device 620 also includes a system memory (not shown), such as the system memory 22 of the thin computing device 20 of FIG. 1. The system memory includes stored operating systems and programs necessary to operate the computing device 620, and also includes an assistance manager operable to implement operations that provide assistance, such as the exemplary operational flows 700 and 750 described in conjunction with FIGS. 11 and 12 respectively. In an embodiment, the system memory may also include stored operating systems and programs necessary to operate and/or interface with one or more of the modules of the system 600. For example, the system memory may include a program allowing user input to the suspension module 606 through one or more interfaces of the computing devices 620.

The system memory also includes an assistance file, which may be included in the assistance manager. The assistance file includes a body of assistance information intended to help a user in response to a plurality of user-selected requests related to the item, illustrated as the exemplary system 600. The assistance manager and/or the assistance file may be provided by an original equipment manufacturer of the exemplary system 600, or it may be provided by a third party.

The assistance manager includes operability to receive a query related to the system 600 through one or more user interfaces. The user interfaces of the system may include one or more user interfaces associated with one or more of the modules 602-618, and the plurality of user interfaces 640 associated with computing device 620.

For example, in an embodiment implementing a query operation, such as the operational flow 700 of FIG. 11, a user touch detected to the button 644E may be received as an instruction to activate the assistance manager, such as the assistance manager at operation 705 of FIG. 11. Activation of the assistance manager transitions the user interfaces 640 of the computing device 620 and/or one or more user interfaces of the modules 602-620 of the system 600, to a first state. When the user interfaces are in the first state, a detected user touch to a user interface of the plurality of user interfaces 640 and/or another of the modules 602-618 of the system 600, is received by the assistance manager as query related to the system 600.

In an alternative embodiment, the query may be received by detecting a signal responsive to a sound or voice received by the microphone 634. For example, a detection and recognition of a signal responsive to a spoken “help” command to the microphone 634 may be received as an instruction to activate the assistance manager. Further, a detection and recognition of a signal responsive to spoken words “traction control” may be received by the assistance manager as a query corresponding to the traction control module 610 aspect of the system 600.

The assistance manager includes operability to search an assistance file for an assistance corresponding to the query as previously described. The assistance manager further includes operability to provide assistance, such as information, advice, guidance, and instructions. The assistance may be provided through at least one of the plurality of interfaces 640 of the computing device 620, and/or at least one user interface associated with one or more of the modules 602-618. For example, the assistance may be provided through user interfaces of the computing device 620, such as the display 632, the tangible buttons 644A-644E, and the speaker 638. By way of further example, the assistance may be provided through a user interface associated with a module, such as the climate control module 614. Using the climate control module 614 as an illustrative example, an assistance may be provided by blinking a light associated with a user button on a console associated with the climate control system and the climate control module 614. In an embodiment, the provided assistance may include any type of presentation, such as a visual presentation, an audio presentation, a spoken presentation, a tactile presentation, and a combination of two or more of the foregoing presentation modes. In another embodiment, the assistance file includes operability to provide interactive assistance with additional user inputs being received through the user interfaces 640.

An alternative embodiment implements a two-part query operational flow, such as the operational flow 750 providing assistance described in conjunction with FIG. 12. Activation of the assistance manager transitions the user interfaces 640 of the computing device 620 and/or the system 600 to a first state. When in the first state, a detected touch to a user interface is received by the assistance manager as a received aspect selection operation 760, as described in conjunction with FIG. 12. On receiving the selection at the operation 760, the assistance manager transitions the user interfaces to a second state. When in the second state, a detected user touch to a user interface is received as selection corresponding to an assistance request 765, as described in conjunction with FIG. 12. In a further embodiment, for example, after the assistance manager transitions the user interfaces to the second state, information may be displayed on the display 632 indicating predetermined assistance selections associated with the buttons 644A-644E. In this example, three of the buttons may be appropriately referenced by information displayed on the display 632, such as “show me,” “demonstrate,” and “guide me” respectively. A selection corresponding to an assistance request is received by the assistance manager as a received selection corresponding to an assistance request operation 765 as described in conjunction with FIG. 12.

In an alternative embodiment of the assistance request operation 765, the assistance selection may be received by detecting a signal responsive to a sound or voice received by the microphone 634. The signal responsive is recognized and received as a selection corresponding to an assistance request at the assistance election operation 765. For example, a signal responsive to spoken commands, such as “show me,” “demonstrate,” and “guide me” may be recognized at the operation 765 as a selection corresponding to an assistance request embodied in a plain meaning of those words.

The assistance manager includes operability to search an assistance file for an assistance correlating to the query as previously described. The assistance manager further includes operability to provide assistance as previously described.

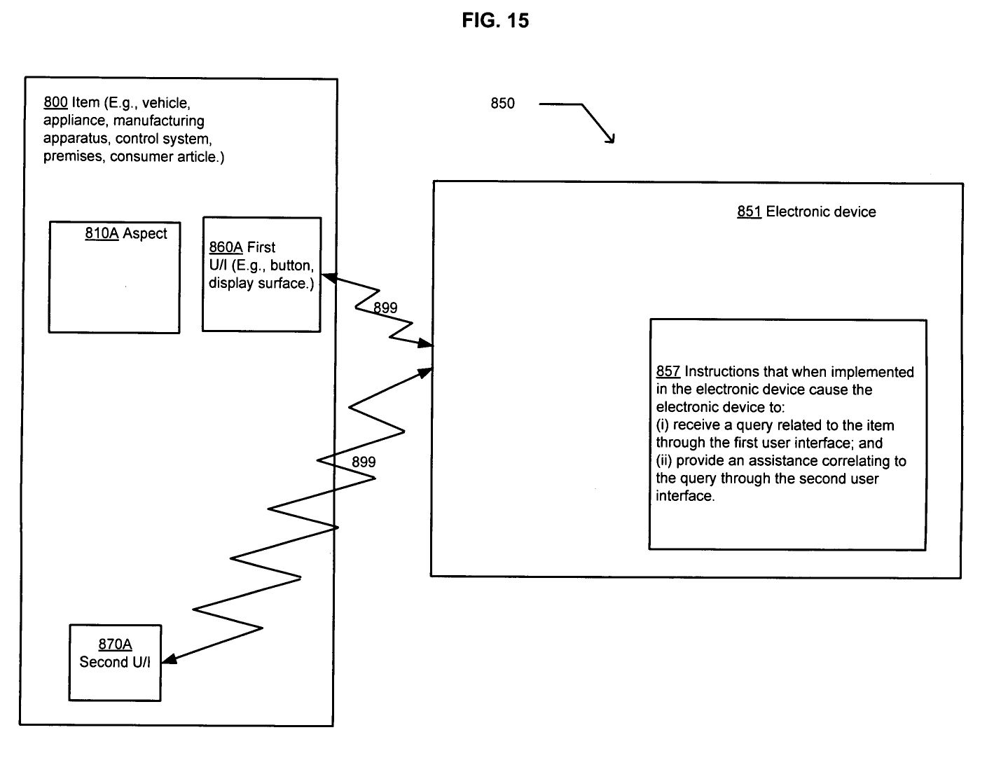

FIG. 15 illustrates a partial view of an exemplary apparatus 850 that may serve as an illustrative environment of and/or for subject matter technologies that provide user assistance for an item, illustrated as an item 800. The apparatus 850 is distinct from the item and includes an electronic device 851. In certain embodiments, the apparatus 850 is distinct from the item 800 because no persistent physical coupling exists between them. In certain other embodiments, the apparatus 850 is distinct from the item 800 because a no signal is communicated between them with respect to providing user assistance. The electronic device 851 includes a first user interface 860A that is associatable with the item 800, and a second user interface 870A. The electronic device 851 also includes instructions 857 that when implemented in the electronic device cause the electronic device to receive a query related to the item through the first user interface 860A and provide an assistance correlating to the query through the second user interface 870A.

The first user interface 860A and/or the second user interface 870A may generally include any suitable configuration or operability states and modes, including any of those previously described. For example, the first user interface and/or the second user interface may include states and modes previously described in several exemplary configurations described in conjunction with exemplary operational flows 200, 220, and 750 of FIGS. 3, 4, and 12 respectively.

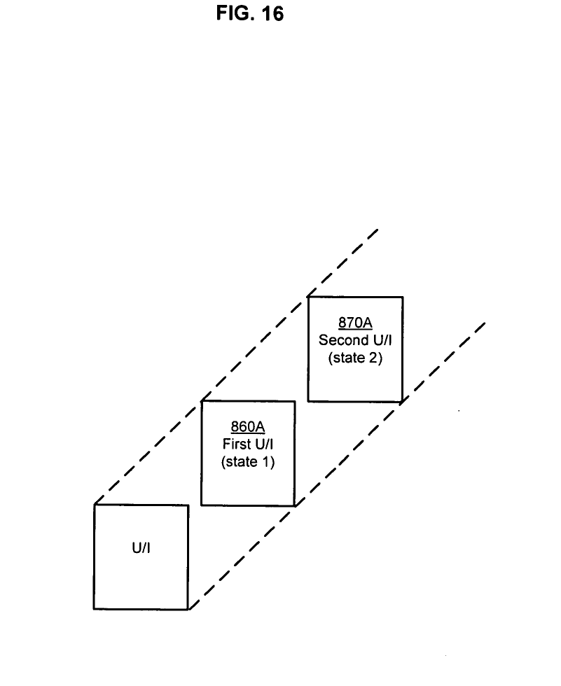

FIG. 16 illustrates an exemplary embodiment of states of a user interface U/I that may serve as an illustrative environment of and/or for subject matter technologies that provide user assistance for an item. The user interface U/I includes a plurality of states. In a pre-user assistance state, the user interface may have any function. If in an optional pre-assistance state, the user interface U/I transitions to a first state, which includes operability that receives a query related to the item 800. Using FIG. 15 as an example, the user interface U/I transitions to the first state, which is the first user interface 860A. After receiving a query through the user interface U/I while in the first state (first user interface 860A), the user interface transitions from the first state to a second state, which is the second user interface 870A. The second user interface 870A in the second state includes operability to provide an assistance.

Returning to FIG. 15, the first user interface 860A may be associatable with the item 800 in any manner. In an embodiment, the physical object of the apparatus 850 includes a configuration to be meaningfully associated with the item 800, and/or one or more aspects of the item, such as the aspect 810A. For example, the apparatus 850 may include a flexible, a semi-rigid, and/or a rigid structure physically mountable or associatable with the item 800. In certain embodiments, the association is physical, with the apparatus 850 being physically overlaid or applied to the item such that one or more receiving user interfaces of the apparatus are respectively proximate to and visually associable with the one or more aspects of the item. The apparatus 850 also includes one or more user interfaces, such as a visual display, a microphone, a speaker, and a plurality of tangible buttons which may be configured to be proximate to and associable with the one or more aspects of the item. In addition, one or more of the tangible buttons may include a light emitter, such as a light emitting device, and/or a vibrator operable to provide a tactile display.

In an embodiment, the first user interface 860A includes a first user interface physically associatable with the item 800. In another embodiment, the apparatus 850 include openings allowing the apparatus to be fitted proximate to aspects of the item 800, such as around knobs and around dials. The embodiment may include a configuration positioning the first user interface 860A proximate to one of the openings. For example, the first user interface 860A may be incorporated into a portion of the apparatus 850 associatable with the item 800, and proximate to an opening configured to frame the aspect 810A, thus operable to create a visual association between the first user interface 860A and the aspect 810A. In other embodiments, the association may include a logical association.

In another embodiment, the first user interface 860A may be associatable with the aspect 810A by a removable and/or releasable association with the aspect. For example, the removable association with the aspect 810A may include a releasable adhesive association, and/or a releasable magnetic association. The first user interface 860A may include a first user interface surface (not shown) associatable with the item 800. The first user interface 860A may include any type of user interface. For example, the first user interface 860A may include a touch receptive button associatable with an item. In an embodiment, the button may include a tangible button associatable with an item, and/or a virtual button associatable with an item. A virtual button associatable with an item may include a virtual button displayable on a display surface of the electronic device 851 that is associatable with the item 800.

The first user interface 860A and the second user interface 870A may be couplable with the electronic device 851 in any manner. FIG. 15 illustrates an embodiment including a wireless coupling 899. The wireless coupling 899 may include a radio frequency coupling, and/or an optical coupling. In an alternative embodiment, the first user interface 860A includes a first user interface electrically couplable with the electronic device (not shown).

The second user interface 870A may be associatable with the item 800 in any manner, including a matter of association similar to that described for the first user interface 860A. As with the first user interface 860A, the second user interface 870A maybe incorporated in an embodiment of the apparatus 850 that includes a structure physically mountable or associatable with the item 800. In an alternative embodiment, the user interface 870A may include a second user interface removably associatable with the item 800. In another embodiment, the second user interface 870A may be removably and physically associatable with the item 800. In a further embodiment, the second user interface may include a visual display, which may include a visual display surface. The visual display may include a light emitter. The second user interface 870A may include operability for a wired electrical coupling (not shown) and/or a wireless coupling 899 with the electronic device.

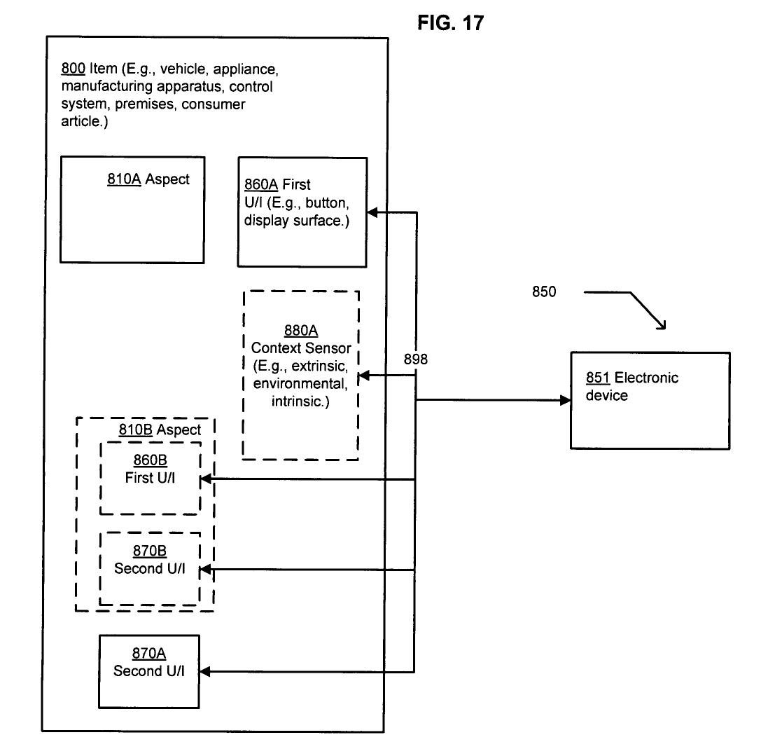

FIG. 17 illustrates an alternative embodiment of the apparatus 850 of FIG. 15 that includes a first user interface 860B and a second user interface 870B both associatable with an aspect 810B of an item, illustrated as the item 800. In a further alternative embodiment, the second user interface 870B may include the first user interface 860B.

Also illustrated in FIG. 17 is an alternative embodiment of the electronic device 851 of FIG. 15 that includes an associatable context sensor 880A operable to sense a context of the item 800. The context sensor may include operability to sense a context of the item 800. For example, the context sensor 880A may include an operability to sense a context extrinsic to the item, an environment extrinsic to the item, and/or a context intrinsic to the item. In an alternative embodiment, the instructions 857 may further include an instruction to (iii) receive a context of the item from the context sensor; and wherein the instruction to (ii) provide an assistance correlating to the query includes provide an assistance correlating to the query and the context of the item (not shown).

The item 800 may include any type of item where user assistance may be advantageously employed. In an embodiment, the item 800 lacks operability to provide a desired level of user assistance for any reason. For example, the item 800 may be a “dumb item” completely lacking any operability to provide user assistance. In another embodiment, the item 800 may lack sufficient memory or computing power to provide a desired level or quality of user assistance. For example, the item 800 may include all or a part of a vehicle, an appliance, a manufacturing apparatus, a control system, a premises, a consumer article, and an HVAC system. Other examples of the item 800 may include all or a part of a complicated item or system, for example, such as is present in a manufacturing operation, in electrical transmission control grid, a soundboard of a recording studio, and in a planetarium.

A further embodiment relates to providing assistance with an item having one or more aspects for which assistance may be desired. The item includes the aspect 810A, which may be representative of any aspect of the item. For example, the aspect 810A may include a tangible element of the item 800, such as a button, a knob, a dial, and/or other tangible element visible to the user. By way of further example, the aspect 810A may include a program, a function, or other tangible or intangible element. In an embodiment, if the aspect 810A includes an intangible element or element not otherwise readily viewable to the user, the aspect may be representatively or virtually made viewable to the user. For example, the aspect may be made visible through an icon in a display screen for an iconic element or button portion of the item 800.

Further illustrated in FIG. 17 is an alternative embodiment of the apparatus 850 of FIG. 15. The electronic device 851 and at least one of the first user interface 860A, the first user interface 860B, the second user interface 870A, and the second user interface 870B may be electronically coupled with the apparatus through a wire connector coupling 898.

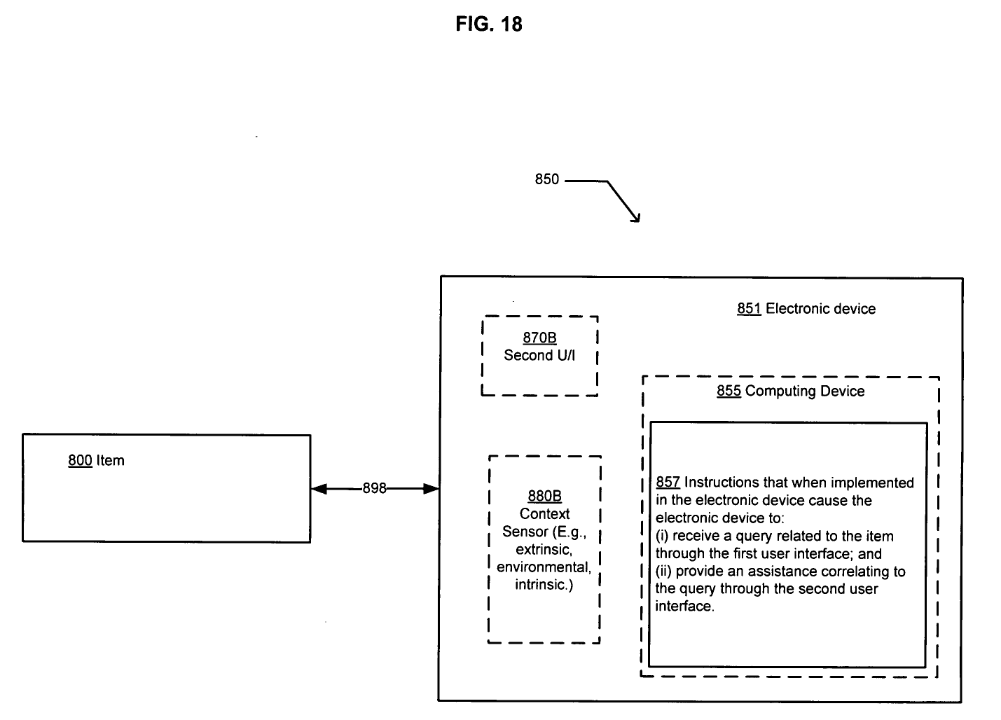

FIG. 18 illustrates an alternative embodiment of the apparatus 850 of FIG. 15. In this alternative embodiment, the electronic device 851 further includes a computing device 855. The computing device 855 may be any type of computing device suitable for providing user assistance. For example, the computing device 855 may include a thin computing device similar to the thin device 20 described in conjunction with FIG. 1. By way of further example, the computing device 855 may include a general-purpose computing device, such as the general-purpose computing device 100 described in conjunction with FIG. 2. In FIG. 18, the instructions 857 are stored in a computer-readable medium associated with the computing device 855. The alternative embodiment illustrated in FIG. 18 further includes a second user interface 870B incorporated in a portion of electronic device 851 not associated with the item 800. The alternative embodiment further includes a context sensor 880B also incorporated into portion of the electronic device 851 not associated with the item 800. The computing device 855 is further operably coupled to a first user interface, such as the first user interface 860A, and a second user interface, such as the second user interface 870A.

Following are a series of illustrations depicting implementations of processes. For ease of understanding, the illustrations are organized such that the initial illustrations present implementations via an overall “big picture” viewpoint and thereafter the following illustrations present alternate implementations and/or expansions of the “big picture” illustrations as either sub-steps or additional steps building on one or more earlier-presented illustrations. The style of presentation utilized herein (e.g., beginning with a presentation of a illustration(s) presenting an overall view and thereafter providing additions to and/or further details in subsequent illustrations) generally allows for a rapid and easy understanding of the various process implementations.

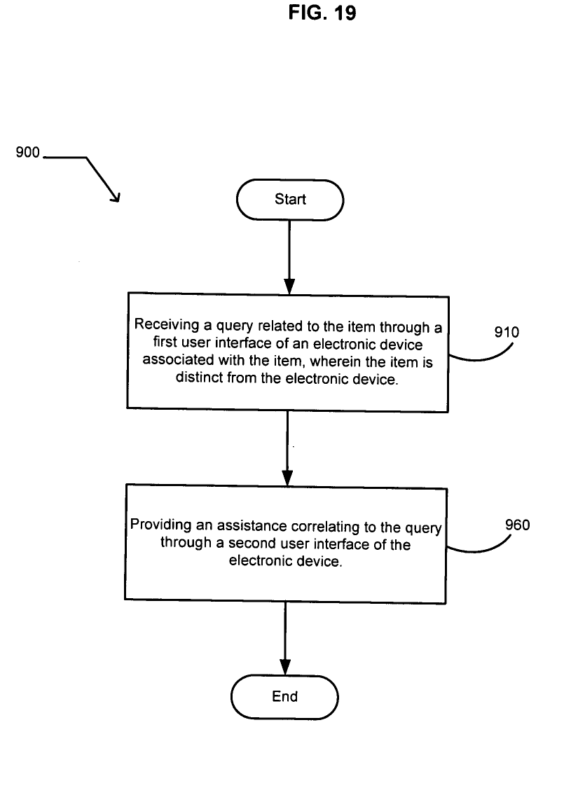

FIG. 19 illustrates an exemplary operational flow 900 that provides user assistance for an item. After a start operation, the operation moves to a reception operation 910 where a query related to the item is received through a first user interface of an electronic device associated with the item. The item is distinct from the electronic device. At a broadcast operation 960, an assistance correlating to the query is provided through a second user interface of the electronic device. As described in conjunction with FIG. 15, the first user interface may include an element in a first state and the second user interface may include the element in a second state. The first user interface may include an element of the electronic device in a first mode and the second user interface may include the element of the electronic device in a second mode. Further, the first user interface associated with the item may include a first user interface removably associated with the item. The operational flow 900 then proceeds to an end operation.

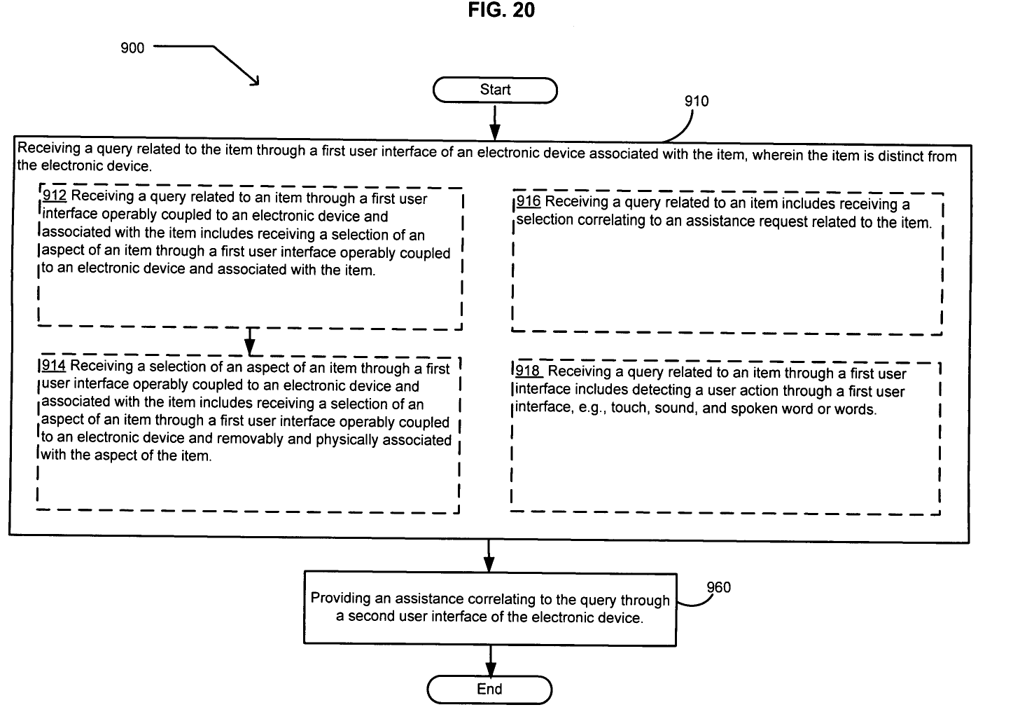

FIG. 20 illustrates an alternative embodiment of the exemplary operational flow 900 of FIG. 19 that provides user assistance for an item. FIG. 20 illustrates an embodiment where the reception operation 910 may include at least one additional operation. Additional operations may include operation 912, operation 914, operation 916, and/or operation 918. For example, at operation 912, a selection of an aspect of an item is received through a first user interface operably coupled to the electronic device and associated with the item. At operation 914, a selection of an aspect of an item is received through a first user interface operably coupled to the electronic device and removably and physically associated with the aspect of the item. At operation 916, a selection correlating to an assistance request related to the item is received. At operation 918, the receiving a query related to an item through a first user interface may include detecting a user action through the first user interface. For example, a user action may be detected by detecting a touch, a sound, and/or a spoken word or words.

By way of further example, the item may include a vehicle and the reception operation 910 that receives a query may include receiving a query related to an aspect of the vehicle. In another example, the item may include an appliance and the reception operation 910 that receives a query may include receiving a query related to an aspect of the appliance. Further, the item may include a manufacturing apparatus and the reception operation 910 that receives a query may include receiving a query related the manufacturing apparatus. The item may include a control system and the reception operation 910 that receives a query may include receiving a query related to the control system.

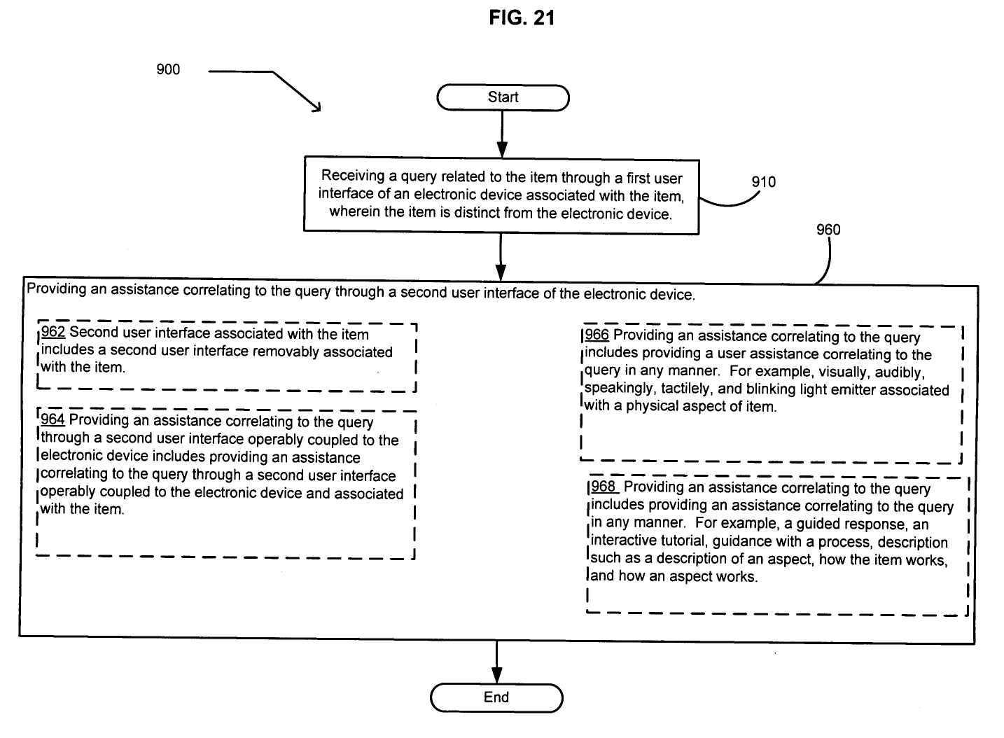

FIG. 21 illustrates an alternative embodiment of the exemplary operational flow 900 of FIG. 19 that provides user assistance for an item. FIG. 21 illustrates an embodiment where the broadcast operation 960 may include may at least one additional operation. Additional operations may include operation 962, operation 964, operation 966, and/or operation 968. For example, at operation 962, the second user interface associated with the item may include a second user interface removably associated with the item. At operation 964, the providing an assistance correlating to the query through a second user interface operably coupled to the electronic device may include providing an assistance correlating to the query through a second user interface operably coupled to the electronic device and associated with the item. At operation 966, the providing an assistance correlating to the query may include providing a user assistance correlating to the query in any suitable manner. For example, the user assistance may be provided by visually providing an assistance correlating to the query, audibly providing an assistance correlating to the query, providing a spoken assistance correlating to the query, and/or tactilely providing an assistance correlating to the query. At operation 968, the providing an assistance may include providing a guided response assistance, providing an interactive tutorial assistance, providing an assistance correlating with a physical aspect of the item, blinking a light emitter associatable with the physical aspect, providing a guidance correlating with a process associated with the item, and/or providing a description of the item. The providing a description of an item may include providing a description of an aspect of the item. Additionally, the providing an assistance may include providing an assistance showing how the device operates, which may include providing an assistance showing how an aspect of the item operates.

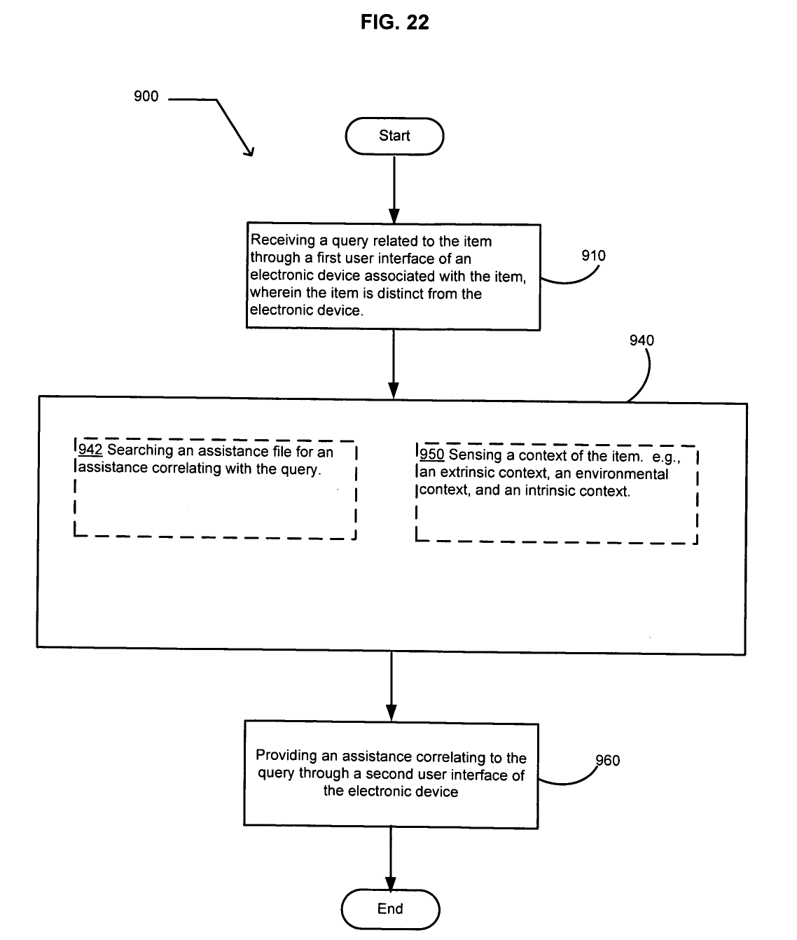

FIG. 22 illustrates an alternative embodiment of the exemplary operational flow 900 of FIG. 19 that provides user assistance for an item. The alternative embodiment illustrated in FIG. 22 includes at least one additional operation 940. The additional operation 940 may include a search operation 942. At the search operation 942, an assistance file is searched for an assistance correlating with the query. The additional operation may include a context operation 950, where a context of the item is sensed. The context maybe sensed in a manner similar to context operation 515 of FIG. 9.

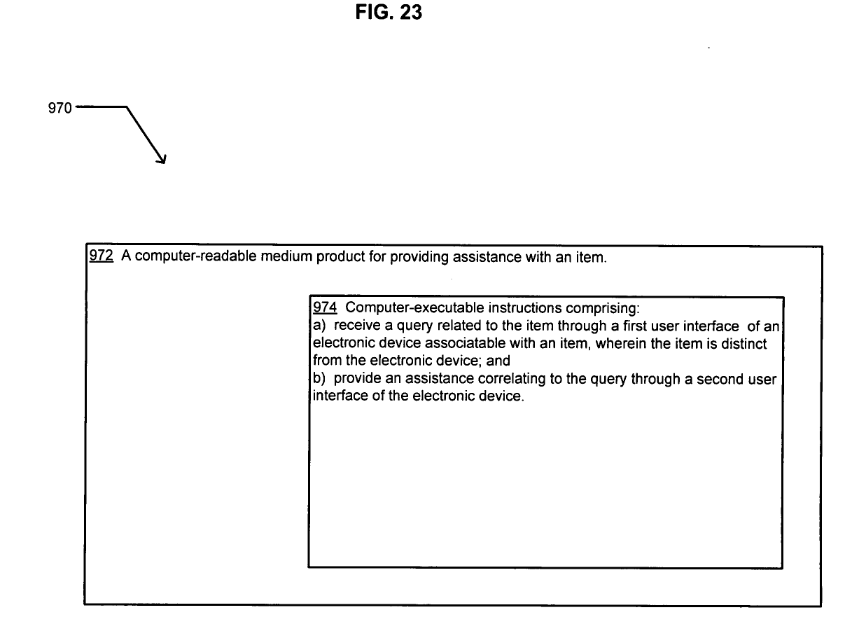

FIG. 23 illustrates a partial view of an exemplary computer-readable medium product 970 that may serve as an illustrative environment of and/or for subject matter technologies that provide user assistance for an item. The computer-readable medium product 972 includes computer-executable instructions 974. The computer-executable instructions include an operability that receives a query related to the item through a first user interface of an electronic device. The first user interface is associatable with the item, and the item is distinct from the electronic device. The computer-executable instructions 974 further include operability that provides an assistance correlating to the query through a second user interface of the electronic device. The computer-readable medium product may include a computer storage medium product, which may be carried by a computer-readable carrier. The computer-readable medium product may include a communications medium product.

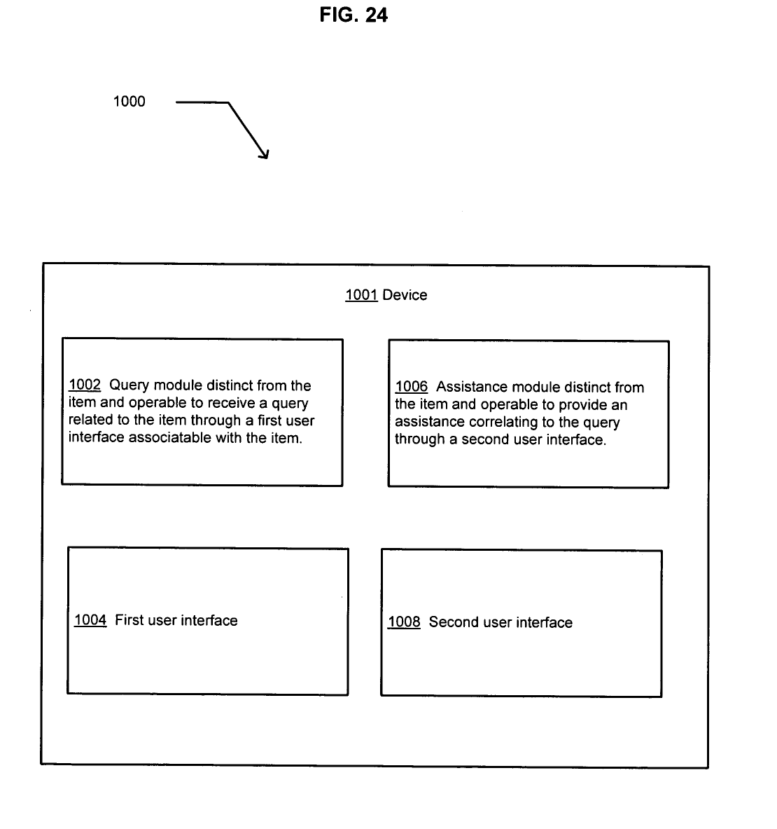

FIG. 24 illustrates a partial view of an exemplary apparatus 1000 that may serve as an illustrative environment of and/or for subject matter technologies that provide user assistance for an item, such as the item 800. The exemplary apparatus 1000 includes a device 1001. The device 1001 includes a query module 1002 operable to receive a query related to the item through a first user interface 1004. The first user interface 1004 includes a structure a associatable with the item. The exemplary apparatus 1000 further includes an assistance module operable 1006 operable to provide an assistance correlating to the query through a second user interface 1008. The item is distinct from the exemplary apparatus 1000.

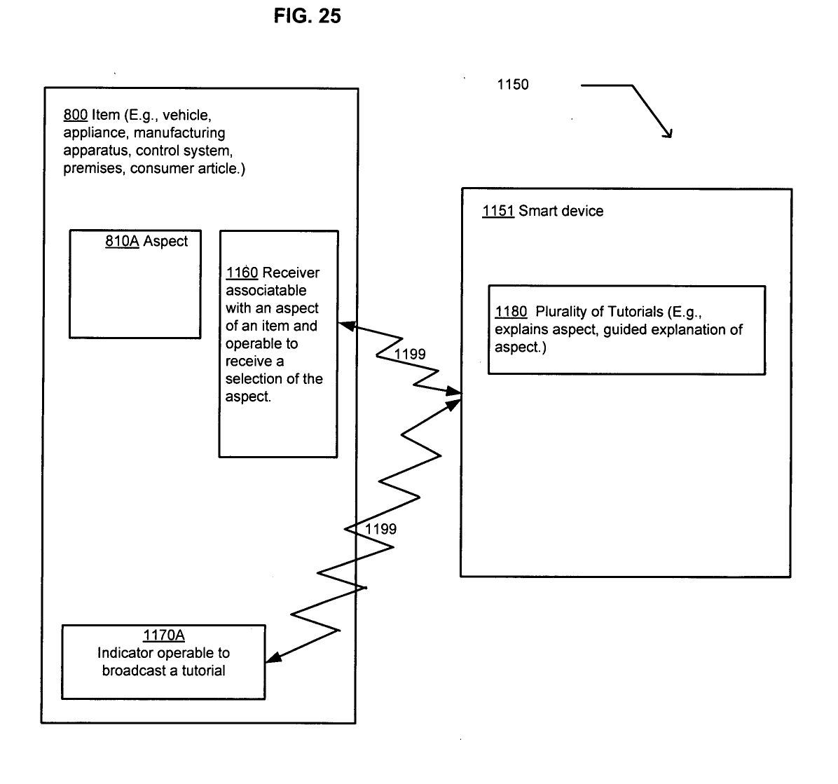

FIG. 25 illustrates a partial view of an exemplary apparatus 1150 that may serve as an illustrative environment of and/or for subject matter technologies that provide user assistance for an item. The exemplary apparatus 1150 is distinct from the item and includes a smart device 1151. The smart device 1151 includes a receiver 1160 associatable with an aspect 810A of the item 800 and operable to receive a selection of the aspect. The smart device 1151 further includes an indicator 1170A operable to broadcast a tutorial. In an embodiment, the indicator 1170A may be associated with the item 800 and/or an aspect 810A of the item. The exemplary apparatus 1150 further includes a plurality of tutorials 1180 that include information related to the item. In an embodiment, the plurality of tutorials are stored in a computer-readable medium product associated with the smart device 1151.

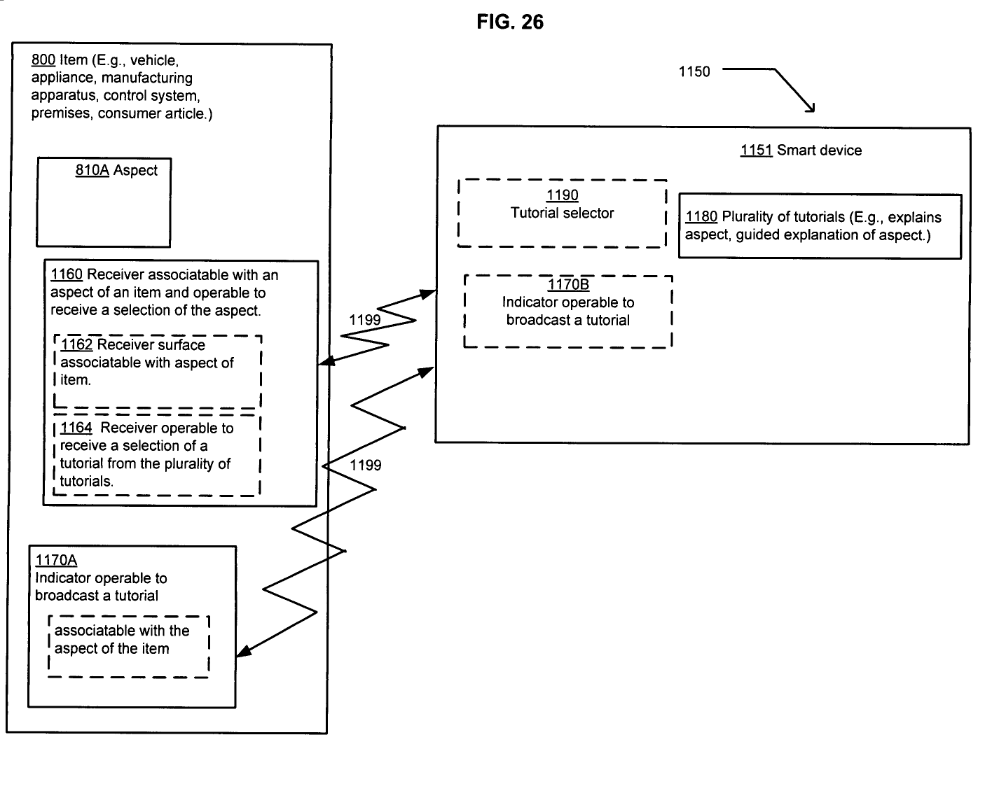

FIG. 26 illustrates a partial view of an alternative embodiment of the exemplary apparatus 1150 of FIG. 24. The smart device 1151 further may include a tutorial selector 1190 operable to receive the selection of the aspect 810A. The tutorial selector 1190 may include operability to select a tutorial correlating with the selection of the aspect from the plurality of tutorials 1180. In an alternative embodiment, the tutorial selector 1190 may be associated with the item 800 (not shown). The information related to the aspect 810A of the item may include an explanation of the aspect of the item, and/or may include a guided explanation related to the aspect of the item. The receiver 1160 further may include a receiver surface 1162 associatable with an aspect of an item. The receiver 1160 further may include a receiver 1164 operable to receive a selection of a tutorial from the plurality of tutorials. The indicator 1170A may include an indicator associatable with the aspect 810A of the item. The smart device 1151 may further include an indicator 1170B not associated with the item 800, and is operable to broadcast a tutorial.

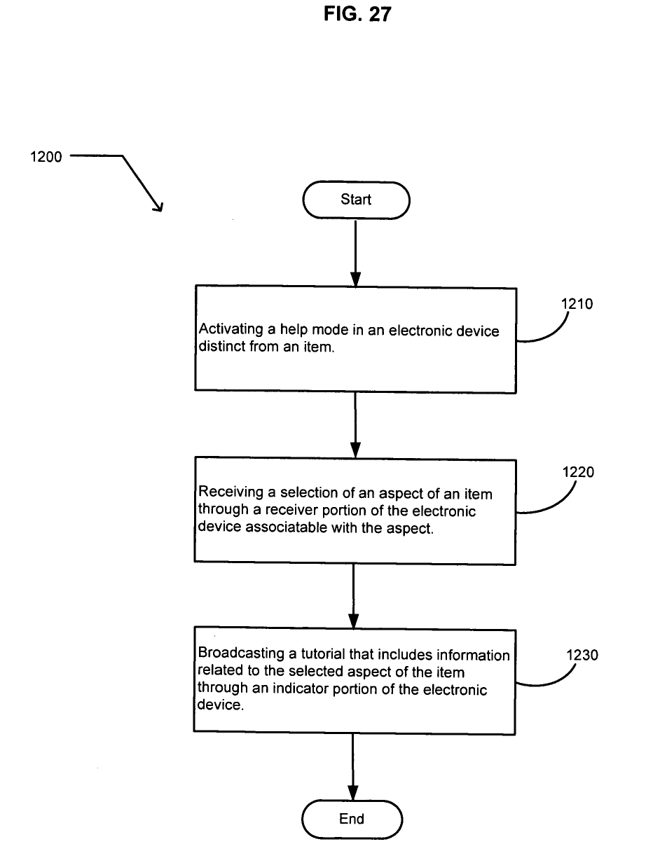

FIG. 27 illustrates an exemplary operational flow 1200 that provides a user assistance with an item. After a start operation, the flow moves to an activation operation 1210. At the activation operation 1210, a help mode is activated in an electronic device distinct from the item. At query operation 1220, a selection of an aspect of an item is received through a receiver portion of the electronic device associatable with the aspect. At broadcast operation 1230, a tutorial is broadcast that includes information related to the selected aspect of the item through an indicator portion of the electronic device. The operational flow 1200 then proceeds to an end operation.

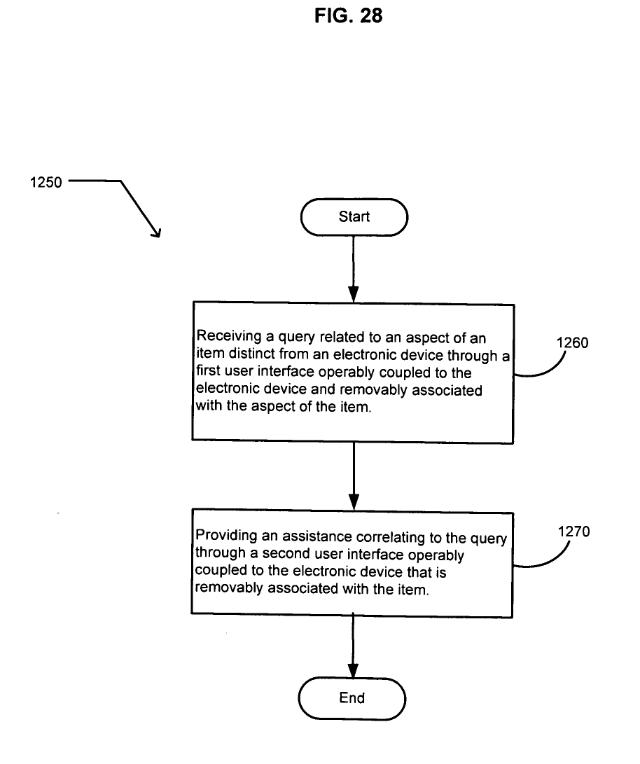

FIG. 28 illustrates an exemplary operational flow 1250 that provides a user assistance with an item. After the start of operation, the flow moves to a query operation 1260. At the query operation 1260, a query related to an aspect of an item distinct from an electronic device is received. The query is received through a first user interface operably coupled to the electronic device and removably associated with the aspect of the item. At help operation 1270, an assistance is provided correlating to the query through a second user interface operably coupled to the electronic device, the second user interface being removably associated with the item. The operational flow 1250 then proceeds to an end operation.

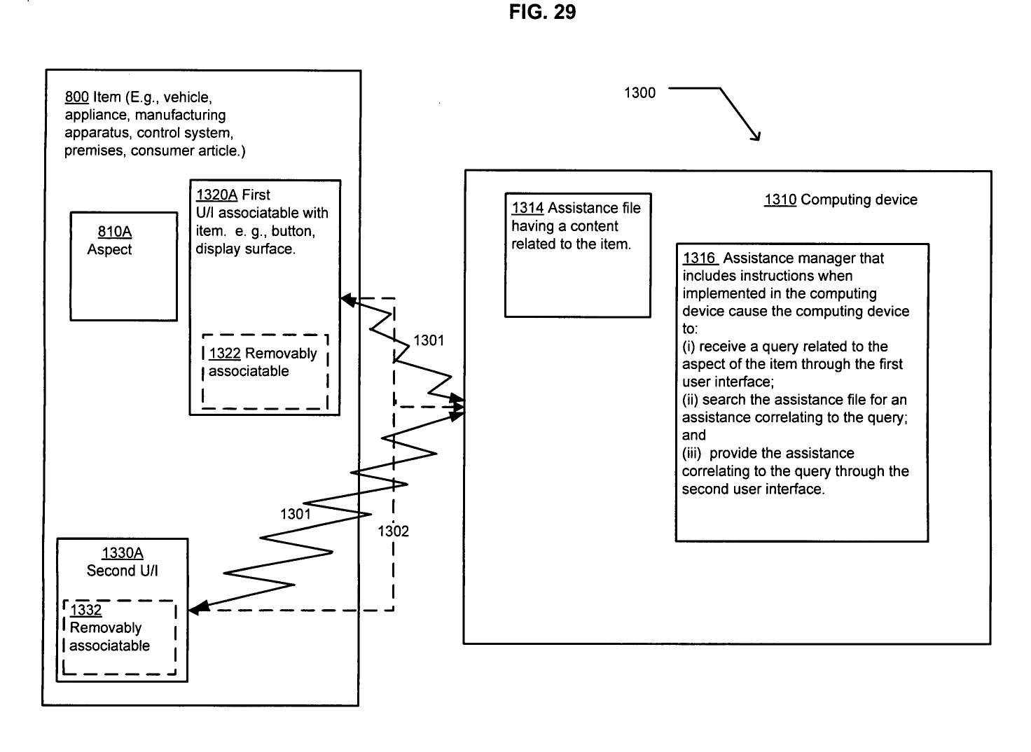

FIG. 29 illustrates a partial view of an exemplary apparatus 1300 that may serve as an illustrative environment of and/or for subject matter technologies that provide user assistance for an item, such as the item 800. The exemplary apparatus 1300 is distinct from the item and includes a computing device 1310. The exemplary apparatus 1300 also includes a first user interface 1320A associatable with the item, and a second user interface 1330A. The exemplary apparatus 1300 further includes an assistance file 1314 having an assistance content related to the item, and an assistance manager 1316 that includes instructions. The instructions, when implemented in the computing device 1310 cause the computing device to perform operations. The operations include receive a query related to the aspect of the item through the first user interface, search the assistance file for an assistance correlating to the query, and provide the assistance correlating to the query through the second user interface.

The first user interface 1320A associatable with an item may include a first user interface removably associatable 1322 with the item. The first user interface 1320A may include a first user interface wirelessly couplable with the computing device through a wireless coupling 1301. The first user interface 1320A may include a first user interface electrically couplable with the computing device through a wired coupling 1302. The second user interface 1330A may include a second user interface wirelessly couplable with the computing device through a wireless coupling 1301 The second user interface 1330A may include a second user interface electrically couplable with the computing device through a wired coupling 1302.

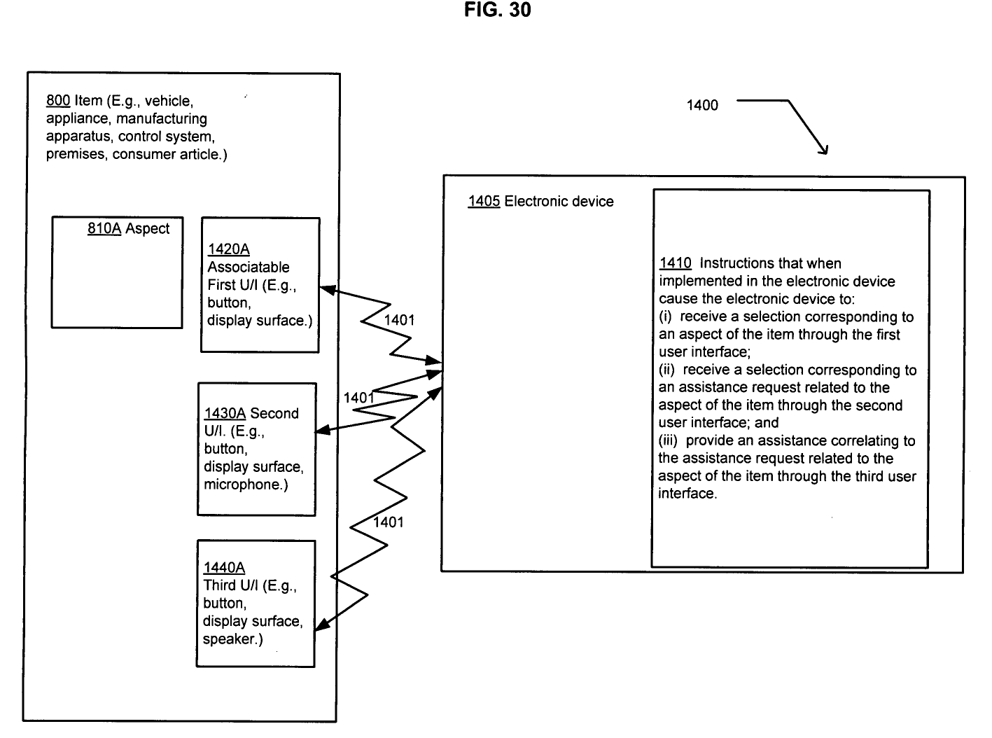

FIG. 30 illustrates a partial view of an exemplary apparatus 1400 that may serve as an illustrative environment of and/or for subject matter technologies that provide user assistance for an item, such as the item 800. The exemplary apparatus 1400 is distinct from the item and includes an electronic device 1405. The electronic device 1405 includes a first user interface 1420A associatable with an aspect 810A of the item 800, a second user interface 1430A, and a third user interface 1440A. The electronic device 1405 further includes instructions that when implemented in the electronic device cause the electronic device to perform certain operations. Operations include receive a selection corresponding to an aspect of the item through the first user interface 1420A, receive a selection corresponding to an assistance request related to the aspect of the item through the second user interface 1430A, and provide an assistance correlating to the assistance request related to the aspect of the item through the third user interface 1440A.

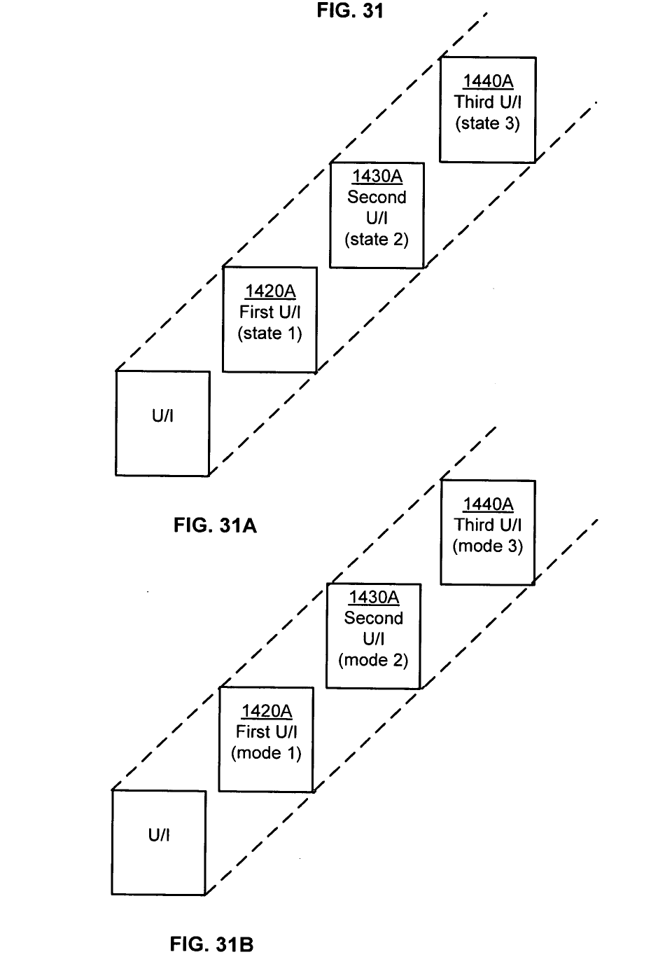

FIGS. 31A and 31B illustrate exemplary embodiments of states and modes of a user interface U/I that may serve as an illustrative environment of and/or for subject matter technologies that provide user assistance for an item. FIG. 31A illustrates an exemplary embodiment where the user interface U/I includes a plurality of states. In a pre-user assistance state, the user interface may have any function. If initially in an optional pre-assistance state, the user interface U/I transitions to a first state, which includes operability that receives a selection related to the item 800. Using FIG. 30 as an example, the user interface U/I transitions to the first state, which is the first user interface 1420A positioned proximate to the aspect 810A. The user interface U/I in the first state includes an operability that receives a selection of an aspect, such as the aspect 810A. After receiving a selection corresponding to an aspect of the item 800 through the user interface U/I in the first state (first user interface 1420A), the user interface transitions from the first state to a second state, which is the second user interface 1430A. The user interface U/I in the second state includes an operability that receives an assistance request selection, such as a help selection. After receiving a selection corresponding to an assistance request through the second user interface U/I in the second state (second user interface 1430A), the user interface transitions from the second state to a third state, which is the third user interface 1440A. The user interface U/I in the third state includes an operability that provides an assistance.

FIG. 31B illustrates an exemplary embodiment where the user interface U/I includes a plurality of modes. Using FIG. 30 as an example, the user interface U/I includes operability responsive to plurality of modes. A first mode may occur upon reception of a first pattern. For example, the first pattern may include receiving a single, quick touch to the user interface U/I. The first mode may include an operability that receives a selection of an aspect of the item, such as the aspect 810A. A second mode may occur upon reception of a second pattern. The second mode may include an operability that receives a selection corresponding to assistance request related to the aspect of the item. The second pattern may include receiving a single, long-touch to the user interface U/I. Alternatively, the second pattern may include receiving two spaced-apart quick touches to the user interface U/I. A third mode may include a user-assistance presentation mode. For example, a user-assistance presentation mode may include one or more of light emitting diodes of various colors that can be appropriately switched and/or blinked to provide an assistance. By way of further example, a user assistance presentation mode may include emitting a sound, providing a graphical display, an animated display, and/or visual display.

Returning to FIG. 30, the first user interface 1420A of the electronic device 1405 may include a first user interface of the electronic device associatable with the aspect of the item 800. The first user interface may be removably associatable with the item. The first user interface may include a first user interface wirelessly couplable with the electronic device, such as through a wireless connection 1401. The second user interface 1430A may include a second user interface wirelessly couplable with the electronic device, such as through a wireless connection 1401.

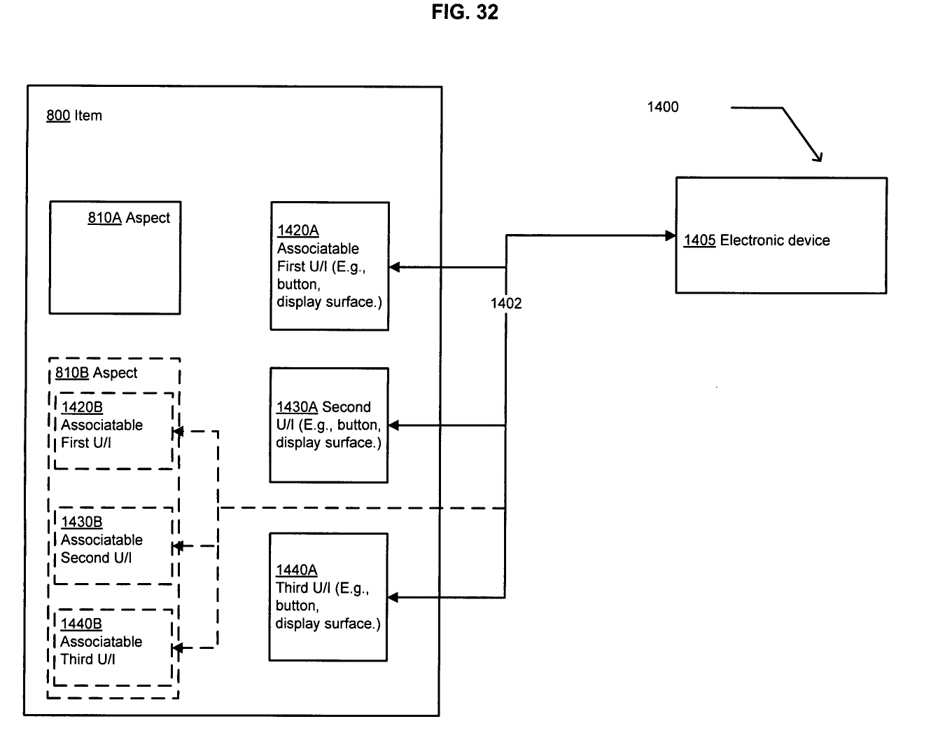

FIG. 32 illustrates a partial view of an alternative embodiment of the exemplary apparatus 1400 of FIG. 30. In this alternative embodiment, the item 800 includes an aspect 810B. The exemplary apparatus 1400 includes an associatable first user interface 1420B, and associatable second user interface of 1430B, and an associatable third user interface 1440B. In this alternative embodiment, these three associatable user interfaces are all associated with the aspect 810B. In addition, these three associatable user interfaces may be electrically coupled or couplable with the exemplary apparatus 1400 through an electrical coupler, such as a coupler 1402.

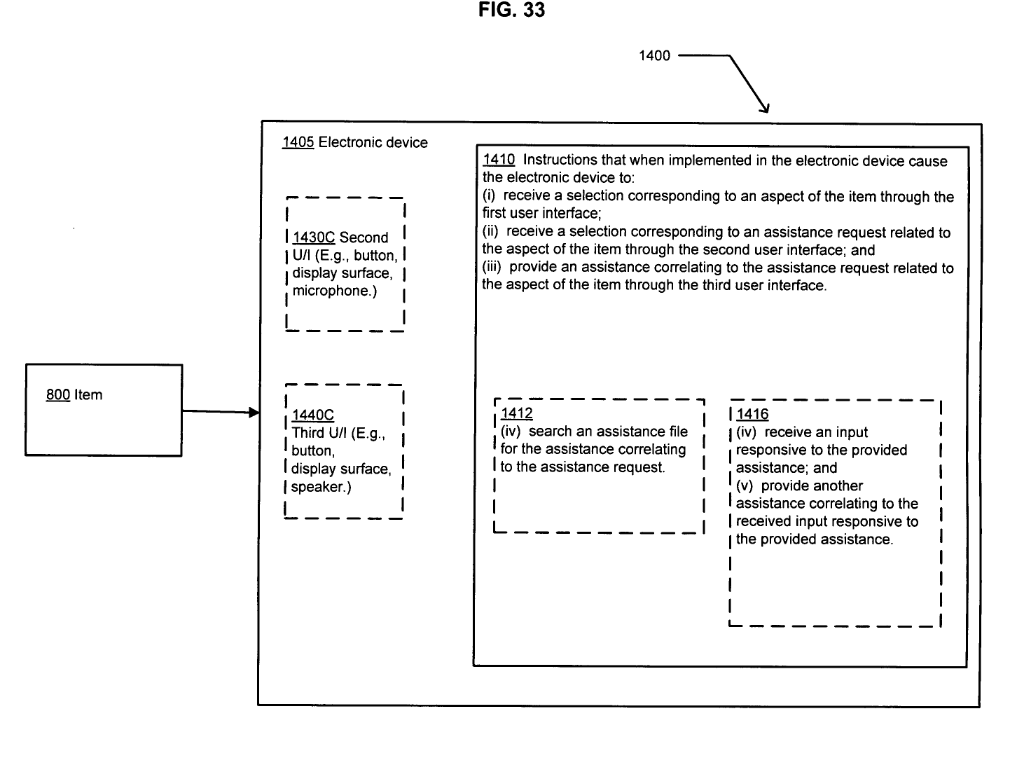

FIG. 33 illustrates a partial view of an alternative embodiment of the exemplary apparatus 1400 of FIG. 30. The exemplary apparatus 1400 may include a second user interface 1430C and a third user interface 1440C that are not associatable with the item 800. The instructions 1410 may further include an operation that searches an assistance file for the assistance correlating to the assistance request. The instructions may additionally include an operation that receives an input responsive to the provided assistance, and provides another assistance correlating to the received input responsive to the provided assistance.

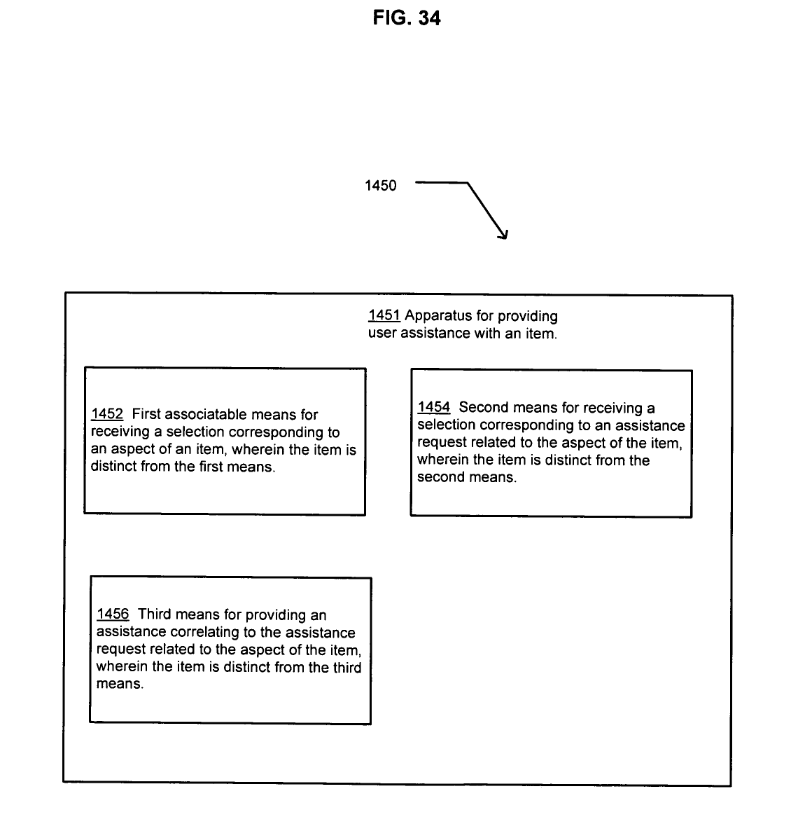

FIG. 34 illustrates a partial view of an exemplary apparatus of 1450 that may serve as an illustrative environment of and/or for subject matter technologies that provide user assistance for an item, such as the item 800. The exemplary apparatus 1451 is distinct from the item 800 and includes a first associatable means 1452 for receiving a selection corresponding to an aspect of an item. The exemplary apparatus 1451 includes a second means 1454 for receiving a selection corresponding to an assistance request related to the aspect of the item. The exemplary apparatus 1451 includes a third means 1456 for providing an assistance correlating to the assistance request related to the aspect of the item.

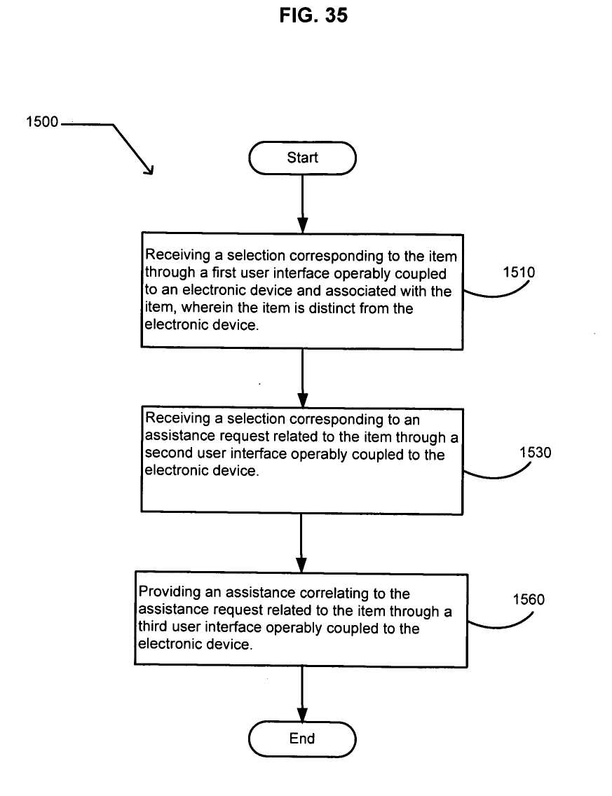

FIG. 35 illustrates an exemplary operational flow 1500 that provides a user assistance with an item, such as the item 800. After the start of operation, the flow moves to a selection operation 1510. At the selection operation 1510, a selection corresponding to the item is received through a first user interface operably coupled to an electronic device and associated with the item. The item is distinct from the electronic device. At a request operation 1530, a selection is received corresponding to an assistance request related to the item through a second user interface operably coupled to the electronic device. At a broadcast operation 1560, an assistance is provided a correlating to the assistance request related to the item through a third user interface operably coupled to the electronic device. In certain embodiments, a user interface of the first use interface, the second user interface, and/or the third user interface a may include a plurality of states and/or a plurality of modes. FIGS. 31A and 31B illustrate several exemplary embodiments of states and modes of a user interface.

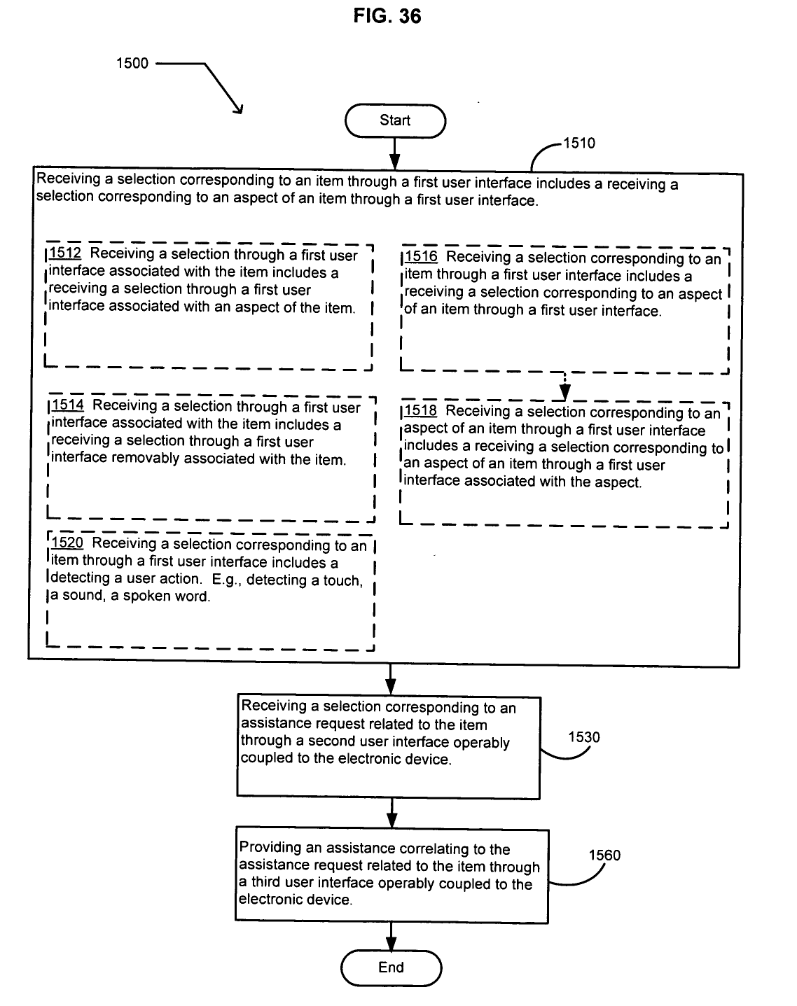

FIG. 36 illustrates an alternative embodiment of the exemplary operational flow 1500 of FIG. 35. FIG. 36 illustrates an embodiment where of the selection operation 1510 may include at least one additional operation. Additional operations may include operation 1512, operation 1514, operation 1516, operation 1518, and/or operation 1520. At operation 1512, the receiving a selection through a first user interface associated with the item may include a receiving a selection through a first user interface associated with an aspect of the item. At operation 1514, the receiving a selection through a first user interface associated with the item may include a receiving a selection through a first user interface removably associated with the item. At operation 1516, the receiving a selection corresponding to an item through a first user interface may include a receiving a selection corresponding to an aspect of an item through a first user interface. The operation 1516 may further include operation 1518. At operation 1518, the receiving a selection corresponding to an aspect of an item through a first user interface may include a receiving a selection corresponding to an aspect of an item through a first user interface associated with the aspect. At operation 1520, the receiving a selection corresponding to a an item to a first user interface includes detecting a user action. The detected user action may include detecting a touch, a sound, and/or a spoken word.

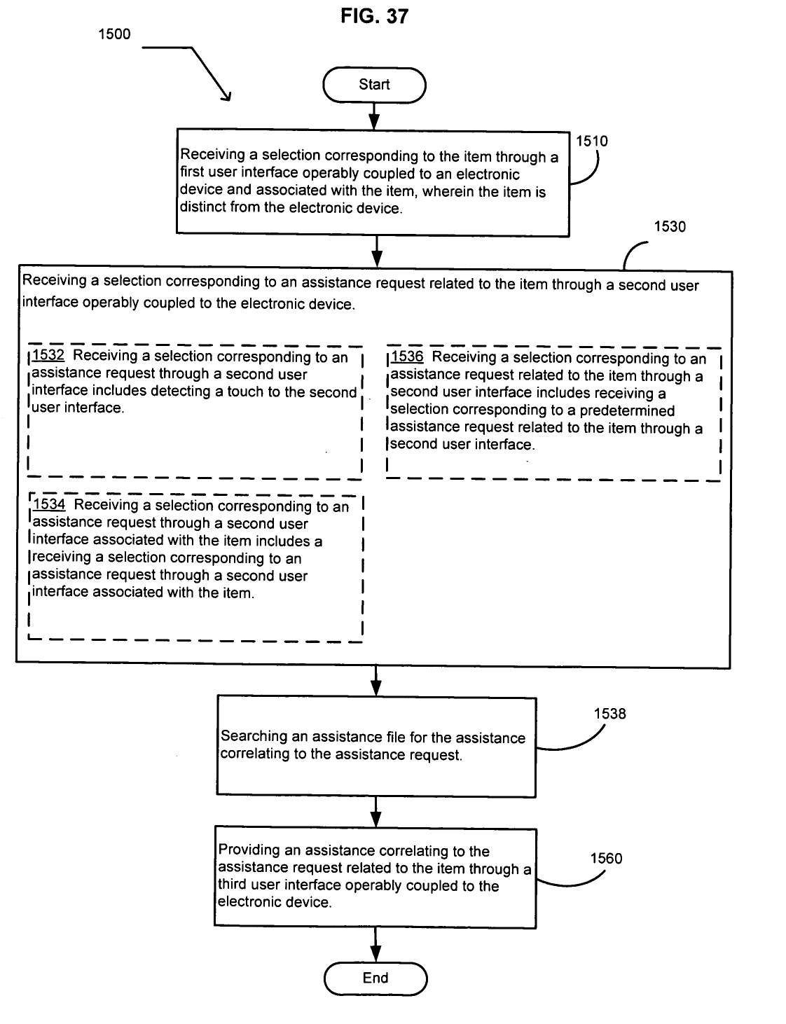

FIG. 37 illustrates an alternative embodiment of the exemplary operational flow 1500 of FIG. 35. FIG. 37 illustrates an embodiment where the selection operation 1530 may include at least one additional operation. Additional operations may include operation 1532, operation 1534, operation 1530, and/or operation 1538. At operation 1532, the receiving a selection corresponding to an assistance request through a second user interface may include detecting a touch to the second user interface. At operation 1534, the receiving a selection corresponding to an assistance request through a second user interface associated with the item may include a receiving a selection corresponding to an assistance request through a second user interface associated with the item. At operation 1536, the receiving a selection corresponding to an assistance request related to the item through a second user interface may include receiving a selection corresponding to a predetermined assistance request related to the item through a second user interface. FIG. 37 also illustrates an alternative embodiment where the exemplary operational flow 1500 further includes searching an assistance file for the assistance correlating to the assistance request.

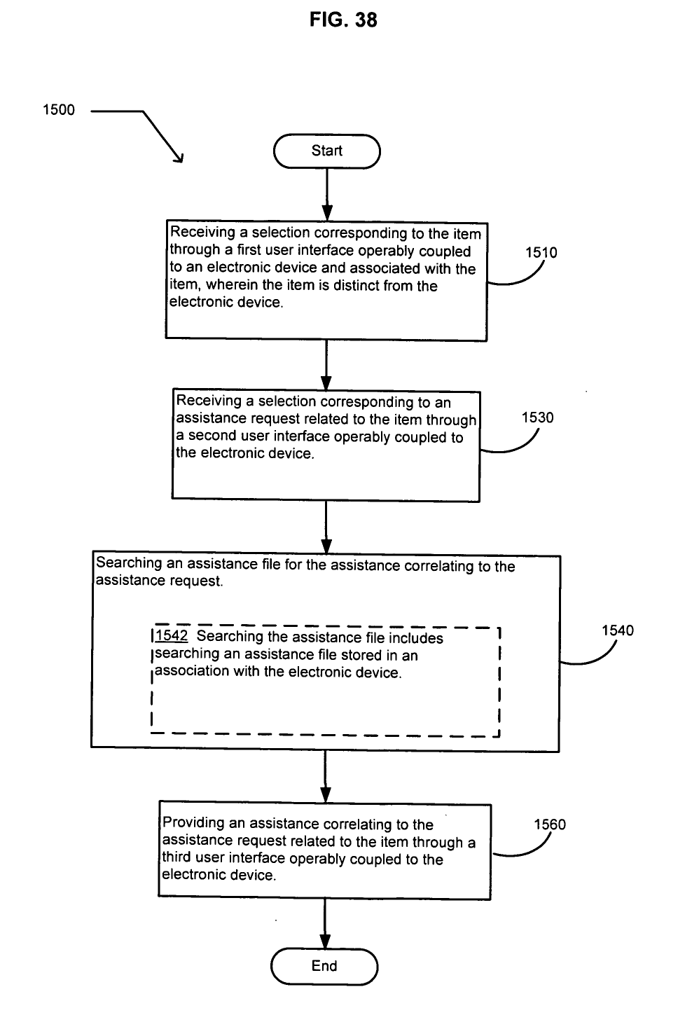

FIG. 38 illustrates an alternative embodiment of the exemplary operational flow 1500 of FIG. 35. FIG. 38 illustrates an embodiment where the exemplary operation flow 1500 may include operation 1540. At operation 1540, an assistance file is searched for the assistance correlating to the assistance request. The operation 1540 may further include operation 1542. At operation 1452, searching the assistance file may include searching an assistance file stored in an association with the electronic device.

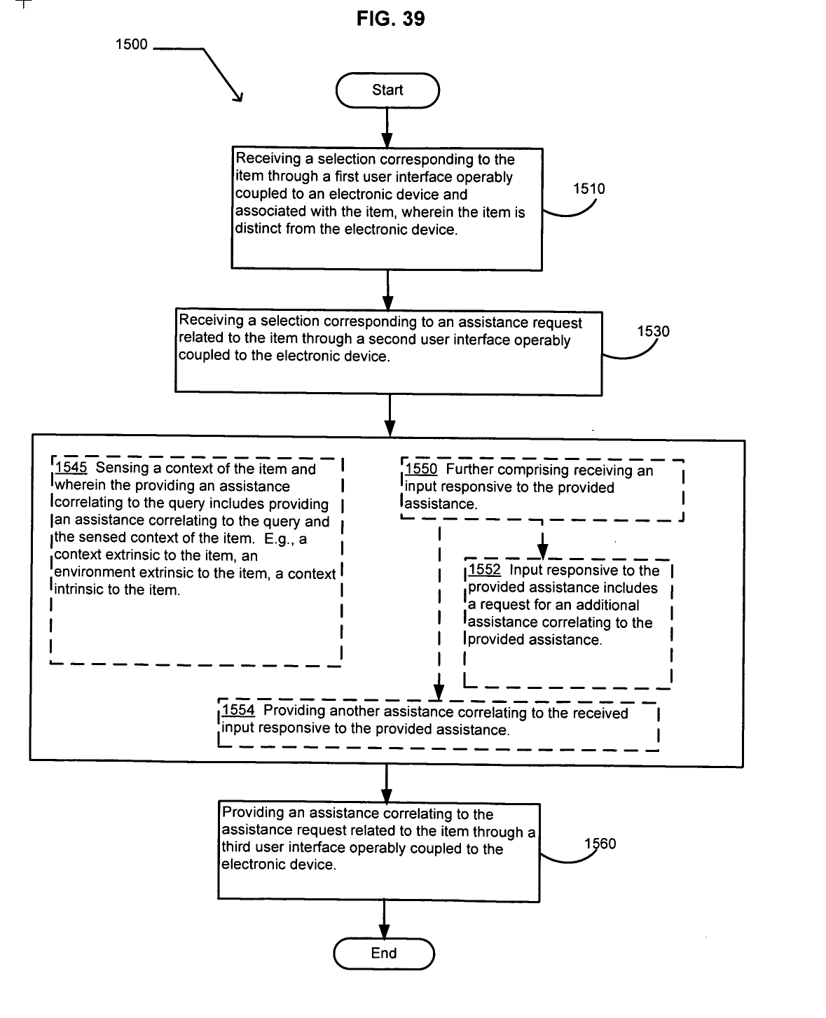

FIG. 39 illustrates an alternative embodiment of the exemplary operational flow 1500 of FIG. 35. FIG. 39 illustrates an embodiment where the selection operation 1510 may include at least one additional operation. The additional operation may include an operation 1545, and/or an operation 1550. At operation 1545, a context of the item is sensed. The sensed context may include a context extrinsic to the item, an environment extrinsic to the item, and/or a context intrinsic to the item. The providing an assistance correlating to the query at the operation 1560 includes providing an assistance correlating to the query and the sensed context of the item. At operation 1550, an input is received responsive to the provided assistance. The exemplary operation flow 1500 may then flow from operation 1550 to operation 1552. At operation 1552, the input responsive to the provided assistance may include a request for an additional assistance correlating to the provided assistance. Alternatively, the exemplary operation flow 1500 may then flow from operation 1550 to operation 1554. At operation 1554, another assistance is provided correlating to the received input responsive to the provided assistance.

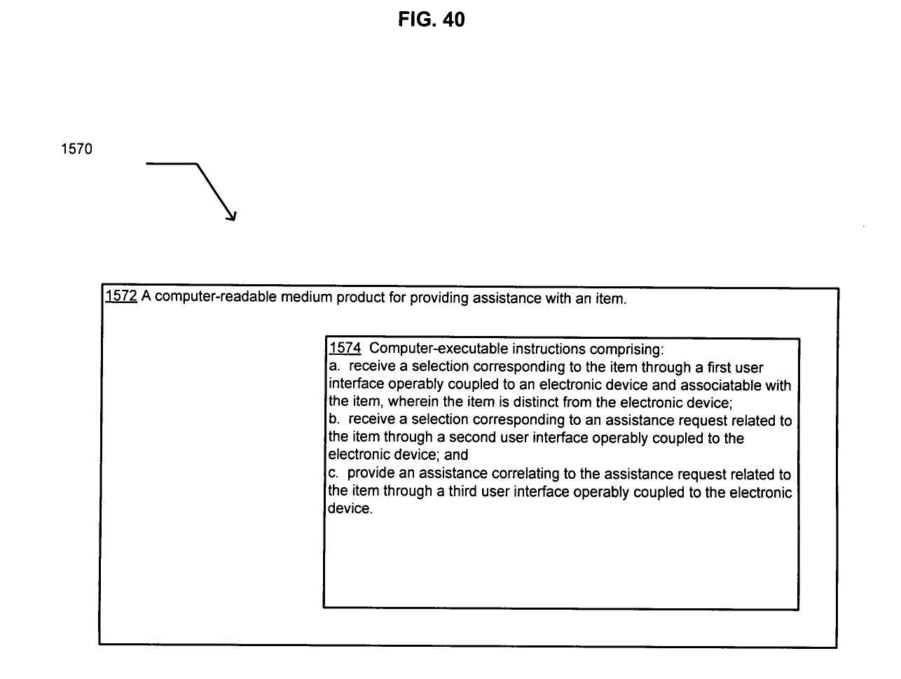

FIG. 40 illustrates a partial view of product 1570 that includes an exemplary computer-readable medium product 1572 that may serve as an illustrative environment of and/or for subject matter technologies that provide user assistance for an item. The computer-readable medium product 1572 includes computer-executable instructions 1574. The computer-executable instructions include an operability to receive a selection corresponding to the item through a first user interface operably coupled to an electronic device and associatable with the item, wherein the item is distinct from the electronic device. The computer-executable instructions a further include an operability to receive a selection corresponding to an assistance request related to the item through a second user interface operably coupled to the electronic device. The computer executable instructions also include an operability to provide an assistance correlating to the assistance request related to the item through a third user interface operably coupled to the electronic device. The computer-readable medium product may include a computer storage medium product, which may be carried by a computer-readable carrier. The computer-readable medium product may include a communications medium product.

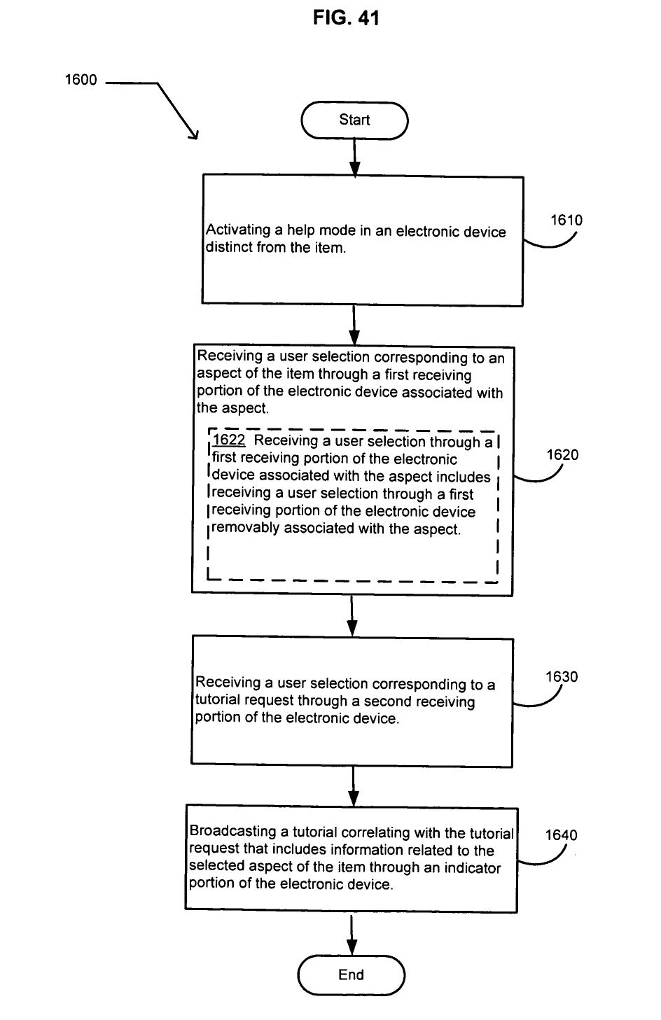

FIG. 41 illustrates an exemplary operational flow 1600 that provides a user assistance with an item, such as the item 800. After the start of operation, the flow moves to an activation operation 1610. At the activation operation 1610, a help mode is activated in an electronic device distinct from the item. At feature selection operation 1620, a user selection is received a corresponding to an aspect of the item through a first receiving portion of the electronic device associated with the aspect. At a request operation 1630, a user selection is received corresponding to a tutorial request through a second receiving portion of the electronic device. At a tutorial operation 1640, a tutorial correlating with the tutorial request that includes information related to the selected aspect of the item is broadcast through an indicator portion of the electronic device.

In an alternative embodiment, the feature selection operation of 1620 includes an operation 1622. At the operation 1622, the receiving a user selection through a first receiving portion of the electronic device associated with the aspect may include receiving a user selection through a first receiving portion of the electronic device removably associated with the aspect. The first receiving portion of the electronic device and the second receiving portion of the electronic device may be at least substantially a same portion of the electronic device.

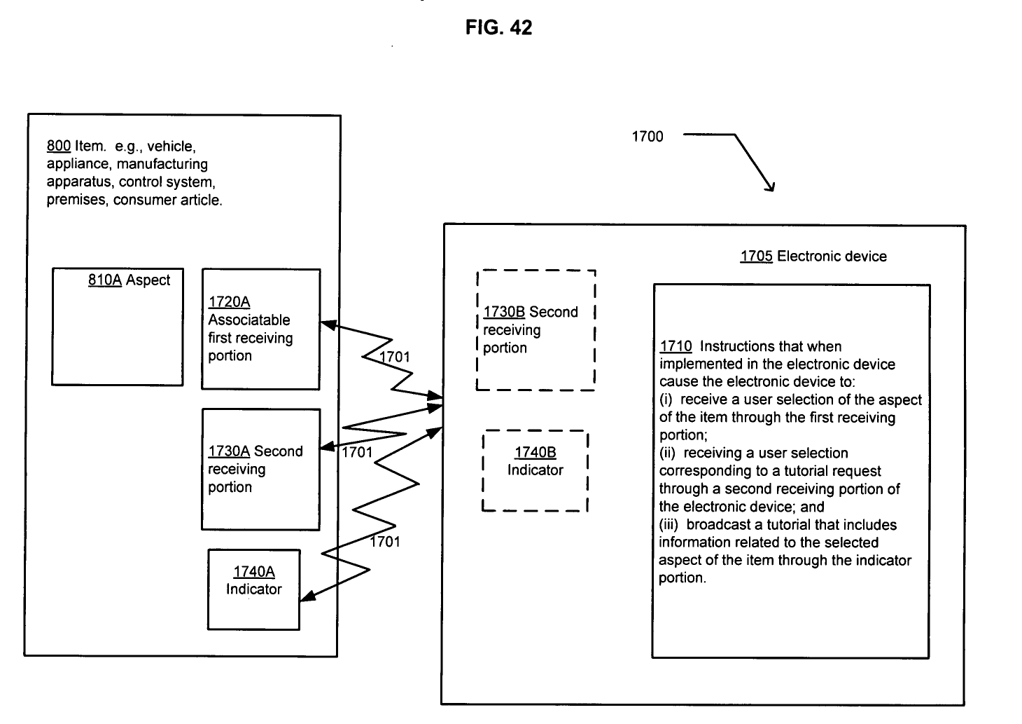

FIG. 42 illustrates a partial view of an exemplary apparatus of 1700 that may serve as an illustrative environment of and/or for subject matter technologies that provide user assistance for an item, such as the item 800. The exemplary apparatus 1700 is distinct from the item 800, and may include an electronic device 1705 having a first receiving portion 1720A associatable with an aspect 810A of the item 800, a second receiving portion 1730A, and an indicator portion 1740A. The exemplary apparatus 1700 also includes instructions 1710. The instructions 1710, when implemented in the electronic device 1705 cause the electronic device to perform certain operations. The operations include a user selection of the aspect of the item through the first receiving portion, receiving a user selection corresponding to a tutorial request through a second receiving portion of the electronic device, and broadcast a tutorial that includes information related to the selected aspect of the item through the indicator portion.

The first receiving portion 1720A, the second receiving portion 1730A, and/or the indicator portion 1740A may include a coupling with the computing device through a wireless coupling 1701. In an alternative embodiment, the first receiving portion 1720A, the second receiving portion 1730A, and/or the indicator portion 1740A may include an electrical coupling with the computing device through a wired coupling (not shown).

In an alternative embodiment, the exemplary apparatus 1700 may also include a second receiving portion 1730B and an indicator 1740B that are not associatable with the item 800.

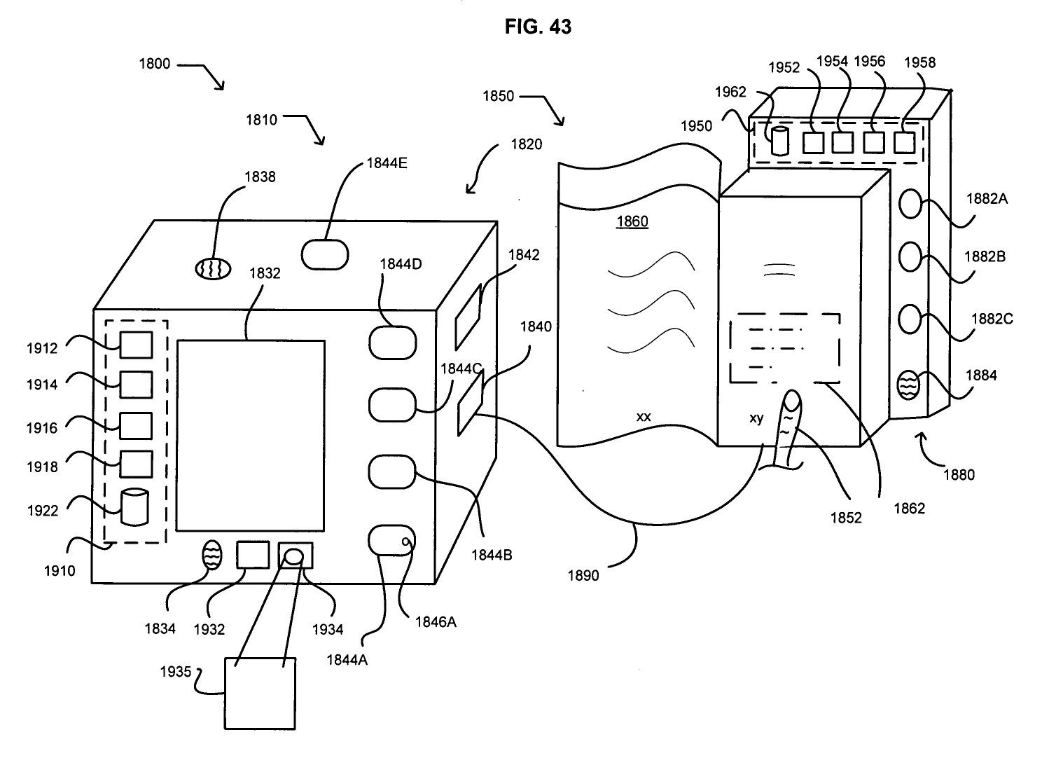

FIG. 43 illustrates an example environment 1800 in which embodiments may be implemented. The environment includes a digital camera 1810 and a manual 1850 related to the camera. The digital camera 1810 includes a computing device (not shown), such as the thin computing device 20 described in conjunction with FIG. 1. The digital camera also includes a plurality of user interfaces 1820. The user interfaces 1820 include a display operable to present a human-understandable content using a display surface, such as a screen 1832. In alternative embodiments, the display may present a visual display, and/or a graphical display. In another embodiment, the display may include at least one of an electronically driven display surface. The electronic display surface may be operated by an electronic display facilitation circuit 1918. The electronic display surface may be physically incorporated with the digital camera, or may be physically separate from the mobile device and electronically coupled with the mobile device. In another embodiment, a display surface 1935 is structurally and physically distinct from the digital camera, and is able to display a content projected by a projector display engine 1934 of the digital camera, such as a screen or a reflective wall. The display surface may include at least one of a visually reflective surface, a flat surface, a screen, an audio speaker, or a scent emitter.

In a further embodiment, the display 1832 may include a touch screen functionality operable to accept a user input. The user interfaces 1820 of the digital camera 1810 also include a microphone 1834, a speaker 1838, and a plurality of tangible buttons 1844A-1844E. One or more of the tangible buttons may include a light emitter, such as a light emitting device 1846A. Further, one of more of the tangible buttons 1844A-1844E may include a vibrator operable to provide a tactile/haptic display. The display 1832 and the tangible buttons 1844A-1844E may have any functionality appropriate to the digital camera. For example, button 1844E may be assigned to operate a device element, such as a shutter function. Button 1844A may be assigned an “enter” function, and buttons 1844B and 1844C may be respectively assigned a scroll up and scroll down function relative to a menu displayed on the display 1832. Button 1844D may be assigned to operate another device element, such as a lens zoom function.

The digital camera 1810 further includes a USB port 1840, and a network port 1842. The digital camera 1810 also includes a system memory, such as the system memory 22 of the thin computing device 20 of FIG. 1. The system memory includes stored operating systems and programs necessary to perform a core functionality of the digital camera, and may also include an assistance file. The assistance file includes information intended to help a user in response to user-selected requests, the requests being selected in response to portions of the manual 1850. The assistance file includes operability to provide assistance, such as advice and instructions, through a user interface of the digital camera 1810, such as the tangible buttons 1844A-1844E, a display, such as the display 1832, and/or the speaker 1838. In another embodiment, the assistance file includes operability to provide interactive assistance with additional user inputs being received through the camera user interfaces 1820. In an embodiment, the provided assistance may include any type of presentation, such as a visual presentation, an audio presentation, a spoken presentation, a tactile presentation, and a combination of two or more of the foregoing presentation modes.

In an alternative embodiment, the digital camera 1810 includes additional circuits and/or components 1910. The additional circuits and/or components include at least one of a content indication receiver circuit 1912, an analytic circuit 1914, a signal generator circuit 1916, an electronic display facilitation circuit 1918, or the computer readable storage medium 1922. In addition, the digital camera may include an electronic display circuit 1932, and/or a projector display engine 1934. For example, the projector display engine may be implemented using a Pico Projector Display Engine by Microvision, Inc.

A representative embodiment of the manual 1850 illustrated in FIG. 43 includes a content display 1860 that presents a content of the manual to assist a user, and an electronic interface 1880. The manual 1850 is illustrated as physically coupled with the digital camera 1810 by a wire link 1890. In an alternative embodiment, they may be coupled by a wireless link (not shown), and/or an optical link (not shown). In the illustrated representative embodiment, the manual 1850 includes a tangible manual, such as a paper manual. The content display 1860 includes a plurality of touch sensitive pages, two of which are illustrated as pages XX and XY. The content display 1860 of FIG. 5 illustrating two open pages of a physical or tangible manual is representative of any type of display. The content of the pages may include assistance, such as information and instructions, related to the digital camera 1810. The content may be called from a storage. The storage may be associated with any device, including a computer readable storage medium 1962 associated with the manual 1850 and/or the computer readable storage medium 1922 associated with the digital camera 1810. The manual 1850 may be provided by an original equipment manufacturer of the camera 1810, or it may be provided by a third party.

In another embodiment, the manual may have an intangible form, and include a display other than the display 1860 of the digital camera 1810. In addition to the open manual or book configuration illustrated in FIG. 5, the content display 1860 may include any display, on a surface plane or otherwise, operable to display static images and/or image streams related to providing a content of a manual. In a further embodiment, the manual may include an e-paper manual. In another embodiment, the manual may include operability to provide content audibly, for example by using a speaker associated with the manual (not shown). In other embodiments, the manual may include operability to provide content using a streaming image or video display, a static image display, and/or an audio display.

The manual user interface 1880 includes operability to receive a user-selection to the content display 1860 and a user-selection to an assistance menu, illustrated as the buttons 1882A-1882C, and microphone 1884. The manual user interface 1880 is also operable to generate appropriate signals in response to the user selections, and to provide those signals to the digital camera 1810. A portion of the user interface 1880 includes a correlation module (not shown) operable to correlate a user-selected portion of a manual page with an aspect of the digital camera 1810. Another portion of the user interface includes buttons 1882A-1882C, and microphone 1884. The buttons 1882A-1882C may be described as a menu and configured to receive a user-assistance selection. The buttons may be appropriately labeled, such as “show me,” “demonstrate,” and “guide me” respectively.

In an alternative embodiment, the manual 1850 may include a user assistance manager circuit 1950. The user assistance manager circuit includes at least one of a sensor circuit 1952, an analytic circuit 1954, a signal generator circuit 1956, an content indication receiver circuit 1958, or the computer readable storage medium 1962.

In operation, a user browses through the content display 1860 of the manual 1850. If the user is interested in receiving assistance related to a displayed portion 1862 of the manual content related to an aspect of the digital camera 1810, the user selects the displayed portion. In an embodiment illustrated in FIG. 43, the manual receives a user selection of the displayed portion 1862 of the manual content by receiving a touch by a user's fingertip to the displayed portion. In other embodiments, the manual receives a user selection of the displayed portion 1862 of the manual content in any manner, for example, receiving a user body part orientation with respect to the portion of the manual, such as a finger tip 1852 pointed toward the displayed portion, or an eye directed toward the displayed portion (not shown). Alternatively, the manual may receive a user selection by receiving at the microphone 1884 a user created sound, a user-spoken word, and a user spoken phrase. For example, a user may have selected a displayed portion 1862 related to deleting stored images from a memory of the digital camera 1810. In another embodiment, the manual receives a signal indicative of a user selecting generated by an optical tracking apparatus (not shown), which may include an operability to track a selective motion of the user's hand, finger, and/or eyes.

In response to the received user-selection to the displayed portion 1862 of the manual 1850, the user interface 1880 generates a signal corresponding to the user-selection. The user assistance manager circuit 1950 may use the signal corresponding to the user-selection in searching for a user assistance. In an alternative embodiment, the signal corresponding to the user-selection is communicated from the manual to the digital camera 1810.

In an alternative embodiment, the user additionally selects an assistance from a menu of assistance modes presented by the buttons 1882A-1882C, which are respectively labeled as “show me,” “demonstrate,” and “guide me.” Continuing the above example where the selected displayed portion 1862 related to deleting stored images, a user may have selected button 1882A, “show me.” In response to the received user-selected request for “show me” assistance, the user interface 1880 generates a signal corresponding to “show me” assistance request. The user assistance manager circuit 1950 may use the signal in searching for a user assistance. In an alternative embodiment, the signal is communicated between the manual 1850 and the digital camera 1810.

The digital camera 1810 receives the signals from the manual 1850 communicated over the wire link 1890. In response to the received signal corresponding to a user-selected portion 1862 of the manual, an electronic device assistance manager running on the computing device (not shown) searches an assistance file stored in a memory of the computing device for an assistance correlating with the user-selected portion of the manual. The assistance file includes assistance content related to the electronic device, which includes a configuration for providing assistance through the user interfaces 1820 of the digital camera 1810. With reference to the above example where the selected portion 1862 of the manual relates to deleting stored images, the assistance manager searches the assistance file for assistance content related to deleting stored images. The assistance content includes using the user interfaces 1820 of the digital camera 1810 to provide assistance.

In the alternative embodiment illustrated above where the user further selected “show me” as the type of assistance desired, the assistance manager further searches the assistance file for an assistance both correlating with the user-selected portion of the manual and the “show me” assistance request.

In response to the search of the assistance file, the digital camera 1810 provides assistance correlating to the user-selected request for assistance through at least one the user interfaces 1820 of the digital camera. For example, the assistance may include providing in the display 1832 a demonstrative visual presentation of the menu used to delete stored images, and a representation of a user movement through the menu to delete stored images. The assistance may also provide a voice track through the speaker 1838 that describe the deletion process, the voice track being coordinated with the visual presentation in the display 1832. The assistance may further include flashing the light emitting device 1846A as appropriate to indicate when the button 1844A should be pressed by a user. Alternatively, the provided assistance may include an assistance that guides a user through the actually steps to delete a user-selected stored image.

In another embodiment, the digital camera 1810 and the manual 1850 jointly present assistance correlating to the selected portion 1862 of the manual. The assistance may be jointly presented, allocated, selected, and/or coordinated in any manner. For example, a manner of jointly presenting the assistance may depend in part on the relative richness of the digital camera 1810 and the manual 1850, and their respective user interfaces. Continuing with this example, assume the manual 1850 of FIG. 43 includes the speaker 1884 having a better quality than the speaker 1838 of the digital camera 1810, and the digital camera includes a microphone 1834 having a better quality than the microphone 1880 of the manual 1850. The process of providing an assistance corresponding to the selected portion 1862 of the manual in this embodiment may include receiving user input related to the selected portion 1862 of the manual 1850 through the microphone 1834 of the digital camera 1810. For example, the manual 1850 may detect a touch of the user finger 1852 to the portion 1862 as a selection and generate a corresponding signal. The microphone 1834 of the camera 1810 may detect a user speaking words “show me” and generate a corresponding signal. The data in these two signals may be combined, forming a signal corresponding to a selected portion of the manual 1850 related to an aspect of the digital camera 1810. Continuing with this example, the process of providing an assistance correlating to the selected portion of the manual may include jointly providing an assistance through user interfaces of both the manual 1850 and the digital camera 1810. For example, a joint presentation of the assistance may include a providing a streaming visual presentation using the visual display 1832 of the camera 1810 and displaying a new page (not shown) of the manual other than the page containing the selected portion 1862.

A further embodiment relates to providing assistance with an item having one or more aspects for which assistance may be desired. However, the item does not include an electronic device, or if it does include an electronic device, the electronic device only includes a very a thin computing device or very limited or non-existent user interfaces. The further embodiment includes a smart device, such as the smart device of FIGS. 25 and/or 26, a manual for an item, such as the manual 1850, and a user assistance, such as the plurality of tutorials 1180 of FIG. 25. The smart device may include a computing device, such as the thin computing device 20 described in conjunction with FIG. 1. The thin computing device includes a plurality of user interfaces, for example, a plurality of user interfaces substantially similar to the user interfaces 1820 of the digital camera 1810, such as a visual display, a microphone, a speaker, and a plurality of tangible buttons. In addition, one or more of the tangible buttons may include a light emitter, such as a light emitting device, and a vibrator operable to provide a tactile display.

An embodiment of the smart device 1151 includes a physical object having a configuration providing a meaningfully association with aspects of the item. In an embodiment, the association may be physical, with the smart device being physically overlaid or applied to the item such that one or more portions of the smart device user interfaces are respectively proximate to and visually associable with the one or more aspects of the item, such as the indicator 1170A and/or the receiver 1160 illustrated in conjunction with FIG. 26. One or more of the user interfaces may be respectively configured to be positioned proximate to and visually associable with the one or more aspects of the item. The smart device may further include a USB port, a network port, and a wireless port.

The smart device 1151 may include a computing device that includes a system memory, such as the system memory 22 of the thin computing device 20 of FIG. 1. The system memory includes stored operating systems and programs necessary to operate the smart device, an assistance manager, such as the process 200 described in conjunction with FIG. 3, and an assistance file. The assistance file includes a body of information intended to help a user in response to a plurality of user-selected requests related to the item, the requests being selected in response to the manual 1850 as described above. The assistance file includes operability to provide assistance, such as advice and instructions related to the item, through the user interfaces of the smart device. The smart device is coupled with the manual 1850 using the coupler 1890. Alternatively, the smart device and the manual 1850 are wirelessly coupled. Wireless coupling may provide flexibility in applying the smart device to the item without requiring physical cabling between the smart device and the manual.

An example of an application of the smart device and the manual 1850 includes providing assistance with a control panel for an item, such as complicated system, for example, as is present in a manufacturing operation, in electrical grid control, in a sound board of a recording studio, and in a planetarium. In an embodiment, the smart device would include openings allowing the smart device to be fitted over knobs and around dials of the control panel, and include user interfaces proximate to the openings. The user interfaces of the smart device may include LED's of various colors that can be appropriately switched on, off, or blinked, to provide an assistance correlating to the selected portion 1862 of the manual 1850. A user desiring assistance would select a desired assistance, and the assistance is provided using appropriate LED's and other portions of the user interfaces of the smart device. In addition, the assistance may also be provided through the user interfaces of the manual 1850.

Another example of an application of the smart device and a manual, such as the manual 1850, includes providing assistance with an item, such as a hotel room or an ergonomic chair. Using the hotel room as an example, smart tags may be respectively associated aspects of the hotel room by placement at locations proximate to aspects. The manual relates the hotel room, such as, for example, a hotel room guide, and portions correspond to aspects of the hotel room. The smart tags may include an electronic device, a wireless link, and a user interface, such as a switchable light source and sound generator. The manual may include user selectable content related to aspects of the hotel room, and a wireless link. For example, smart tags may be respectively placed proximate to a thermostat, a dimmer switch for a hot tub, and a switch that closes a window covering. A user wanting assistance in locating the thermostat could select a portion of the hotel room guide related to the thermostat. The hotel room guide, or manual, would receive the selection and in responsive thereto wirelessly transmit a signal activating a user interface of the smart tag proximate to the thermostat. For example, the user interface may blink a light and emit a beeping sound to attract attention to the thermostat location, thus providing assistance. Using the ergonomic chair example, smart tags may be placed at locations on or proximate to respective levers and knobs of the chair. A user wanting assistance in reclining the chair back could select a portion of the chair manual related to the chair back. The manual would receive the selection and wirelessly transmit a signal activating a user interface located on a lever adjusting a reclining function. For example, the user interface may blink a light, such as the light emitting device 1846A, thus providing assistance. The smart tags may be removable from the chair.

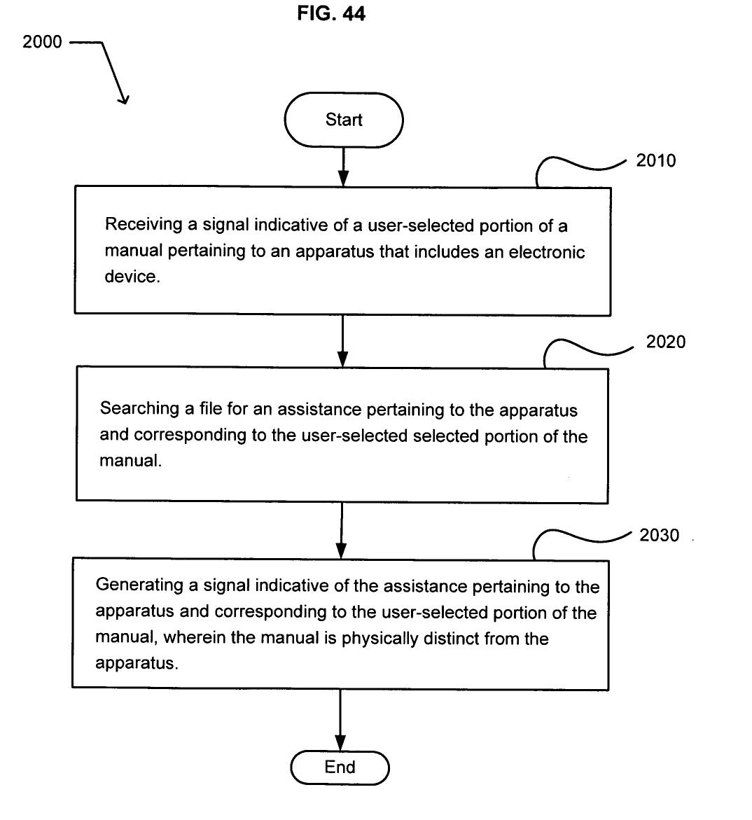

FIG. 44 illustrates an example of an operational flow 2000. FIG. 44 and several following figures may include various examples of operational flows, discussions, and explanations with respect to the above-described environment 1800 of FIG. 43, and/or with respect to other examples and contexts. However, it should be understood that the operational flows may be executed in a number of other environments and contexts, and/or in modified versions of FIG. 43. Also, although the various operational flows are illustrated in a sequence(s), it should be understood that the various operations may be performed in other orders than those which are illustrated, and/or may be performed concurrently.

After a start operation, the operational flow 2000 includes an inquiry operation 2010. The inquiry operation includes receiving a signal indicative of a user-selected portion of a manual pertaining to an apparatus that includes an electronic device. The inquiry operation may be implemented using the content indication receiver circuit 1912 of the apparatus 1810 and/or the content indication receiver circuit 1958 of the manual 1850 as illustrated in FIG. 43. An analytic operation 2020 includes searching a file for an assistance pertaining to the apparatus and corresponding to the user-selected portion of the manual. The analytic operation may be implemented using the analytic circuit 1914 of the apparatus and/or the analytic circuit 1954 of the manual. A communications operation 2030 includes generating a signal indicative of the assistance pertaining to the apparatus and corresponding to the user-selected portion of the manual. The manual is physically distinct from the apparatus. The communications operation may be implemented using the signal generator circuit 1916 of the apparatus, and/or the signal generator circuit 1956 of the manual. The operational flow then moves to an end operation.

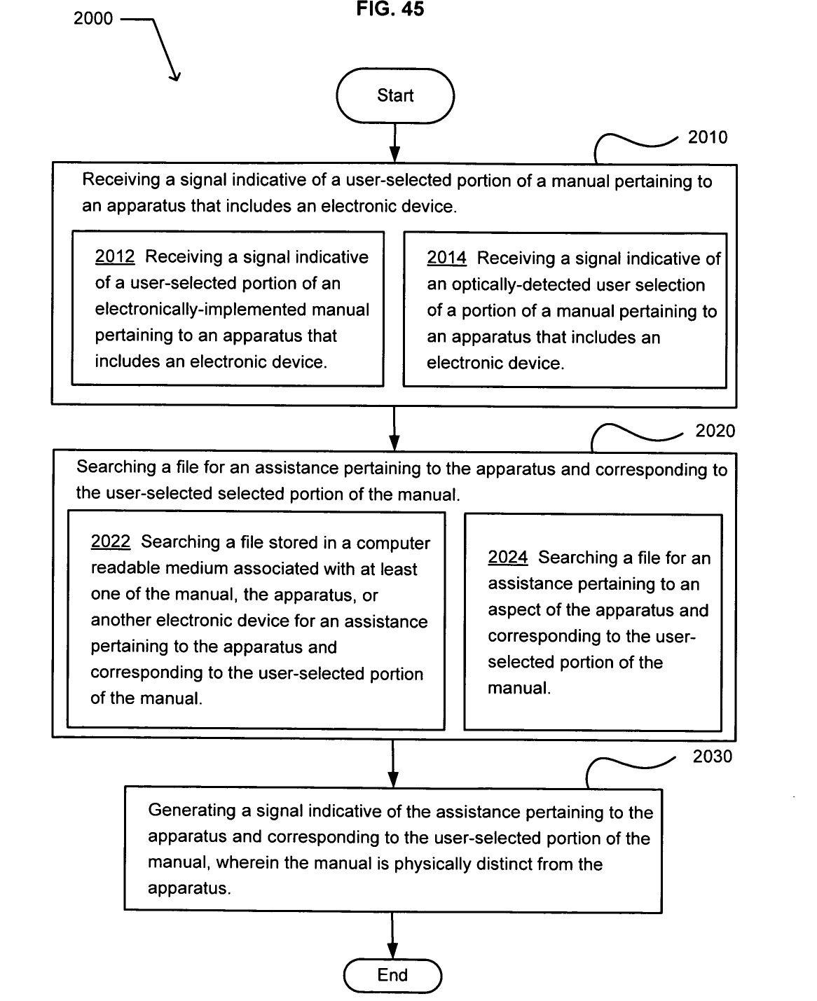

FIG. 45 illustrates an alternative embodiment of the operational flow 2000 of FIG. 44. The inquiry operation 2010 may include at least one additional operation. The at least one additional operation may include an operation 2012, or an operation 2014. The operation 2012 includes receiving a signal indicative of a user-selected portion of an electronically-implemented manual pertaining to an apparatus that includes an electronic device. The operation 2014 includes receiving a signal indicative of an optically-detected user selection of a portion of a manual pertaining to an apparatus that includes an electronic device. The analytic operation 2020 may include at least one additional operation. The at least one additional operation may include an operation 2022, or an operation 2024. The operation 2022 includes searching a file stored in a computer readable medium associated with at least one of the manual, the apparatus, or another electronic device for an assistance pertaining to the apparatus and corresponding to the user-selected portion of the manual. The operation 2024 includes searching a file for an assistance pertaining to an aspect of the apparatus and corresponding to the user-selected portion of the manual.

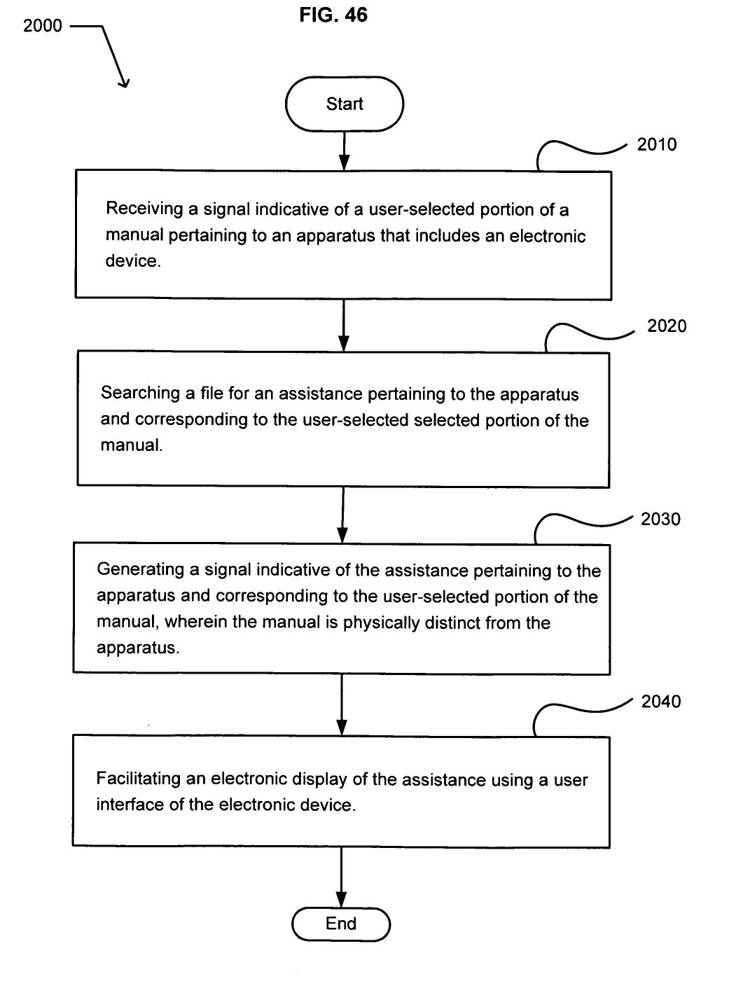

FIG. 46 illustrates another alternative embodiment of the operational flow 2000 of FIG. 44. The operational flow may include at least one additional operation, illustrated as the assistance operation 2040. The assistance operation includes facilitating an electronic display of the assistance using a user interface of the electronic device. The assistance operation may be implemented using at least one of a display associated with the apparatus 1810, such as the display 1832, the projector display engine 1934 which may be driven by the electronic display circuit 1932, and/or a display associated with the manual 1850, such as an electronically controlled version of the display 1860, or a projector display engine (not shown).

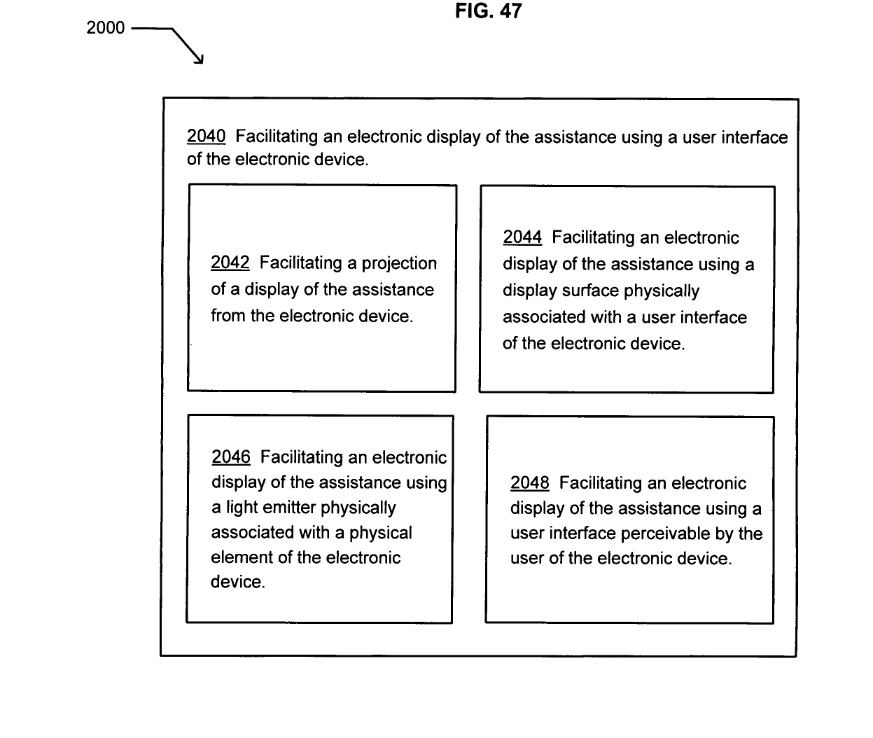

FIG. 47 illustrates a further alternative embodiment of the operational flow 2000 of FIG. 44. The assistance operation 2040 may include at least one additional operation. The at least one additional operation may include an operation 2042, an operation 2044, an operation 2046, or an operation 2048. The operation 2042 includes facilitating a projection of a display of the assistance from the electronic device. The operation 2042 may be implemented using an embedded image projector operable to display the assistance on a surface, such as the projector display engine 1934 to display the assistance on a surface 1935 of FIG. 43. The surface may include a wall, a screen, or other surface suitable for displaying a projected image. The assistance may include text, a still image, and/or a streaming image. In an embodiment, the projector display engine 1934 may include a Pico Projector Display at least similar to that provided by Microvision, Inc. The operation 2044 includes facilitating an electronic display of the assistance using a display surface physically associated with a user interface of the electronic device. The operation 2044 may be implemented using the display surface 1832. The operation 2046 includes facilitating an electronic display of the assistance using a light emitter physically associated with a physical element of the electronic device. The operation 2048 includes facilitating an electronic display of the assistance using a user interface perceivable by the user of the electronic device.

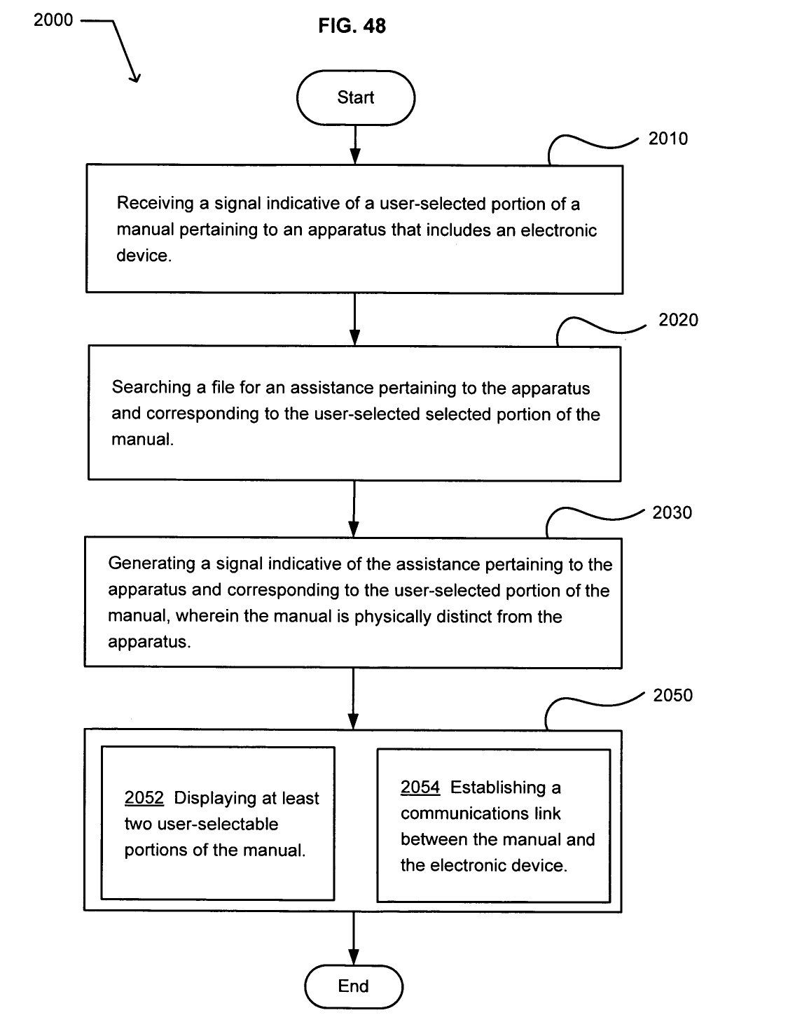

FIG. 48 illustrates an alternative embodiment of the operational flow 2000 of FIG. 44. The operational flow may include at least one additional operation 2050. The at least one additional operation may include an operation 2052, or an operation 2054. The operation 2052 includes displaying at least two user-selectable portions of the manual. The operation 2054 includes establishing a communications link between the manual and the electronic device.

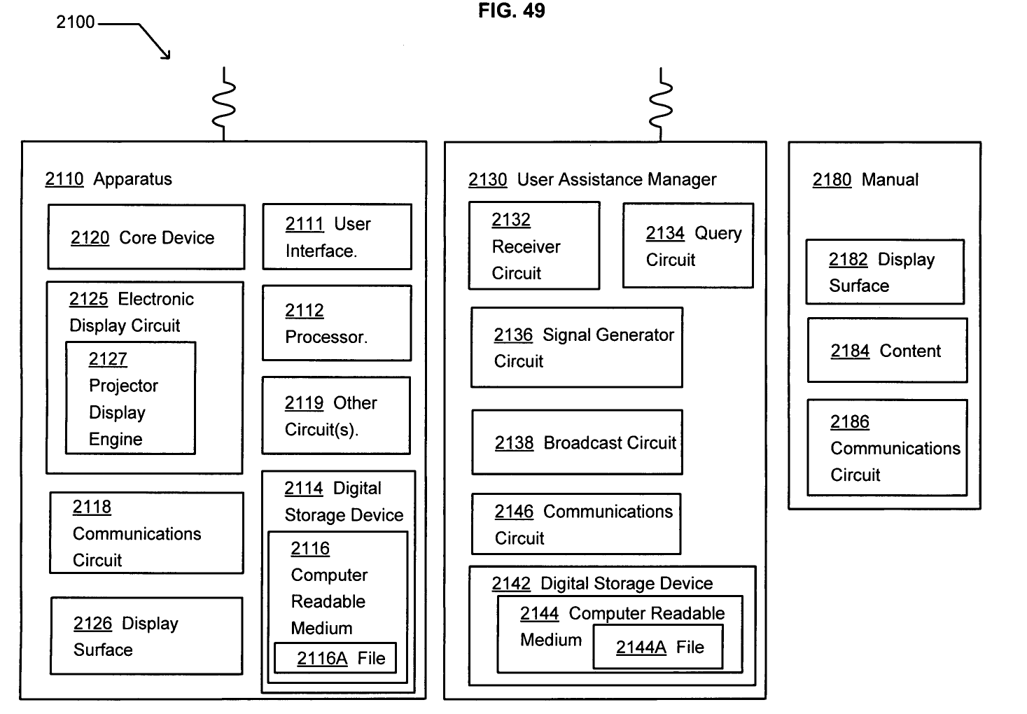

FIG. 49 illustrates an example system 2100 that includes an apparatus 2110 and a user assistance manager 2130. The apparatus includes a core device 2120 operable to perform a core function of the apparatus. For example, see an embodiment illustrated in FIG. 1 as the device functional elements 50. A core function may include at least one of a voice, telephone, email, message, music, global positioning, navigation, picture, video, browsing, or Internet core function. In another embodiment, a core function may include at least one of transportation, such as car, boat, airplane, or train transportation, heating and air conditioning, refrigeration, or a building. The apparatus also includes an electronic display circuit 2125. The electronic display circuit is operable to present human-perceivable content using a user interface of the apparatus. In another embodiment, the content may include at least one of a text, audio, still image moving image, schematic, or interactive parts-explosion graphic content. In a further embodiment, the manual may include an e-paper manual. In another embodiment, the content may include at least one of a text, audio, still image moving image, schematic, or interactive parts-explosion graphic content. In a further embodiment, the manual may include an e-paper manual. In an alternative embodiment, the electronic display circuit is operable to present human-perceivable content using a display screen and/or a display surface 2126 associated with the apparatus. In another alternative embodiment, the electronic display circuit is operable to present human-perceivable content using a projector display engine associated with the apparatus, such as the projector display engine 2127. The projector display engine may include the Pico Projector Display Engine by Microvision, Inc. In a further embodiment, the electronic circuit is operable to present a human-perceivable light emitting element on a physical user interface associated with the apparatus, such as the light emitting element 1864A associated with the tangible button 1844A of FIG. 43, or a virtual button (not shown) displayed on a display screen or a projected display.

The user assistance manager 2130 includes a receiver circuit 2132, a query circuit 2134, and a signal generator circuit 2136. The receiver circuit is operable to receive a signal originated by a manual having content pertaining to the apparatus, and indicative of a user-selected content portion of the manual. In an alternative embodiment, the receiver circuit is operable to receive a signal originated by an electronically implemented manual. In another alternative embodiment, the receiver circuit is operable to receive a signal originated by at least one of a touch sensitive, or an optical tracker device. In another embodiment, the manual includes a manual having content pertaining to at least one of a core function, or an aspect of the apparatus. In a further embodiment, the manual includes at least one of an owner's manual, a user's manual, an instruction manual, an operator's manual, a guidebook, or a parts manual. In another embodiment, the content may include at least one of a text, audio, still image moving image, schematic, or interactive parts-explosion graphic content. In a further embodiment, the manual may include an e-paper manual. The query circuit is operable to search a file stored on a computer readable medium, such as a file 2144A saved in the computer readable medium 2144, for a user assistance pertaining to the apparatus and corresponding to the user-selected content portion of the manual. The signal generator is operable to generate a signal indicative of the user assistance pertaining to the apparatus and corresponding to the user-selected content portion of the manual. In an alternative embodiment, the system may be implemented in the environment 1800 described in conjunction with FIG. 43.

In another alternative embodiment, the user assistance manager 2130 further includes a broadcast circuit 2138 operable to facilitate using the electronic display circuit a presentation of the assistance pertaining to the apparatus and corresponding to the user-selected content portion of the manual. In a further embodiment, the apparatus 2110 further includes the user-assistance manager. In this further embodiment, the user assistance manager may include the computer readable medium 2144 operable to save the file 2144A that includes at least two instances of user assistance pertaining to the apparatus.

In an alternative embodiment, the apparatus 2110 includes a communication circuit 2118 operable to communicate with the manual 2180. In another embodiment, the system 2100 further includes the manual. In a further embodiment, the manual further includes the user-assistance manager 2130. In an alternative embodiment, the user-assistance manager includes the computer readable medium 2144 operable to save the file 2144A that includes at least two instances of user assistance pertaining to the apparatus. In another embodiment, the user-assistance manager includes a communication circuit 2146 operable to communicate with the apparatus.

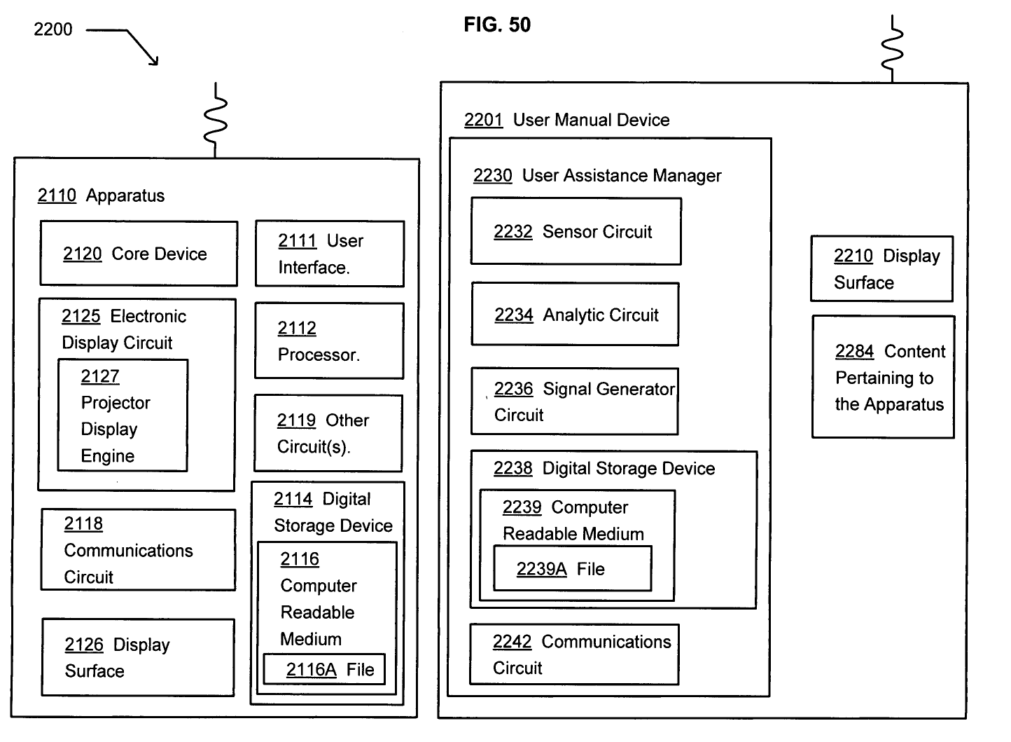

FIG. 50 illustrates an example system 2200. The system includes a user manual device 2201. The user manual device includes a display surface 2210 and a user assistance manager 2230. The display surface includes a display surface operable to present to a human-user at least two portions of content 2284 pertaining to an apparatus 2110 and selectable by the human-user. The user assistance manager includes a sensor circuit 2232, an analytic circuit 2234, and a signal generator circuit 2236. The sensor circuit includes a sensor circuit operable to detect a human-user selection of a presented content portion of at least two portions of presented content. In an alternative embodiment, the sensor circuit is operable to detect a human-user selection using at least one of a touch sensitive screen, or an optical sensor operable to acquire an indication in response to a selection action by the human-user of with respect to the presented content portion. The analytic circuit includes an analytic circuit operable to search a file stored on a computer readable medium for a human-user assistance related to the user-selected content portion. For example, in an embodiment, the analytic circuit is operable to search file 2239A stored to computer readable medium 2239 for a human-user assistance related to the user-selected content portion. In another embodiment, the analytic circuit is operable to search a file stored to another computer readable medium, such as the file 2116A stored to the computer readable medium 2116, or a remotely located file, such as a file stored on a web server (not shown). The signal generator 2236 includes a signal generator circuit operable to generate the signal indicative of the human user assistance related to the human user-selected content portion.

In an alternative embodiment, the display surface 2210 includes an electronic display surface operable to present to a human-user at least two portions of content 2284 pertaining to an apparatus, such as the apparatus 2110, and selectable by the human-user. In another embodiment, the display surface includes at least one of a printed page(s) display surface, an electronically driven display surface, a projector display engine operable to display on a surface not physically associated with the user manual device 2201, or an e-paper display surface operable to present to a human-user at least two portions of content pertaining to an apparatus and selectable by the human-user. In a further embodiment, the display surface includes a display surface operable to present to a human-user at least two portions of content pertaining to an apparatus and selectable by the human-user. The content pertaining to an apparatus includes at least one of an owner's manual, a users guide, an instruction information, an operator's guide, or a parts list. In an alternative embodiment, the user assistance manager 2230 includes a computer readable medium 2239 operable to save a file 2239A that includes at least two instances of user assistance pertaining to the apparatus.

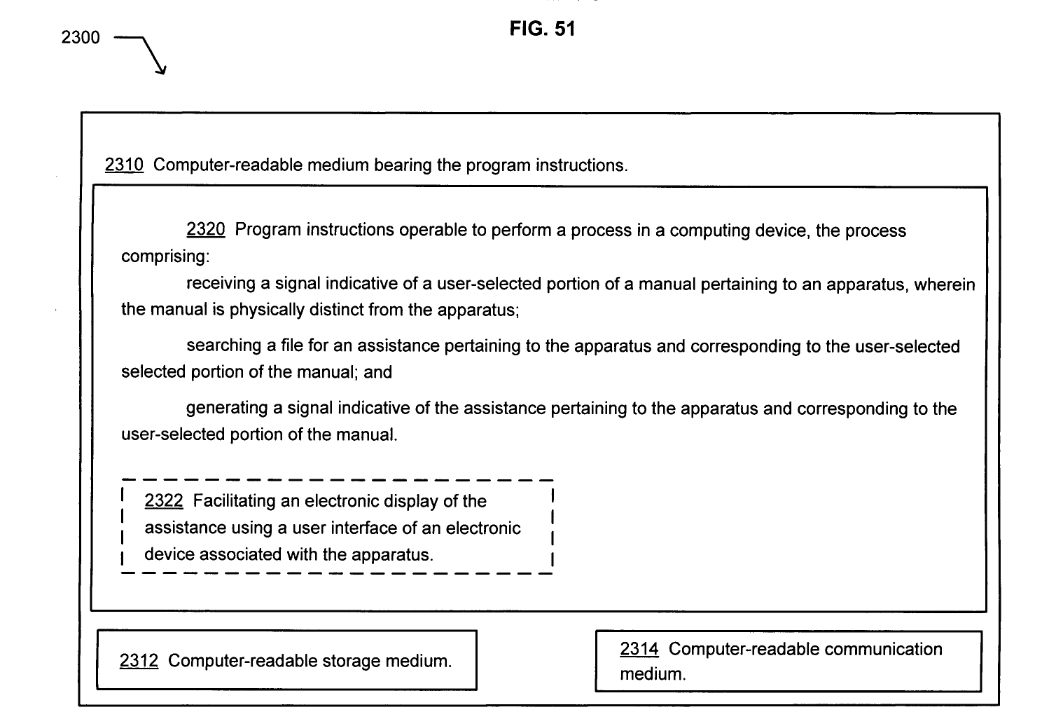

FIG. 51 illustrates an example computer program product 2300. The computer program product includes a computer-readable storage medium 2310 bearing program instructions 2320. The program instructions are operable to perform a process in a computing device. The process includes receiving a signal indicative of a user-selected portion of a manual pertaining to an apparatus. The manual is physically distinct from the apparatus, such as illustrated in FIG. 43 where the manual 1850 is physically distinct from the apparatus 1810. The process also includes searching a file for an assistance pertaining to the apparatus and corresponding to the user-selected portion of the manual. The process further includes generating a signal indicative of the assistance pertaining to the apparatus and corresponding to the user-selected portion of the manual. In an alternative embodiment, the process further includes facilitating an electronic display of the assistance using a user interface of an electronic device associated with the apparatus.

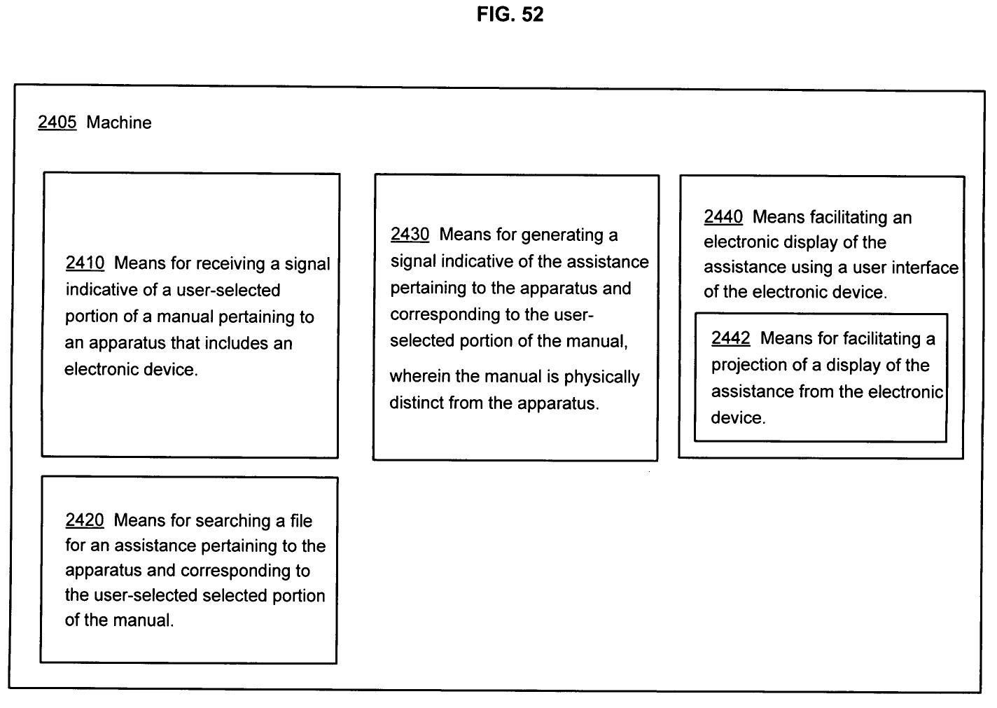

FIG. 52 illustrates an example machine 2405. The machine includes means 2410 for receiving a signal indicative of a user-selected portion of a manual pertaining to an apparatus that includes an electronic device. The machine also includes means 2420 for searching a file for an assistance pertaining to the apparatus and corresponding to the user-selected portion of the manual. The machine also includes means 2430 for generating a signal indicative of the assistance pertaining to the apparatus and corresponding to the user-selected portion of the manual, wherein the manual is physically distinct from the apparatus. In an alternative embodiment, the machine further includes means 2440 for facilitating an electronic display of the assistance using a user interface of the electronic device. In an alternative embodiment, the means for facilitating an electronic display of the assistance using a user interface of the electronic device further includes means 2442 for facilitating a projection of a display of the assistance from the electronic device

The foregoing detailed description has set forth various embodiments of the systems, apparatus, devices, computer program products, and/or processes using block diagrams, flow diagrams, operation diagrams, flowcharts, illustrations, and/or examples. A particular block diagram, operation diagram, flowchart, illustration, environment, and/or example should not be interpreted as having any dependency or requirement relating to any one or combination of components illustrated therein. For example, in certain instances, one or more elements of an environment may be deemed not necessary and omitted. In other instances, one or more other elements may be deemed necessary and added.

Insofar as such block diagrams, operation diagrams, flowcharts, illustrations, and/or examples contain one or more functions and/or operations, it will be understood that each function and/or operation within such block diagrams, operation diagrams, flowcharts, illustrations, or examples can be implemented, individually and/or collectively, by a wide range of hardware, software, firmware, or virtually any combination thereof unless otherwise indicated. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware. Those skilled in the art will recognize that optical aspects of implementations will typically employ optically-oriented hardware, software, and or firmware.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable and/or physically interacting components and/or wirelessly interactable and/or wirelessly interacting components.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
receiving a signal indicative of a user-selected portion of a manual pertaining to an apparatus that includes an electronic device;
searching a file for an assistance pertaining to the apparatus and corresponding to the user-selected portion of the manual; and
generating a signal indicative of the assistance pertaining to the apparatus and corresponding to the user-selected portion of the manual,
wherein the manual is physically distinct from the apparatus.

2. The method of claim 1, wherein the receiving a signal indicative of a user-selected portion of a manual pertaining to an apparatus that includes an electronic device further includes:
receiving a signal indicative of a user-selected portion of an electronically-implemented manual pertaining to an apparatus that includes an electronic device.

3. The method of claim 1, wherein the receiving a signal indicative of a user-selected portion of a manual pertaining to an apparatus that includes an electronic device further includes:
receiving a signal indicative of an optically-detected user selection of a portion of a manual pertaining to an apparatus that includes an electronic device.

4. The method of claim 1, wherein the searching a file for an assistance pertaining to the apparatus and corresponding to the user-selected portion of the manual further includes:
searching a file stored in a computer readable medium associated with at least one of the manual, the apparatus, or another electronic device for an assistance pertaining to the apparatus and corresponding to the user-selected portion of the manual.

5. The method of claim 1, wherein the searching a file for an assistance pertaining to the apparatus and corresponding to the user-selected portion of the manual further includes:
searching a file for an assistance pertaining to an aspect of the apparatus and corresponding to the user-selected portion of the manual.

6. The method of claim 1, further comprising:
facilitating an electronic display of the assistance using a user interface of the electronic device.

7. The method of claim 6, wherein the facilitating an electronic display of the assistance using a user interface of the electronic device further includes:
facilitating a projection of a display of the assistance from the electronic device.

8. The method of claim 6, wherein the facilitating an electronic display of the assistance using a user interface of the electronic device further includes:
facilitating an electronic display of the assistance using a display surface physically associated with a user interface of the electronic device.

9. The method of claim 6, wherein the facilitating an electronic display of the assistance using a user interface of the electronic device further includes:
facilitating an electronic display of the assistance using a light emitter physically associated with a physical element of the electronic device.

10. The method of claim 6, wherein the facilitating an electronic display of the assistance using a user interface of the electronic device further includes:
facilitating an electronic display of the assistance using a user interface perceivable by the user of the electronic device.

11. The method of claim 1, further comprising:
displaying at least two user-selectable portions of the manual.

12. The method of claim 1, further comprising:
establishing a communications link between the manual and the electronic device.

13. A system comprising:
an apparatus including:
a core device operable to perform a core function of the apparatus;
an electronic display circuit operable to present human-perceivable content using a user interface of the apparatus;
a user assistance manager including:
a receiver circuit operable to receive a signal originated by a manual having content pertaining to the apparatus, and indicative of a user-selected content portion of the manual,
a query circuit operable to search a file stored on a computer readable medium for a user assistance pertaining to the apparatus and corresponding to the user-selected content portion of the manual, and
a signal generator operable to generate a signal indicative of the user assistance pertaining to the apparatus and corresponding to the user-selected content portion of the manual.

14. The system of claim 13, wherein the user assistance manager further includes:
a broadcast circuit operable to facilitate using the electronic display circuit a presentation of the assistance pertaining to the apparatus and corresponding to the user-selected content portion of the manual.

15. The system of claim 13, wherein the user assistance manager further includes:
a computer readable medium operable to save a file that includes at least two instances of user assistance pertaining to the apparatus.

16. The system of claim 13, wherein the user assistance manager further includes:
a communication circuit operable to communicate with the apparatus.

17. The system of claim 13, wherein the apparatus further includes:
the user assistance manager.

18. The system of claim 13, wherein the apparatus further includes:
a communication circuit operable to communicate with the manual.

19. The system of claim 13, wherein the system further includes:
the manual.

20. The system of claim 19, wherein the manual further includes:
the user assistance manager.

21. A user manual device comprising:
a display surface operable to present to a human-user at least two portions of content pertaining to an apparatus and selectable by the human-user; and
a user assistance manager that includes:
a sensor circuit operable to detect a human-user selection of a presented content portion of at least two portions of presented content,
an analytic circuit operable to search a file stored on a computer readable medium for a human-user assistance related to the user-selected content portion; and
a signal generator circuit operable to generate the signal indicative of the human user assistance related to the human user-selected content portion.

22. The user manual device of claim 21, wherein the display surface operable to present to a human-user at least two portions of content pertaining to an apparatus and selectable by the human-user further includes:
an electronic display surface operable to present to a human-user at least two portions of content pertaining to an apparatus and selectable by the human-user.

23. The user manual device of claim 21, wherein the display surface operable to present to a human-user at least two portions of content pertaining to an apparatus and selectable by the human-user further includes:
at least one of a printed page(s) display surface, an electronically driven display surface, or an e-paper display surface operable to present to a human-user at least two portions of content pertaining to an apparatus and selectable by the human-user.

24. The user manual device of claim 21, wherein the display surface operable to present to a human-user at least two portions of content pertaining to an apparatus and selectable by the human-user further includes:
a display surface operable to present to a human-user at least two portions of content pertaining to an apparatus and selectable by the human-user, the content including at least one of an owners manual, a users guide, an instruction information, operators guide, or a parts list.

25. The user manual device of claim 21, wherein the user assistance manager further includes:
a computer readable medium operable to save a file that includes at least two instances of user assistance pertaining to the apparatus.

26. A computer program product comprising:
(a) program instructions operable to perform a process in a computing device, the process including
receiving a signal indicative of a user-selected portion of a manual pertaining to an apparatus, wherein the manual is physically distinct from the apparatus;
searching a file for an assistance pertaining to the apparatus and corresponding to the user-selected portion of the manual; and
generating a signal indicative of the assistance pertaining to the apparatus and corresponding to the user-selected portion of the manual; and
(b) a computer-readable storage medium bearing the program instructions.

27. The computer program product of claim 26, wherein the process further includes:
facilitating an electronic display of the assistance using a user interface of an electronic device associated with the apparatus.

28. A machine comprising:
means for receiving a signal indicative of a user-selected portion of a manual pertaining to an apparatus that includes an electronic device;
means for searching a file for an assistance pertaining to the apparatus and corresponding to the user-selected portion of the manual; and
means for generating a signal indicative of the assistance pertaining to the apparatus and corresponding to the user-selected portion of the manual,
wherein the manual is physically distinct from the apparatus.

29. The machine of claim 28, further comprising:
means for facilitating an electronic display of the assistance using a user interface of the electronic device.

30. The machine of claim 29, wherein the means for facilitating an electronic display of the assistance using a user interface of the electronic device further includes:
means for facilitating a projection of a display of the assistance from the electronic device.
